(19) United States
(12) Patent Application Publication
(10) Pub. No.: US 2025/0150151 A1
(43) Pub. Date: May 8, 2025

(54) BEAM FAILURE RECOVER UNDER UNIFIED TCI FRAMEWORK WITH MULTI-TRP OPERATION

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 18/924,942

(22) Filed: Oct. 23, 2024

Related U.S. Application Data
(60) Provisional application No. 63/547,248, filed on Nov. 3, 2023.
(60) Provisional application No. 63/547,497, filed on Nov. 6, 2023.
(60) Provisional application No. 63/547,647, filed on Nov. 7, 2023.
(60) Provisional application No. 63/547,774, filed on Nov. 8, 2023.
(60) Provisional application No. 63/603,829, filed on Nov. 29, 2023.
(60) Provisional application No. 63/647,826, filed on May 15, 2024.

(51) Int. Cl. H04B 7/06; H04W 72/044

(52) U.S. Cl. CPC H04B 7/06964; H04B 7/0626; H04B 7/06968; H04W 72/046

(57) ABSTRACT

Methods and apparatuses for beam failure recovery under unified TCI framework with multi-TRP operation. A method performed by a user equipment (UE) includes receiving a first transmission configuration indication (TCI) state and a second TCI state, transmitting a capability signaling, and determining, based on the capability signaling, a beam failure detection (BFD) reference signal (RS) resource set q₀ from the first or second TCI state or the first and second TCI state. The method further includes receiving a new beam RS resource set q₁ associated with the q₀, receiving a RS resource index q_{new} from the q₁ and a beam failure recovery (BFR) response (BFRR), determining, based on the q₀, q_{new}, and BFRR, a quasi-co-location (QCL) assumption for receiving downlink (DL) channels or signals, and determining, based on the q₀, q_{new}, and BFRR, a spatial domain filter for transmitting uplink (UL) channels or signals.

### CROSS-REFERENCE TO RELATED AND CLAIM OF PRIORITY

The present application claims priority under 35 U.S.C. § 119(e) to U.S. Provisional Patent Application No. 63/547,248 filed on Nov. 3, 2023; U.S. Provisional Patent Application No. 63/547,497 filed on Nov. 6, 2023; U.S. Provisional Patent Application No. 63/547,647 filed on Nov. 7, 2023; U.S. Provisional Patent Application No. 63/547,774 filed on Nov. 8, 2023; U.S. Provisional Patent Application No. 63/603,829 filed on Nov. 29, 2023; and U.S. Provisional Patent Application No. 63/647,826 filed on May 15, 2024, which are hereby incorporated by reference in their entirety.

### TECHNICAL FIELD

The present disclosure relates generally to wireless communication systems and, more specifically, the present disclosure relates to methods and apparatuses for beam failure recovery under unified TCI framework with multi-TRP operation.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to beam failure recovery under unified TCI framework with multi-TRP operation.

In one embodiment, a user equipment (UE) is provided. The UE includes a transceiver configured to receive a first transmission configuration indication (TCI) state and a second TCI state and transmit a capability signaling. The UE further includes a processor operably coupled to the transceiver. The processor is configured to determine, based on the capability signaling, a beam failure detection (BFD) reference signal (RS) resource set q̅₀ from (i) the first or second TCI state or (ii) the first and second TCI state. The transceiver is further configured to receive a new beam RS resource set q̅₁ associated with the q̅₀ and receive a RS resource index q_{new} from the q̅₁ and a beam failure recovery (BFR) response (BFRR). The processor is further configured to determine, based on the q₀, q_{new}, and BFRR, a quasi-co-location (QCL) assumption for receiving downlink (DL) channels or signals and determine, based on the q₀, q_{new}, and BFRR, a spatial domain filter for transmitting uplink (UL) channels or signals.

In another embodiment, a base station (BS) is provided. The BS includes a transceiver configured to transmit a first TCI state and a second TCI state and receive a capability signaling and a processor operably coupled to the transceiver. The processor is configured to determine, based on the capability signaling, a BFD RS resource set q̅₀ from (i) the first or second TCI state or (ii) the first and second TCI state. The transceiver is further configured to transmit a new beam RS resource set q̅₁ associated with the q̅₀ and transmit a RS resource index q_{new} from the q̅₁ and a BFRR. The q₀, q_{new}, and BFRR, indicate (i) a QCL assumption for DL channels or signals and (ii) a spatial domain filter for transmitting UL channels or signals.

In yet another embodiment, a method performed by a UE is provided. The method includes receiving a first TCI state and a second TCI state, transmitting a capability signaling, and determining, based on the capability signaling, a BFD RS resource set q̅₀ from the first or second TCI state or the first and second TCI state. The method further includes receiving a new beam RS resource set q̅₁ associated with the q₀, receiving a RS resource index q_{new} from the q̅₁ and a BFRR, determining, based on the q₀, q_{new}, and BFRR, a QCL assumption for receiving DL channels or signals, and determining, based on the q₀, q_{new}, and BFRR, a spatial domain filter for transmitting UL channels or signals.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example multiple transmission and reception point (TRP) system according to embodiments of the present disclosure;

FIG. 8 illustrates an example system of a primary cell (PCell) beam failure according to embodiments of the present disclosure;

FIG. 9 illustrates an example system of a secondary cell (SCell) beam failure according to embodiments of the present disclosure;

FIG. 10 illustrates an example procedure for beam resetting/updating according to embodiments of the present disclosure;

FIG. 11 illustrates an example procedure for beam resetting/updating according to embodiments of the present disclosure;

FIG. 12 illustrates an example system for receiving physical downlink control channel(s) (PDCCH(s)) and physical downlink shared channel (PDSCH) according to embodiments of the present disclosure; and

FIG. 13 illustrates an example procedure for beam resetting/updating according to embodiments of the present disclosure.

### DETAILED DESCRIPTION

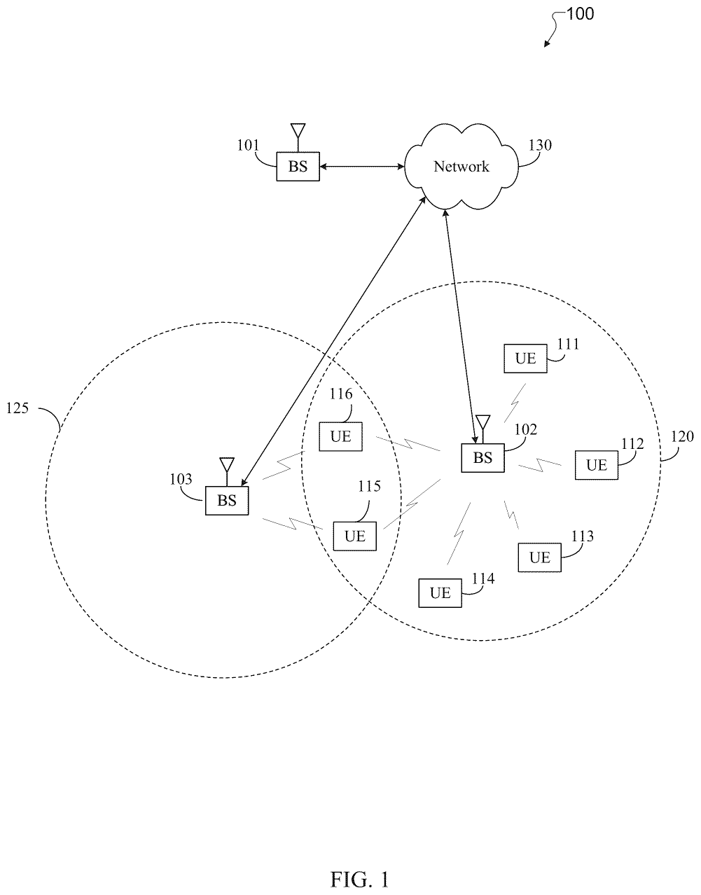

FIGS. 1-13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1]3GPP TS 38.211 v16.1.0, “NR; Physical channels and modulation;” [2]3GPP TS 38.212 v16.1.0, “NR; Multiplexing and Channel coding;” [3]3GPP TS 38.213 v16.1.0, “NR; Physical Layer Procedures for Control;” [4]3GPP TS 38.214 v16.1.0, “NR; Physical Layer Procedures for Data;” [5]3GPP TS 38.321 v16.1.0, “NR; Medium Access Control (MAC) protocol specification;” and [6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing beam failure recovery under unified TCI framework with multi-TRP operation. In certain embodiments, one or more of the BSs 101-103 include circuitry, programing, or a combination thereof to support beam failure recovery under unified TCI framework with multi-TRP operation.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

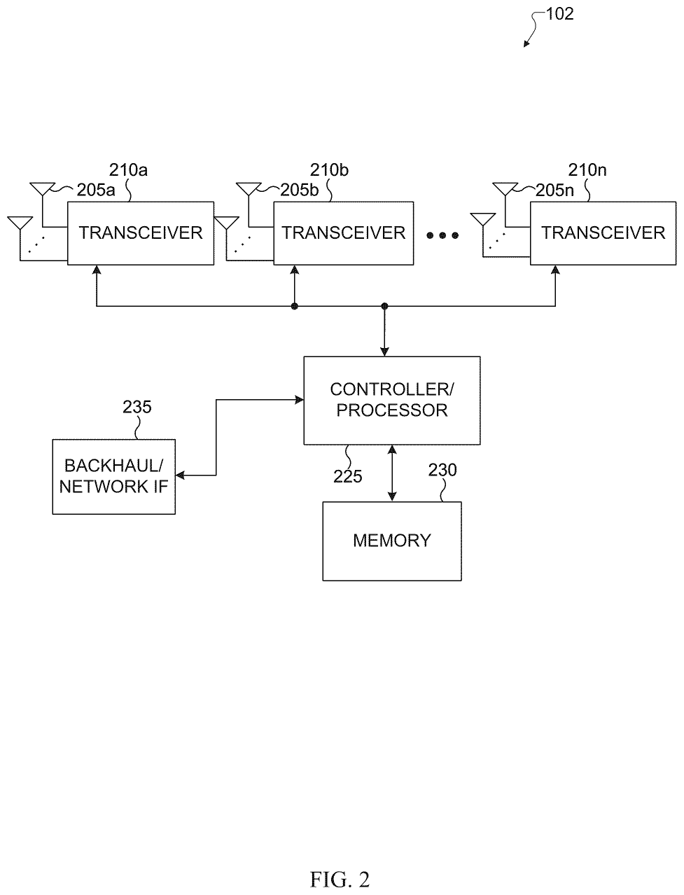

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting beam failure recovery under unified TCI framework with multi-TRP operation. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

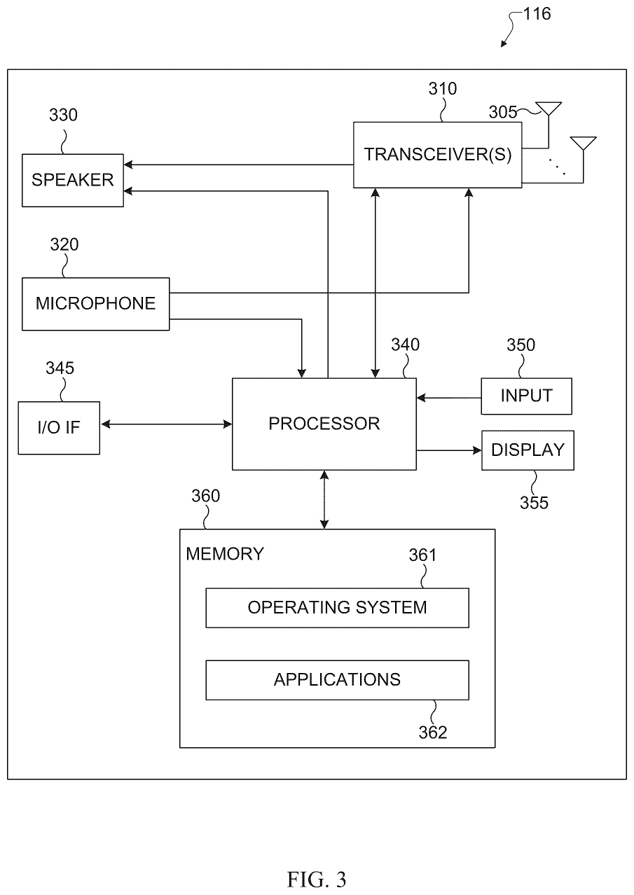

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify beam failure recovery under unified TCI framework with multi-TRP operation as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

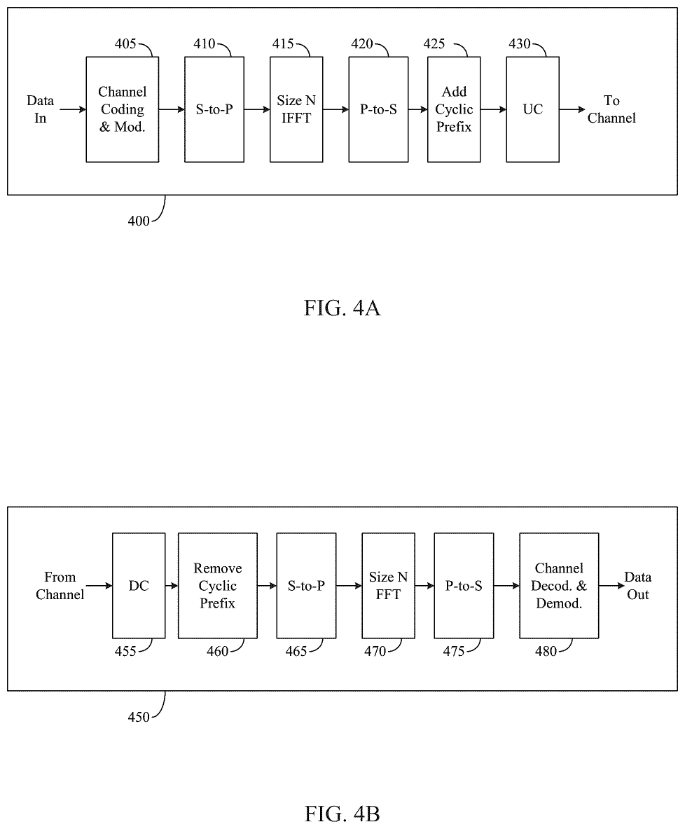

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support beam failure recovery under unified TCI framework with multi-TRP operation as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

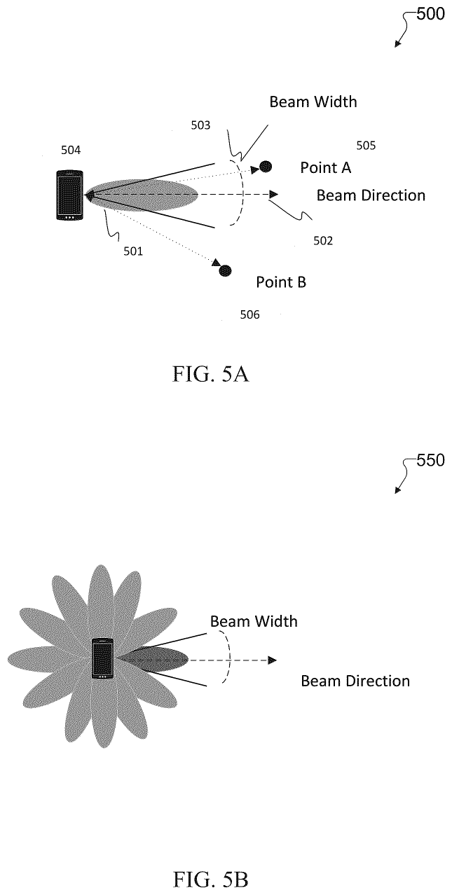

As illustrated in FIG. 5A, in a wireless system 500, a beam 501 for a device 504 can be characterized by abeam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

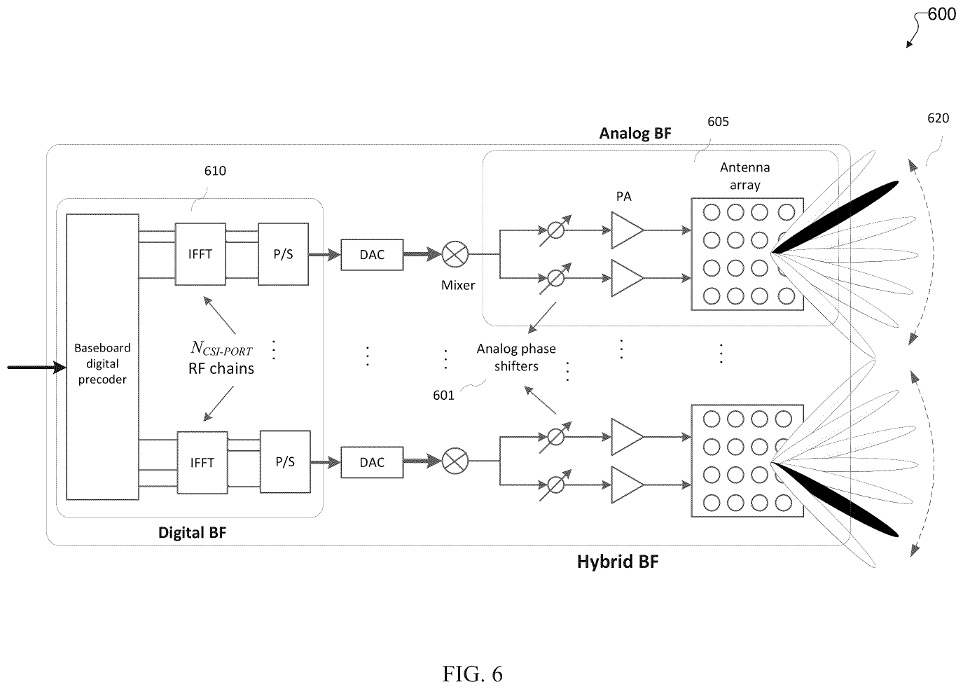

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding reference signal (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

In this disclosure, a beam is determined by either of:
A TCI state that establishes a quasi-colocation (QCL) relationship between a source reference signal (e.g., SSB and/or CSI-RS) and a target reference signal.
A spatial relation information that establishes an association to a source reference signal, such as SSB or CSI-RS or SRS.

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

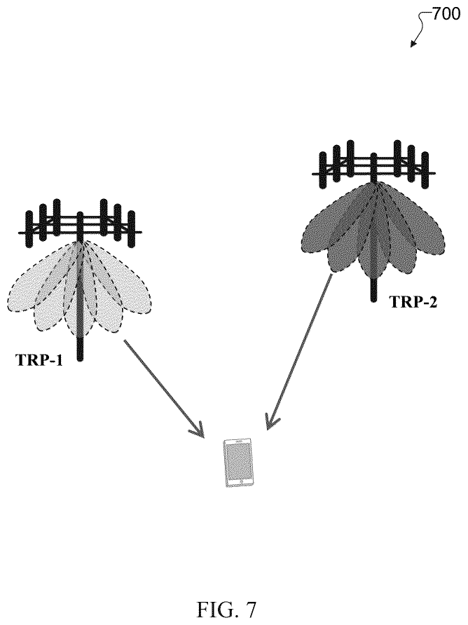

FIG. 7 illustrates an example system 700 for a multi-TRP according to embodiments of the present disclosure. For example, the system 700 may operate within the wireless network 100 in FIG. 1. This example is for illustration only and other embodiments can be used without departing from the scope of the present disclosure.

With reference to FIG. 7, a UE could simultaneously receive from multiple physically non-co-located TRPs various channels/RSs such as physical downlink control channels (PDCCHs) and/or physical downlink shared channels (PDSCHs) using either a single receive (RX) panel or multiple RX panels. In this disclosure, a RX panel could correspond to a set of RX antenna elements/ports at the UE 116, a set of measurement RS resources such as SRS resources, a spatial domain RX filter or etc. Furthermore, a TRP in the multi-TRP system can represent a collection of measurement antenna ports, measurement RS resources and/or control resource sets (CORESETs). For example, a TRP could be associated with one or more of:
A plurality of CSI-RS resources
A plurality of CRIs (CSI-RS resource indices/indicators)
A measurement RS resource set, for example, a CSI-RS resource set along with its indicator
A plurality of CORESETs associated with a CORESETPoolIndex
A plurality of CORESETs associated with a TRP-specific index/indicator/identity

A cell/TRP could be a non-serving cell/TRP. In this disclosure, the non-serving cell(s) or the non-serving cell TRP(s) could have/broadcast different physical cell IDs (PCIs) and/or other higher layer signaling index values from that of the serving cell or the serving cell TRP (i.e., the serving cell PCI). In one example, the serving cell or the serving cell TRP could be associated with the serving cell ID (SCI) and/or the serving cell PCI. That is, for the inter-cell operation evaluated in the present disclosure, different cells/TRPs could broadcast different PCIs and/or one or more cells/TRPs (referred to/defined as non-serving cells/TRPs in the present disclosure) could broadcast different PCIs from that of the serving cell/TRP (i.e., the serving cell PCI) and/or one or more cells/TRPs are not associated with valid SCI (e.g., provided by the higher layer parameter ServCellIndex). In the present disclosure, a non-serving cell PCI can also be referred to as an additional PCI, another PCI, or a different PCI (with respect to the serving cell PCI).

Furthermore, in a wireless communications system, a radio link failure (RLF) could occur if a significant/sudden link quality drop is observed at the UE side. Embodiments of the present disclosure recognize that if a RLF occurs, fast RLF recovery mechanisms, therefore, become essential to promptly re-establish the communication link(s) and avoid severe service interruption. At higher frequencies, e.g., millimeter-wave (mmWave) frequencies or FR2 in the 3GPP NR, both the transmitter and receiver could use directional (analog) beams to transmit and receive various RSs/channels such as SSBs, CSI-RSs, PDCCHs or PDSCHs. Hence, prior to declaring a full RLF, the UE could first detect and recover a beam failure if the signal qualities/strengths of certain beam pair links (BPLs) are below a certain threshold for a certain period of time.

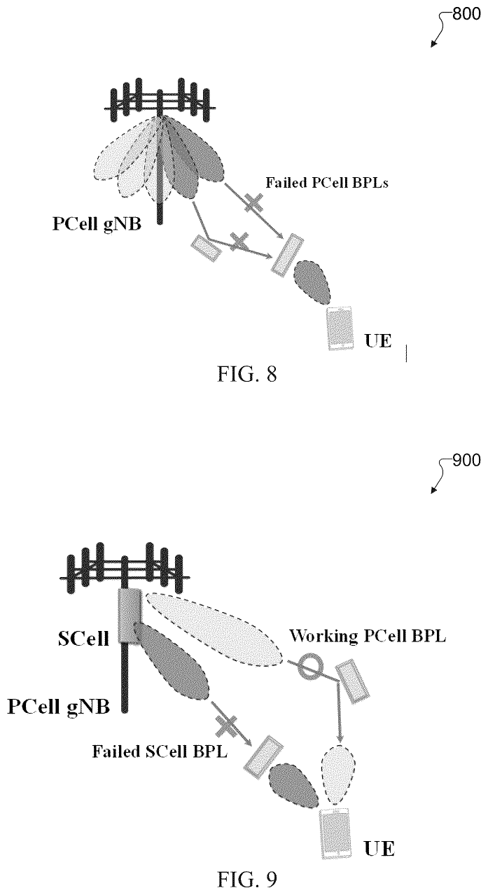

FIG. 8 illustrates an example system 800 of a PCell according to embodiments of the present disclosure. For example, system 800 may operate within the wireless network 100 in FIG. 1. This example is for illustration only and other embodiments can be used without departing from the scope of the present disclosure.

The 3GPP Rel. 15 beam failure recovery (BFR) procedure mainly targets for a primary cell (PCell or PSCell) under the carrier aggregation (CA) framework (FIG. 8). The BFR procedure in the 3GPP Rel. 15 comprises the following key components:
Beam failure detection (BFD)
New beam identification (NBI)
BFR request (BFRQ)
BFRQ response (BFRR)

The UE is first configured by the gNB (e.g. the gNB 102) a set of BFD RS resources to monitor the link qualities between the gNB and the UE. One BFD RS resource could correspond to one (periodic) CSI-RS/SSB RS resource, which could be a quasi-co-located (QCL) source RS with typeD in a TCI state for a CORESET. If the received signal qualities of the BFD RS resources are below a given threshold (implying that the hypothetical block error ratios (BLERs) of the corresponding CORESETs/PDCCHs are above a given threshold), the UE could declare a beam failure instance (BFI). Furthermore, if the UE has declared N_BFI consecutive BFIs within a given time period, the UE would declare a beam failure.

After declaring/detecting the beam failure, the UE would transmit the BFRQ to the gNB via a contention-free (CF) PRACH (CF BFR-PRACH) resource, whose index is associated with a new beam identified by the UE. Specifically, to determine a new beam, the UE could be first configured by the network a set of SSB and/or CSI-RS resources (NBI RS resources) via a higher layer parameter candidateBeamRSList. The UE would then measure the NBI RSs and calculate their layer1 reference signal received powers (L1-RSRPs). If at least one of the measured L1-RSRPs of the NBI RSs is beyond a given threshold, the UE would select the beam that corresponds to the NBI RS with the highest L1-RSRP as the new beam q_new. To determine a CF BFR-PRACH resource to convey the BFRQ, the UE could be first configured by the network a set of PRACH resources, each associated with a NBI RS resource. The UE could then select the PRACH resource that has the one-to-one correspondence to the selected NBI RS resource (and therefore, the new beam index q_new) to send the BFRQ to the gNB. From the index of the selected CF PRACH resource, the gNB could also know which beam is selected by the UE as the new beam.

Four slots after the UE has transmitted the BFRQ, the UE could start to monitor a dedicated CORESET/search space for BFRQ response. The dedicated CORESET is addressed to the UE-specific cell-radio network temporary identifier (C-RNTI), and would be transmitted by the gNB using the newly identified beam. If the UE detects a valid UE-specific downlink control information (DCI) in the dedicated CORESET for BFRR, the UE expects that the beam failure recovery request has been successfully received by the network, and the UE would complete the BFR process. Otherwise, if the UE does not receive the BFRR within a configured time window, the UE would initiate a contention based (CB) random access (RA) process to reconnect to the network.

FIG. 9 illustrates an example system 900 of a secondary cell (SCell) according to embodiments of the present disclosure. For example, system 900 may operate within the wireless network 100 in FIG. 1. This example is for illustration only and other embodiments can be used without departing from the scope of the present disclosure.

In the 3GPP Rel. 16, the BFR procedures were customized for the secondary cell (SCell) under the CA framework, in which the BPL(s) between the PCell and the UE is expected to be working. With reference to FIG. 9, an illustrative example of the SCell beam failure is given.

After declaring/detecting the beam failure for the SCell, the UE would transmit the BFRQ in form of a scheduling request (SR) over a physical uplink control channel (PUCCH) for the working PCell. Furthermore, the UE could only transmit the BFRQ at this stage without indicating any new beam index, failed SCell index or other information to the network. This is different from the Rel. 15 PCell/PSCell procedure, in which the UE would indicate both the BFRQ and the identified new beam index to the network at the same time. Allowing the gNB to quickly know the beam failure status of the SCell without waiting for the UE to identify a new beam could be beneficial. For instance, the gNB could deactivate the failed SCell and allocate the resources to other working SCells.

The UE could be indicated by the network (e.g. the network 130) an uplink grant in response to the BFRQ SR, which would allocate necessary resources for the MAC CE to carry new beam index q_new (if identified), failed SCell index and etc. over the physical uplink shared channel (PUSCH) for the working PCell. After transmitting the MAC CE for BFR to the working PCell, the UE would start to monitor the BFRR. The BFRR could be a TCI state indication for a CORESET for the corresponding SCell. The BFRR to the MAC CE for BFR could also be a normal uplink grant for scheduling a new transmission for the same hybrid automatic repeat request (HARQ) process as the PUSCH carrying the MAC CE for BFR. If the UE could not receive the BFRR within a configured time window, the UE could transmit BFR-PUCCH again, or fall back to CBRA process.

This disclosure provides various design aspects related to sending beam failure recovery request (BFRQ) and information related to beams having radio link quality worse than a threshold in a multi-TRP system, wherein beams/TRPs selection is conducted under the unified TCI framework.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

A UE could receive from the network a first (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of CCs/DL bandwidth parts (BWPs), and/or a second (unified) TCI state(s) activation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. That is, e.g., when/if the UE is provided/configured with dl-OrJointTCI-StateList and/or ul-TCI-StateList and/or is having one or two indicated TCI states and/or is having first and/or second indicated TCI states, an activated TCI codepoint in the second MAC CE activation command could be composed/comprised of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 16: a first TCI state for DL channel(s)/signal(s) and UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

Furthermore, when/if the UE is configured by higher layer parameter PDCCH-Config that contains two values of coresetPoolIndex (e.g., 0 and 1) in ControlResourceSet, the first/second (unified) TCI state(s) activation command as specified herein in the present disclosure could also incorporate/provide/indicate/include/contain a value of coresetPoolIndex (e.g., 0 or 1). For this case, the TCI state(s)/TCI codepoint(s) activated by/in the first/second (unified) TCI state(s) activation command could be specific to the same coresetPoolIndex value (i.e., 0 or 1) provided/indicated therein.

In one example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a third (unified) TCI state(s) activation MAC CE command, wherein the TCI codepoint(s) activated by/in the third (unified) TCI state(s) activation MAC CE command could be comprised of or mapped to or could correspond to one of:
Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
Case 21: first TCI state(s) for both DL and UL channels/signals
Case 22: second TCI state(s) for both DL and UL channels/signals

That is, the TCI codepoint(s) activated by/in a third (unified) TCI state(s) activation command could be comprised of or mapped to either first joint/DL/UL TCI state(s)/pair(s) of first DL and UL TCI states or second joint/DL/UL TCI state(s)/pair(s) of second DL and UL TCI states.

In another example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a fourth (unified) TCI state(s) activation MAC CE command as specified herein in the present disclosure with (1) at least one TCI codepoint activated therein composing/comprising of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s), and/or (2) at least one TCI codepoint activated therein composing/comprising of at least first TCI state(s) as specified herein in the present disclosure and another TCI codepoint activated therein composing/comprising of at least second TCI state(s) as specified herein in the present disclosure. That is, for this case/design example, the UE may or may not expect, or may or may not be expected to receive a fourth (unified) TCI state(s) activation MAC CE command as specified herein in the present disclosure with (1) at least one TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and/or (2) at least one TCI codepoint activated therein composing/comprising of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 16: a first TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and another TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE (e.g. the UE 116) could be configured/provided/indicated by the network via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUSCH transmission in a (single-DCI based) multi-TRP system, a UE could be configured/provided/indicated by the network (e.g. the network 130) via higher layer RRC signaling/parameter and/or MAC CE command and/or dynamic DCI based L1 signaling—e.g., in an UL DCI (e.g., DCI format 0_0/0_1/0_2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

In one embodiment, for implicit BFD RS determination,
In one example, the UE could determine a BFD RS set—e.g., denoted by q0—to include periodic CSI-RS resource configuration indexes or SSB indexes (also referred to as BFD RS resource indexes) with same values as the RS indexes in the RS sets in the first TCI state(s) among the set of one or more (e.g., N=2) TCI states/pairs of TCI states indicated, e.g., by a TCI codepoint, in a beam indication DCI or MAC CE as specified herein in the present disclosure.
In another example, the UE could determine a BFD RS set—e.g., denoted by q0—to include periodic CSI-RS resource configuration indexes or SSB indexes (also referred to as BFD RS resource indexes) with same values as the RS indexes in the RS sets in the second TCI state(s) among the set of one or more (e.g., N=2) TCI states/pairs of TCI states indicated, e.g., by a TCI codepoint, in a beam indication DCI or MAC CE as specified herein in the present disclosure.
In yet another example, the UE could determine a BFD RS set—e.g., denoted by q0—to include periodic CSI-RS resource configuration indexes or SSB indexes (also referred to as BFD RS resource indexes) with same values as the RS indexes in the RS sets in both of the first and second TCI states among the set of one or more (e.g., N=2) TCI states/pairs of TCI states indicated, e.g., by a TCI codepoint, in a beam indication DCI or MAC CE as specified herein in the present disclosure.
In yet another example, the UE could determine two BFD RS sets. For instance, the UE could determine a first BFD RS set—e.g., denoted by q0_0—to include periodic CSI-RS resource configuration indexes or SSB indexes (also referred to as BFD RS resource indexes) with same values as the RS indexes in the RS sets in the first TCI state(s) among the set of one or more (e.g., N=2) TCI states/pairs of TCI states indicated, e.g., by a TCI codepoint, in a beam indication DCI or MAC CE as specified herein in the present disclosure, and a second BFD RS set—e.g., denoted by q0_1—to include periodic CSI-RS resource configuration indexes or SSB indexes (also referred to as BFD RS resource indexes) with same values as the RS indexes in the RS sets in the second TCI state(s) among the set of one or more (e.g., N=2) TCI states/pairs of TCI states indicated, e.g., by a TCI codepoint, in a beam indication DCI or MAC CE as specified herein in the present disclosure.

When a UE receives the first indicator for one or more CORESETs as specified herein in the present disclosure, the UE would determine one or more BFD RS sets (and therefore, BFD RSs determined therein) according to one or more of the followings.
In one example, the UE could determine a BFD RS set—e.g., denoted by q0—to include periodic CSI-RS resource configuration indexes or SSB indexes (also referred to as BFD RS resource indexes) with same values as the RS indexes in the RS sets in the first TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘00’ as specified herein in the present disclosure, wherein the first TCI state(s) is for the one or more CORESETs.
In another example, the UE could determine a BFD RS set—e.g., denoted by q0—to include periodic CSI-RS resource configuration indexes or SSB indexes (also referred to as BFD RS resource indexes) with same values as the RS indexes in the RS sets in the second TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘01’ as specified herein in the present disclosure, wherein the second TCI state(s) is for the one or more CORESETs.
In yet another example, the UE could determine two BFD RS sets. For instance, the UE could determine a first BFD RS set—e.g., denoted by q0_0—to include periodic CSI-RS resource configuration indexes or SSB indexes (also referred to as BFD RS resource indexes) with same values as the RS indexes in the RS sets in the first TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more first CORESETs configured/associated with the first indicator set to ‘00’ as specified herein in the present disclosure, wherein the first TCI state(s) is for the one or more first CORESETs, and a second BFD RS set—e.g., denoted by q0_1—to include periodic CSI-RS resource configuration indexes or SSB indexes (also referred to as BFD RS resource indexes) with same values as the RS indexes in the RS sets in the second TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more second CORESETs configured/associated with the first indicator set to ‘01’ as specified herein in the present disclosure, wherein the second TCI state(s) is for the one or more second CORESETs.
In yet another example, the UE could determine a BFD RS set—e.g., denoted by q0—to include periodic CSI-RS resource configuration indexes or SSB indexes (also referred to as BFD RS resource indexes) with same values as the RS indexes in the RS sets in the first and second TCI states among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘10’ or ‘11’ as specified herein in the present disclosure, wherein both of the first and second TCI states are for the one or more CORESETs.
In yet another example, the UE could determine two BFD RS sets. For instance, the UE could determine a first BFD RS set—e.g., denoted by q0_0—to include periodic CSI-RS resource configuration indexes or SSB indexes (also referred to as BFD RS resource indexes) with same values as the RS indexes in the RS sets in the first TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘10’ or ‘11’ as specified herein in the present disclosure, and a second BFD RS set—e.g., denoted by q0_1—to include periodic CSI-RS resource configuration indexes or SSB indexes (also referred to as BFD RS resource indexes) with same values as the RS indexes in the RS sets in the second TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘10’ or ‘11’ as specified herein in the present disclosure, wherein both of the first and second TCI states are for the one or more CORESETs.
In yet another example, the UE could determine a BFD RS set—e.g., denoted by q0—to include periodic CSI-RS resource configuration indexes or SSB indexes (also referred to as BFD RS resource indexes) with same values as the RS indexes in the RS sets in a TCI state indicated for receiving/monitoring PDCCH/PDCCH candidate(s) in one or more CORESETs configured/associated with the first indicator set to ‘11’ as specified herein in the present disclosure, wherein (i) the TCI state could be provided by TCI-State and for the one or more CORESETs, and/or (ii) the TCI state is not in the set of indicated TCI states/pairs of TCI states as specified herein in the present disclosure.

According to the described/specified design examples herein, the UE could determine a BFD RS set—e.g., denoted by q0 or q0_0—to include periodic CSI-RS resource configuration indexes or SSB indexes (also referred to as BFD RS resource indexes) with same values as the RS indexes in the RS sets in the first TCI state(s) among the set of one or more (e.g., N=2) TCI states/pairs of TCI states indicated, e.g., by a TCI codepoint, in a beam indication DCI or MAC CE as specified herein in the present disclosure, when/if the first TCI state(s), among the set of one or more (e.g., N=2) TCI states/pairs of TCI states indicated, e.g., by a TCI codepoint, in a beam indication DCI or MAC CE as specified herein in the present disclosure, is indicated for at least one CORESET or used/applied for PDCCH reception, wherein as specified herein in the present disclosure, the first indicator configured for or associated to PDCCH(s)/PDCCH candidate(s) received in the CORESET could be set to ‘00’ or ‘10’ or ‘11’.

According to the described/specified design examples herein, the UE could determine a BFD RS set—e.g., denoted by q1 or q0_1—to include periodic CSI-RS resource configuration indexes or SSB indexes (also referred to as BFD RS resource indexes) with same values as the RS indexes in the RS sets in the second TCI state(s) among the set of one or more (e.g., N=2) TCI states/pairs of TCI states indicated, e.g., by a TCI codepoint, in a beam indication DCI or MAC CE as specified herein in the present disclosure, when/if the second TCI state(s), among the set of one or more (e.g., N=2) TCI states/pairs of TCI states indicated, e.g., by a TCI codepoint, in a beam indication DCI or MAC CE as specified herein in the present disclosure, is indicated for at least one CORESET or used/applied for PDCCH reception, wherein as specified herein in the present disclosure, the first indicator configured for or associated to PDCCH(s)/PDCCH candidate(s) received in the CORESET could be set to ‘01’ or ‘10’ or ‘11’.

According to the described/specified design examples herein, the UE could determine a BFD RS set—e.g., denoted by q0—to include periodic CSI-RS resource configuration indexes or SSB indexes (also referred to as BFD RS resource indexes) with same values as the RS indexes in the RS sets in the first and second TCI states among the set of one or more (e.g., N=2) TCI states/pairs of TCI states indicated, e.g., by a TCI codepoint, in a beam indication DCI or MAC CE as specified herein in the present disclosure, when/if both of the first and second TCI states, among the set of one or more (e.g., N=2) TCI states/pairs of TCI states indicated, e.g., by a TCI codepoint, in a beam indication DCI or MAC CE as specified herein in the present disclosure, are indicated for at least one CORESET or used/applied for PDCCH reception, wherein as specified herein in the present disclosure, the first indicator configured for or associated to PDCCH(s)/PDCCH candidate(s)—e.g., the first and second PDCCH candidates—received in the CORESET(s) could be set to ‘10’ or ‘11’.

For explicit BFD RS configuration, activation or indication, a UE could be configured/provided/indicated by the network, e.g., via higher layer RRC signaling/parameter and/or MAC CE command and/or dynamic DCI based L1 signaling, one or more BFD RS sets for radio link quality monitoring each comprising one or more BFD RSs, wherein a BFD RS could correspond to a periodic CSI-RS resource or a SSB. For instance, the UE could be first configured by the network, e.g., via higher layer RRC signaling/parameter, one or more sets of BFD RSs or BFD RS IDs. The UE could then receive from the network, one or more BFD RS MAC CE activation/subselection commands (or BFD RS indication MAC CEs) that activate/subselect one or more BFD RSs or BFD RS IDs from the one or more sets, to update one or more BFD RSs in one or more BFD RS sets.

In one embodiment, a UE could use/apply a single BFD RS set—e.g., denoted by q0—to monitor radio link quality for (single-DCI based) multi-TRP operation. As specified herein in the present disclosure, the UE could be first configured by the network, e.g., via higher layer RRC signaling/parameter, a set of BFD RSs or BFD RS IDs. The UE could then receive from the network, e.g., a BFD RS MAC CE activation/subselection command (or a BFD RS indication MAC CE) that activates/subselects one or more BFD RSs or BFD RS IDs from the set, to update one or more BFD RSs in the BFD RS set (e.g., q0).

For monitoring the radio link quality over the BFD RS set q0,
In one example, the UE could assess the radio link quality of the BFD RS set q0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure.
In another example, the UE could assess the radio link quality of the BFD RS set q0 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure.
In yet another example, the UE could assess the radio link quality of the BFD RS set q0 according to SSBs on the PCell or the PSCell or periodic CSI-RS resource configurations that are in both of the first and second TCI states among the set of one or more (e.g., N=2) TCI states/pairs of TCI states indicated, e.g., by a TCI codepoint, in a beam indication DCI or MAC CE as specified herein in the present disclosure.
In yet another example, the UE could assess a first radio link quality of the BFD RS set q0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure, and a second radio link quality of the BFD RS set q0 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure.

When a UE receives the first indicator for one or more CORESETs as specified herein in the present disclosure, the UE would determine or assess one or more radio link qualities of the BFD RS set q0 according to one or more of the followings.
In one example, the UE could assess the radio link quality of the BFD RS set q0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘00’ as specified herein in the present disclosure, wherein the first TCI state(s) is for the one or more CORESETs.
In another example, the UE could assess the radio link quality of the BFD RS set q0 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘01’ as specified herein in the present disclosure, wherein the second TCI state(s) is for the one or more CORESETs.
In yet another example, the UE could determine, or access two radio link qualities of the BFD RS set q0. For instance, the UE could assess a first radio link quality of the BFD RS set q0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more first CORESETs configured/associated with the first indicator set to ‘00’ as specified herein in the present disclosure, wherein the first TCI state(s) is for the one or more first CORESETs, and a second radio link quality of the BFD RS set q0 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more second CORESETs configured/associated with the first indicator set to ‘01’ as specified herein in the present disclosure, wherein the second TCI state(s) is for the one or more second CORESETs.
In yet another example, the UE could assess the radio link quality of the BFD RS set q0 according to SSBs on the PCell or the PSCell or periodic CSI-RS resource configurations that are in the first and second TCI states among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘10’ or ‘11’ as specified herein in the present disclosure, wherein both of the first and second TCI states are for the one or more CORESETs.
In yet another example, the UE could determine, or access two radio link qualities of the BFD RS set q0. For instance, the UE could assess a first radio link quality of the BFD RS set q0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘10’ or ‘11’ as specified herein in the present disclosure, and a second radio link quality of the BFD RS set q0 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘10’ or ‘11’ as specified herein in the present disclosure, wherein both of the first and second TCI states are for the one or more CORESETs.
In yet another example, the UE (e.g. the UE 116) could assess the radio link quality of the BFD RS set q0 according to SSBs on the PCell or the PSCell or periodic CSI-RS resource configurations that are in a TCI state indicated for receiving/monitoring PDCCH/PDCCH candidate(s) in one or more CORESETs configured/associated with the first indicator set to ‘11’ as specified herein in the present disclosure, wherein (i) the TCI state could be provided by TCI-State and for the one or more CORESETs, and/or (ii) the TCI state is not in the set of indicated TCI states/pairs of TCI states as specified herein in the present disclosure.

According to the described/specified design examples herein, the UE could assess the radio link quality of the BFD RS set q0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure, when/if the first TCI state(s), among the set of one or more (e.g., N=2) TCI states/pairs of TCI states indicated, e.g., by a TCI codepoint, in a beam indication DCI or MAC CE as specified herein in the present disclosure, is indicated for at least one CORESET or used/applied for PDCCH reception, wherein as specified herein in the present disclosure, the first indicator configured for or associated to PDCCH(s)/PDCCH candidate(s) received in the CORESET could be set to ‘00’ or ‘10’ or ‘11’.

According to the described/specified design examples herein, the UE could assess the radio link quality of the BFD RS set q0 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure, when/if the second TCI state(s), among the set of one or more (e.g., N=2) TCI states/pairs of TCI states indicated, e.g., by a TCI codepoint, in a beam indication DCI or MAC CE as specified herein in the present disclosure, is indicated for at least one CORESET or used/applied for PDCCH reception, wherein as specified herein in the present disclosure, the first indicator configured for or associated to PDCCH(s)/PDCCH candidate(s) received in the CORESET could be set to ‘01’ or ‘10’ or ‘11’.

According to the described/specified design examples herein, the UE could assess the radio link quality of the BFD RS set q0 according to SSBs on the PCell or the PSCell or periodic CSI-RS resource configurations that are in the first and second TCI states among the set of one or more (e.g., N=2) TCI states/pairs of TCI states indicated, e.g., by a TCI codepoint, in a beam indication DCI or MAC CE as specified herein in the present disclosure, when/if both of the first and second TCI states, among the set of one or more (e.g., N=2) TCI states/pairs of TCI states indicated, e.g., by a TCI codepoint, in a beam indication DCI or MAC CE as specified herein in the present disclosure, are indicated for at least one CORESET or used/applied for PDCCH reception, wherein as specified herein in the present disclosure, the first indicator configured for or associated to PDCCH(s)/PDCCH candidate(s)—e.g., the first and second PDCCH candidates—received in the CORESET(s) could be set to ‘10’ or ‘11’.

In one embodiment, a UE could use/apply one or more of S>1 (e.g., two) BFD RS sets—e.g., denoted by q0_0 and q0_1—to monitor radio link quality(s) for (single-DCI based) multi-TRP operation. As specified herein in the present disclosure, the UE could be first configured by the network, e.g., via higher layer RRC signaling/parameter, one or more (e.g., two) sets of BFD RSs or BFD RS IDs. The UE could then receive from the network, e.g., one or more (e.g., two) BFD RS MAC CE activation/subselection commands (or one or more BFD RS indication MAC CEs) that respectively activate/subselect one or more BFD RSs or BFD RS IDs from the one or more sets, to respectively update one or more BFD RSs in one or more of the S>1 BFD RS sets (e.g., q0_0 and q0_1). In the present disclosure, various design examples and methods are presented under S=2; they can be extended to system settings and/or assumptions with S>2.

For S=2 or N=2, the two BFD RS sets q0_0 and q0_1 could be (one-to-one) mapped/associated to the (set of) two TCI states/pairs of TCI states indicated, e.g., by a TCI codepoint, in a beam indication DCI or MAC CE as specified herein in the present disclosure.
For example, the first BFD RS set q0_0 could be mapped/associated to the first TCI state(s)—identified among the set of one or more (e.g., N=2) TCI states/pairs of TCI states indicated, e.g., by a TCI codepoint, in a beam indication DCI or MAC CE as specified herein in the present disclosure, and the second BFD RS set q0_0 could be mapped/associated to the second TCI state(s)—identified among the set of one or more (e.g., N=2) TCI states/pairs of TCI states indicated, e.g., by a TCI codepoint, in a beam indication DCI or MAC CE as specified herein in the present disclosure.
For another example, the first BFD RS set q0_0 could be mapped/associated to the second TCI state(s)—identified among the set of one or more (e.g., N=2) TCI states/pairs of TCI states indicated, e.g., by a TCI codepoint, in a beam indication DCI or MAC CE as specified herein in the present disclosure, and the second BFD RS set q0_0 could be mapped/associated to the first TCI state(s)—identified among the set of one or more (e.g., N=2) TCI states/pairs of TCI states indicated, e.g., by a TCI codepoint, in a beam indication DCI or MAC CE as specified herein in the present disclosure.
Yet for another example, the UE could be indicated/configured/provided by the network (e.g. the network 130), e.g., via higher layer RRC signaling/parameter and/or MAC CE command and/or dynamic DCI based L1 signaling, the mapping/association relationship between the two BFD RS sets q0_0 and q0_1 and the (set of) two TCI states/pairs of TCI states indicated, e.g., by a TCI codepoint, in a beam indication DCI or MAC CE as specified herein in the present disclosure.

Depending on which one or more of the TCI states—among the set of one or more (e.g., N=2) TCI states/pairs of TCI states indicated, e.g., by a TCI codepoint, in a beam indication DCI or MAC CE as specified herein in the present disclosure—are used/applied for transmitting or receiving channels/signals (e.g., indicated by the first, second, third and/or fourth indicators as specified herein in the present disclosure), the UE could assess the radio link quality(s) of the associated/corresponding BFD RS set(s)—e.g., q0_0 and/or q0_1—as specified herein in the present disclosure, to detect beam failure(s). In the following design examples, the first BFD RS set q0_0 is mapped/associated to the first indicated TCI state and the second BFD RS set q0_1 is mapped/associated to the second indicated TCI state. The design examples specified in the present disclosure can be extended/applied to when the first BFD RS set q0_0 is mapped/associated to the second indicated TCI state and the second BFD RS set q0_1 is mapped/associated to the first indicated TCI state.
In one example, the UE could assess the radio link quality of the first BFD RS set q0_0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure.
In another example, the UE could assess the radio link quality of the second BFD RS set q0_1 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure.
In yet another example, the UE could assess a first radio link quality of the first BFD RS set q0_0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure, and a second radio link quality of the second BFD RS set q0_1 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure.

When a UE receives the first indicator for one or more CORESETs as specified herein in the present disclosure, the UE would determine or assess radio link quality(s) of the first BFD RS set q0_0 and/or the second BFD RS set q0_1 according to one or more of the followings.
In one example, the UE could assess the radio link quality of the first BFD RS set q0_0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘00’ as specified herein in the present disclosure, wherein the first TCI state(s) is for the one or more CORESETs.
In another example, the UE could assess the radio link quality of the second BFD RS set q0_1 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘01’ as specified herein in the present disclosure, wherein the second TCI state(s) is for the one or more CORESETs.
In yet another example, the UE could assess a first radio link quality of the first BFD RS set q0_0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more first CORESETs configured/associated with the first indicator set to ‘00’ as specified herein in the present disclosure, wherein the first TCI state(s) is for the one or more first CORESETs, and a second radio link quality of the second BFD RS set q0_1 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more second CORESETs configured/associated with the first indicator set to ‘01’ as specified herein in the present disclosure, wherein the second TCI state(s) is for the one or more second CORESETs.
In yet another example, the UE could assess a first radio link quality of the first BFD RS set q0_0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘10’ or ‘11’ as specified herein in the present disclosure, and a second radio link quality of the second BFD RS set q0_1 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure, for receiving/monitoring PDCCH/PDCCH candidate(s) in one or more CORESETs configured/associated with the first indicator set to ‘10’ or ‘11’ as specified herein in the present disclosure, wherein both of the first and second TCI states are for the one or more CORESETs.

According to the described/specified design examples herein, the UE could assess the radio link quality of the first BFD RS set q0_0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure, when/if the first TCI state(s), among the set of one or more (e.g., N=2) TCI states/pairs of TCI states indicated, e.g., by a TCI codepoint, in a beam indication DCI or MAC CE as specified herein in the present disclosure, is indicated for at least one CORESET or used/applied for PDCCH reception, wherein as specified herein in the present disclosure, the first indicator configured for or associated to PDCCH(s)/PDCCH candidate(s) received in the CORESET could be set to ‘00’ or ‘10’ or ‘11’.

According to the described/specified design examples herein, the UE could assess the radio link quality of the second BFD RS set q0_1 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure, when/if the second TCI state(s), among the set of one or more (e.g., N=2) TCI states/pairs of TCI states indicated, e.g., by a TCI codepoint, in a beam indication DCI or MAC CE as specified herein in the present disclosure, is indicated for at least one CORESET or used/applied for PDCCH reception, wherein as specified herein in the present disclosure, the first indicator configured for or associated to PDCCH(s)/PDCCH candidate(s) received in the CORESET could be set to ‘01’ or ‘10’ or ‘11’.

According to the described/specified design examples herein, the UE could assess a first radio link quality of the first BFD RS set q0_0 according to SSBs on the PCell or the PSCell or periodic CSI-RS resource configurations that are in the first TCI state(s) among the set of one or more (e.g., N=2) TCI states/pairs of TCI states indicated, e.g., by a TCI codepoint, in a beam indication DCI or MAC CE as specified herein in the present disclosure, and a second radio link quality of the second BFD RS set q0_1 according to SSBs on the PCell or the PSCell or periodic CSI-RS resource configurations that are in the second TCI state(s) among the set of one or more (e.g., N=2) TCI states/pairs of TCI states indicated, e.g., by a TCI codepoint, in a beam indication DCI or MAC CE as specified herein in the present disclosure, when/if both of the first and second TCI states, among the set of one or more (e.g., N=2) TCI states/pairs of TCI states indicated, e.g., by a TCI codepoint, in a beam indication DCI or MAC CE as specified herein in the present disclosure, are indicated for at least one CORESET or used/applied for PDCCH reception, wherein as specified herein in the present disclosure, the first indicator configured for or associated to PDCCH(s)/PDCCH candidate(s)—e.g., the first and second PDCCH candidates—received in the CORESET(s) could be set to ‘10’ or ‘11’.

For a (or any or every) BFD RS set specified herein in the present disclosure, the higher layers in the UE would increment beam failure instance (BFI) count (by one) in the BFI counter (denoted by BFI_COUNTER) associated/corresponding to the BFD RS set if the higher layers receive from the physical layer in the UE that the radio link quality of the BFD RS set is worse than a threshold Qout. The UE would declare a beam failure for the BFD RS set if the BFI count in the BFI counter BFI_COUNTER for the BFD RS set reaches the maximum number of BFI counts (e.g., provided by the higher layer parameter maxBFIcount) before a BFD timer expires. After the higher layers in the UE declare the beam failure for the BFD RS set, the higher layers in the UE would reset the BFI count in the corresponding/associated BFI counter BFI_COUNTER or the BFD timer to zero.

For a (or any or every) BFD RS set specified herein in the present disclosure, the UE could be configured with/provided by the network, e.g., via the higher layer parameter candidateBeamRSList, a new beam identification (NBI) RS set of periodic CSI-RS resource configuration indexes or SSB indexes—corresponding/associated to the BFD RS set—for radio link quality measurement. The NBI RS set—as discussed herein, corresponding/associated to the BFD RS set—is used for identifying new beam(s) to recover the failed beam(s)/link(s) for the BFD RS set (and therefore, the corresponding channel(s)/signal(s) or TRP). The UE expects single-port or two-port CSI-RS with frequency density equal to 1 or 3 REs per resource block (RB) in the NBI RS set. The UE could assess the radio link quality according to the NBI RS set of resource configurations against a threshold Qin. The UE would apply the Qin threshold to the L1-RSRP measurement obtained from a SSB in the NBI RS set, and apply the Qin threshold to the L1-RSRP measurement obtained from a CSI-RS resource in the NBI RS set after scaling a respective CSI-RS reception power with a value provided by powerControlOffset. According to the L1-RSRP measurements, the UE could identify the periodic CSI-RS resource configuration index or SSB index in the NBI RS set, denoted by q_new, that corresponds to the largest/highest measured L1-RSRP among those larger than or equal to the Qin threshold.

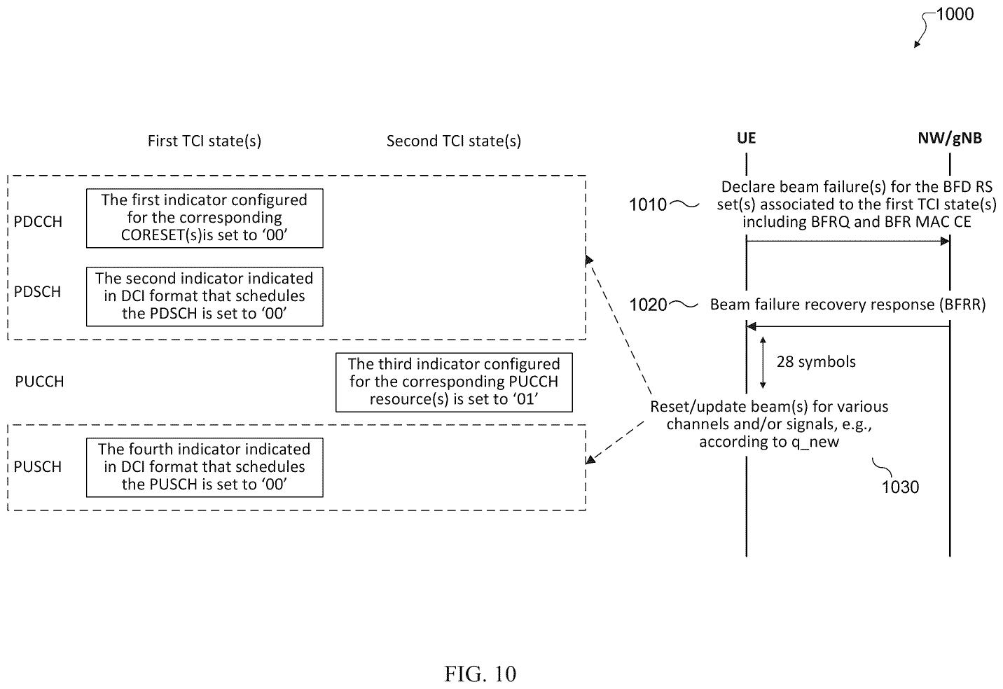

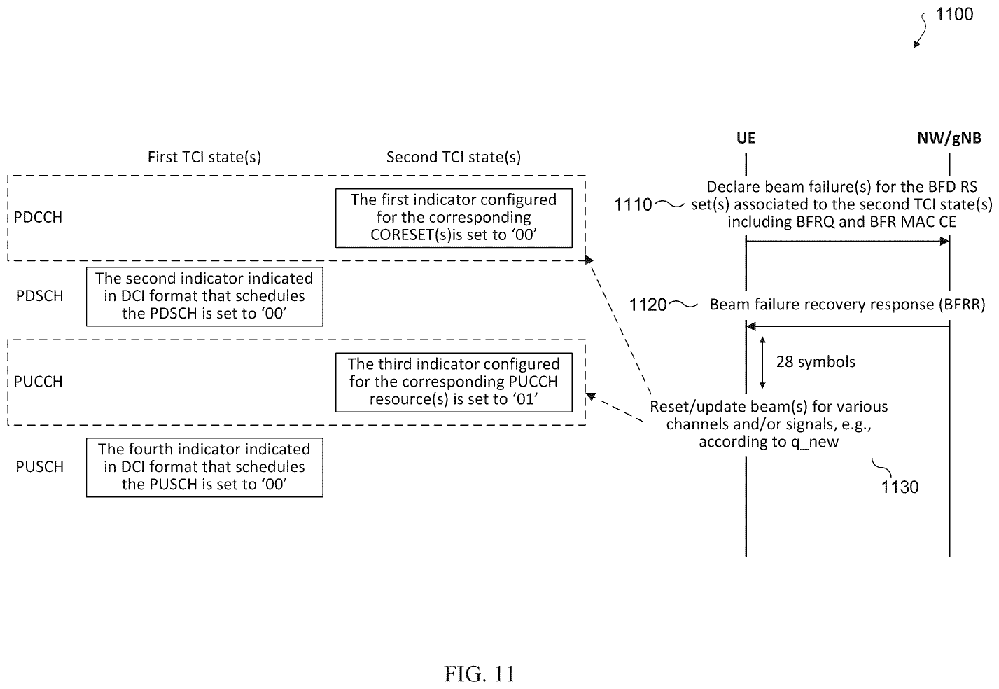

FIG. 10 illustrates an example procedure 1000 for beam resetting/updating according to embodiments of the present disclosure. For example, procedure 1000 for beam resetting/updating can be performed by the UE 116 and the gNB 102 and/or the network 130 in the wireless network 100 of FIG. 1. This example is for illustration only and other embodiments can be used without departing from the scope of the present disclosure.

The procedure begins in 1010, the UE sends declaration of beam failure(s) for the BFD RS set(s) associated to the first TCI state(s) including BFRQ and BFR MAC CE to the gNB 102 and/or the network 130. In 1020, the gNB 102 and/or the network 130 sends beam failure recovery response (BFRR) to the UE 116. In 1030, the UE 116 resets/updates beam(s) for various channels and/or signals, e.g., according to q_new.

A BFD RS set could be associated/corresponding to one or more TCI states—among the set of one or more (e.g., N=2) TCI states/pairs of TCI states indicated, e.g., by a TCI codepoint, in a beam indication DCI or MAC CE as specified herein in the present disclosure—indicated for at least UE-dedicated DL and/or UL channels/signals. For example, a BFD RS set could include periodic CSI-RS resource configuration indexes or SSB indexes (also referred to as BFD RS resource indexes) with same values as the RS indexes in the RS sets in the first TCI state(s) and/or the second TCI state(s) (e.g., for N=2)—among the set of one or more (e.g., N=2) TCI states/pairs of TCI states indicated, e.g., by a TCI codepoint, in a beam indication DCI or MAC CE as specified herein in the present disclosure; for this case, whether the first TCI state(s) and/or the second TCI state(s) are used/applied could be determined according to one or more of the followings: (1) fixed in the system specification(s), (2) configured/provided/indicated by the network, e.g., via higher layer RRC signaling/parameter and/or MAC CE command and/or dynamic DCI based L1 signaling, and (3) depending on the first, second, third and/or fourth indicators as specified herein in the present disclosure and/or their association(s) to the first, second, third and/or fourth indicators. For another example, the UE could assess the radio link quality(s) of a RRC configured and/or MAC CE indicated BFD RS set according to the RS indexes in the RS sets in the first TCI state(s) and/or the second TCI state(s) (e.g., for N=2)—among the set of one or more (e.g., N=2) TCI states/pairs of TCI states indicated, e.g., by a TCI codepoint, in a beam indication DCI or MAC CE as specified herein in the present disclosure; for this case, whether the first TCI state(s) and/or the second TCI state(s) are used/applied could be determined according to one or more of the followings: (1) fixed in the system specification(s), (2) configured/provided/indicated by the network, e.g., via higher layer RRC signaling/parameter and/or MAC CE command and/or dynamic DCI based L1 signaling, and (3) depending on the first, second, third and/or fourth indicators as specified herein in the present disclosure and/or their association(s) to the first, second, third and/or fourth indicators. For configuring/determining one or more BFD RSs in one or more BFD RS sets as specified herein in the present disclosure, the first TCI state(s) or the second TCI state(s)—as specified herein in the present disclosure—could correspond to a joint DL and UL TCI state provided by TCI-State/DLorJointTCI-State, a separate DL TCI state provided by TCI-State/DLorJointTCI-State, or the separate DL TCI state in a pair of DL and UL TCI states. Throughout the present disclosure, if the radio link quality of one or more BFD RSs in one or more BFD RS sets (or equivalently, the radio link quality of one or more BFD RS sets) is worse than a threshold (e.g., Qout,LR), the (higher layers of) UE could declare beam failure(s) for the one or more BFD RSs in the one or more BFD RS sets (or equivalently, for the one or more BFD RS sets).

In one embodiment, a UE could monitor and declare beam failure(s) for a single TRP in a (single-DCI based) multi-TRP (MTRP) system. As specified herein, a UE could assess the radio link quality(s) of one or more BFD RSs in one or more BFD RS sets associated to the first TCI state(s) or the second TCI state(s) among the set of one or more (e.g., N=2) TCI states/pairs of TCI states indicated, e.g., by a TCI codepoint, in a beam indication DCI or MAC CE as specified herein in the present disclosure. For this case, the (higher layers of) UE could declare beam failure(s) for the one or more BFD RS sets having radio link quality(s) worse than Qout,LR (and therefore, the corresponding/associated first or second TCI state(s)). As specified herein in the present disclosure, the one or more BFD RS sets (and therefore, the one or more BFD RSs provided therein) being corresponding/associated to the first TCI state(s) or the second TCI state(s) could be according to the value(s) of the first indicator configured for CORESET(s)/PDCCH reception (e.g., when/if the first indicator is set to ‘00’, the BFD RS set(s) is associated to the first TCI state(s), while when/if the first indicator is set to ‘01’, the BFD RS set(s) is associated to the second TCI state(s)) and/or the second indicator indicated for PDSCH reception (e.g., when/if the second indicator is set to ‘00’, the BFD RS set(s) is associated to the first TCI state(s), while when/if the second indicator is set to ‘01’, the BFD RS set(s) is associated to the second TCI state(s)) and/or the third indicator configured for PUCCH transmission (e.g., when/if the third indicator is set to ‘00’, the BFD RS set(s) is associated to the first TCI state(s), while when/if the third indicator is set to ‘01’, the BFD RS set(s) is associated to the second TCI state(s)) and/or the fourth indicator indicated for PUSCH transmission (e.g., when/if the fourth indicator is set to ‘00’, the BFD RS set(s) is associated to the first TCI state(s), while when/if the fourth indicator is set to ‘01’, the BFD RS set(s) is associated to the second TCI state(s)).

In one example, the UE could declare beam failure(s) for the BFD RS set(s) associated to the first TCI state(s) among the set of one or more (e.g., N=2) TCI states/pairs of TCI states indicated, e.g., by a TCI codepoint, in a beam indication DCI or MAC CE as specified herein in the present disclosure. For this design example, after the UE has sent to the network beam failure recovery request (BFRQ) and necessary information related to the BFD RS set(s) having radio link quality(s) worse than Qout,LR and etc., the UE could expect to receive from the network a beam failure recovery response (BFRR), upon which the UE could reset/update the beam(s) for transmitting or receiving channels/signals associated to the BFD RS set(s)—and therefore, the first TCI state(s)—as the newly identified beam(s).

If a UE is indicated/configured/provided by the network, e.g., via higher layer RRC signaling and/or MAC CE command (e.g., via a TCI codepoint in a TCI state(s) indication/activation MAC CE) and/or dynamic DCI based L1 signaling (e.g., via a TCI codepoint of a TCI field in a beam indication DCI 1_1/1_2 with or without DL assignment), a set of one or more (unified) TCI states/pairs of TCI states for the PCell or the PSCell, and/or if the PCell or the PSCell is associated with one or more (e.g., two) BFD RS sets, and/or if the UE has declared beam failure(s)—including sending the corresponding BFRQ and information (in PUSCH MAC CE for BFR) related to the beam failure(s)—for the BFD RS set(s) associated to the first TCI state(s) among the set of one or more (e.g., N=2) TCI states/pairs of TCI states indicated, e.g., by a TCI codepoint, in a beam indication DCI or MAC CE as specified herein in the present disclosure, and/or the UE provides BFR MAC CE in Msg3 or MsgA of contention based random access procedure, after 28 symbols from a last symbol of a first PDCCH reception in a search space set provided by recoverySearchSpaceId where the UE detects a DCI format with cyclic redundancy check (CRC) scrambled by C-RNTI or modulation and coding scheme-cell radio network temporary identifier (MCS-C-RNTI) or after 28 symbols from the last symbol of the PDCCH reception that determines the completion of the contention based random access procedure, the UE could
monitor PDCCH in CORESETs or one or more CORESETs associated/corresponding to the first TCI state(s)—e.g., the one or more CORESETs configured/associated with the first indicator set to ‘00’ or ‘10’ or ‘11’ as specified herein in the present disclosure—using the same antenna port quasi co-location parameters as the ones associated with the index q_new;
receive PDSCH associated/corresponding to the first TCI state(s)—e.g., the second indicator indicated in the (downlink) DCI (e.g., DCI format 1_0/1_1/1_2) that schedules/activates/triggers the PDSCH is set to ‘00’ or ‘10’ or ‘11’ as specified herein in the present disclosure—using the same antenna port quasi co-location parameters as the ones associated with the index q_new;
receive aperiodic CSI-RS resource in a CSI-RS resource set with same indicated TCI state(s)—i.e., the first TCI state(s) here—as for the PDCCH and/or the PDSCH using the same antenna port quasi co-location parameters as the ones associated with the index q_new;
transmit PUCCH associated/corresponding to the first TCI state(s)—e.g., the corresponding PUCCH resource(s) configured/associated with the third indicator set to ‘00’ or ‘10’ or ‘11’ as specified herein in the present disclosure—using a same spatial domain filter as for the last PRACH transmission;
transmit PUSCH associated/corresponding to the first TCI state(s)—e.g., the fourth indicator indicated in the (uplink) DCI (e.g., DCI format 0_0/0_1/0_2) that schedules/activates/triggers the PUSCH is set to ‘00’ or ‘10’ or ‘11’ as specified herein in the present disclosure—using a same spatial domain filter as for the last PRACH transmission;
transmit SRS that uses a same spatial domain filter with same indicated TCI state(s)—i.e., the first TCI state(s) here—as for the PUCCH and/or the PUSCH using a same spatial domain filter as for the last PRACH transmission;
for transmitting the PUCCH, PUSCH and/or SRS as specified herein in the present disclosure, the following parameters for determination of a corresponding power can be used
   the RS index q_{d}=q_{new} for obtaining the downlink pathloss estimate
   the values of P_{O_UE_PUSCH,b,f,c}(j), α_{b,f,c}(j), and the PUSCH power control adjustment state l provided by p0-Alpha-CLID-PUSCH-Set associated with the first TCI state(s) and/or the smallest value of ul-powercontrolId for the PCell or the PSCell
   the value of P_{O_PUCCH,b,f,c}(qᵤ) and the PUCCH power control adjustment state l provided by p0-Alpha-CLID-PUCCH-Set associated with the first TCI state(s) and/or the smallest value of ul-powercontrolId for the PCell or the PSCell
   the values of P_{O_SRS,b,f,c}(qₛ), α_{SRS,b,f,c}(qₛ), and the SRS power control adjustment state l provided by p0-Alpha-CLID-SRS-Set associated with the first TCI state(s) and/or the smallest value of ul-powercontrolId for the PCell or the PSCell

Furthermore, the index q_new could correspond to a RS index determined/selected by the UE from the NBI RS set(s)—as specified herein in the present disclosure—that is associated with the BFD RS set(s) associated/corresponding to the first TCI state(s).

If a UE (e.g. the UE 116) is indicated/configured/provided by the network, e.g., via higher layer RRC signaling and/or MAC CE command (e.g., via a TCI codepoint in a TCI state(s) indication/activation MAC CE) and/or dynamic DCI based L1 signaling (e.g., via a TCI codepoint of a TCI field in a beam indication DCI 1_1/1_2 with or without DL assignment), a set of one or more (unified) TCI states/pairs of TCI states for the PCell or the PSCell, and/or if the PCell or the PSCell is associated with one or more (e.g., two) BFD RS sets, and/or if the UE has declared beam failure(s)—including sending the corresponding BFRQ and information (in PUSCH MAC CE for BFR) related to the beam failure(s)—for the BFD RS set(s) associated to the first TCI state(s) among the set of one or more (e.g., N=2) TCI states/pairs of TCI states indicated, e.g., by a TCI codepoint, in a beam indication DCI or MAC CE as specified herein in the present disclosure, after 28 symbols from a last symbol of a PDCCH reception with a DCI format scheduling a PUSCH transmission with a same HARQ process number as for the transmission of the PUSCH that carries the information related to the beam failure(s) and having a toggled new data indicator (NDI) field value, the UE could
monitor PDCCH in CORESETs or one or more CORESETs associated/corresponding to the first TCI state(s)—e.g., the one or more CORESETs configured/associated with the first indicator set to ‘00’ or ‘10’ or ‘11’ as specified herein in the present disclosure—using the same antenna port quasi co-location parameters as the ones associated with the index q_new;
receive PDSCH associated/corresponding to the first TCI state(s)—e.g., the second indicator indicated in the (downlink) DCI (e.g., DCI format 1_0/1_1/1_2) that schedules/activates/triggers the PDSCH is set to ‘00’ or ‘10’ or ‘11’ as specified herein in the present disclosure—using the same antenna port quasi co-location parameters as the ones associated with the index q_new;
receive aperiodic CSI-RS resource in a CSI-RS resource set with same indicated TCI state(s)—i.e., the first TCI state(s) here—as for the PDCCH and/or the PDSCH using the same antenna port quasi co-location parameters as the ones associated with the index q_new;
transmit PUCCH associated/corresponding to the first TCI state(s)—e.g., the corresponding PUCCH resource(s) configured/associated with the third indicator set to ‘00’ or ‘10’ or ‘11’ as specified herein in the present disclosure—using a same spatial domain filter as the one corresponding to q_new;
transmit PUSCH associated/corresponding to the first TCI state(s)—e.g., the fourth indicator indicated in the (uplink) DCI (e.g., DCI format 0_0/0_1/0_2) that schedules/activates/triggers the PUSCH is set to ‘00’ or ‘10’ or ‘11’ as specified herein in the present disclosure—using a same spatial domain filter as the one corresponding to q_new;
transmit SRS that uses a same spatial domain filter with same indicated TCI state(s)—i.e., the first TCI state(s) here—as for the PUCCH and/or the PUSCH using a same spatial domain filter as the one corresponding to q_new;
for transmitting the PUCCH, PUSCH and/or SRS as specified herein in the present disclosure, the following parameters for determination of a corresponding power can be used
   the RS index q=q_{new} for obtaining the downlink pathloss estimate
   the values of P_{O_UE_PUSCH,b,f,c}(j), α_{b,f,c}(j), and the PUSCH power control adjustment state l provided by p0-Alpha-CLID-PUSCH-Set associated with the first TCI state(s) and/or the smallest value of ul-powercontrolId for the PCell or the PSCell
   the value of P_{O_PUCCH,b,f,c}(qᵤ) and the PUCCH power control adjustment state l provided by p0-Alpha-CLID-PUCCH-Set associated with the first TCI state(s) and/or the smallest value of ul-powercontrolId for the PCell or the PSCell
   the values of P_{O_SRS,b,f,c}(qₛ), α_{SRS,b,f,c}(qₛ), and the SRS power control adjustment state l provided by p0-Alpha-CLID-SRS-Set associated with the first TCI state(s) and/or the smallest value of ul-powercontrolId for the PCell or the PSCell

Furthermore, the index q_new could correspond to a RS index determined/selected by the UE from the NBI RS set(s)—as specified herein in the present disclosure—that is associated with the BFD RS set(s) associated/corresponding to the first TCI state(s).

With reference to FIG. 10, a conceptual example depicting the described beam resetting/updating procedure herein is shown. After 28 symbols upon receiving the BFRR for the BFD RS set(s) associated to the first TCI state(s)—i.e., the BFD RS set(s) that has radio link quality worse than Q_{out,LR}, the UE would reset/update the beams for PDCCH, PDSCH and PUSCH that are associated with/to the first TCI state(s)—e.g., their respective first, second and fourth indicators are set to ‘00’—according to the index q_new. For this example, the UE would not reset/update the beam(s) for PUCCH according to the index q_new because the PUCCH is associated with/to the second TCI state(s)—e.g., the third indicator configured for the corresponding PUCCH resource(s) is set to ‘01’.

In another example, the UE could declare beam failure(s) for the BFD RS set(s) associated to the second TCI state(s) among the set of one or more (e.g., N=2) TCI states/pairs of TCI states indicated, e.g., by a TCI codepoint, in a beam indication DCI or MAC CE as specified herein in the present disclosure. For this design example, after the UE has sent to the network beam failure recovery request (BFRQ) and necessary information related to the BFD RS set(s) having radio link quality(s) worse than Qout,LR and etc., the UE could expect to receive from the network a beam failure recovery response (BFRR), upon which the UE could reset/update the beam(s) for transmitting or receiving channels/signals associated to the BFD RS set(s)—and therefore, the second TCI state(s)—as the newly identified beam(s).

If a UE is indicated/configured/provided by the network (e.g. the network 130), e.g., via higher layer RRC signaling and/or MAC CE command (e.g., via a TCI codepoint in a TCI state(s) indication/activation MAC CE) and/or dynamic DCI based L1 signaling (e.g., via a TCI codepoint of a TCI field in a beam indication DCI 1_1/1_2 with or without DL assignment), a set of one or more (unified) TCI states/pairs of TCI states for the PCell or the PSCell, and/or if the PCell or the PSCell is associated with one or more (e.g., two) BFD RS sets, and/or if the UE has declared beam failure(s)—including sending the corresponding BFRQ and information (in PUSCH MAC CE for BFR) related to the beam failure(s)—for the BFD RS set(s) associated to the second TCI state(s) among the set of one or more (e.g., N=2) TCI states/pairs of TCI states indicated, e.g., by a TCI codepoint, in a beam indication DCI or MAC CE as specified herein in the present disclosure, and/or the UE provides BFR MAC CE in Msg3 or MsgA of contention based random access procedure, after 28 symbols from a last symbol of a first PDCCH reception in a search space set provided by recoverySearchSpaceId where the UE detects a DCI format with CRC scrambled by C-RNTI or MCS-C-RNTI or after 28 symbols from the last symbol of the PDCCH reception that determines the completion of the contention based random access procedure, the UE could
monitor PDCCH in CORESETs or one or more CORESETs associated/corresponding to the second TCI state(s)—e.g., the one or more CORESETs configured/associated with the first indicator set to ‘01’ or ‘10’ or ‘11’ as specified herein in the present disclosure—using the same antenna port quasi co-location parameters as the ones associated with the index q_new;
receive PDSCH associated/corresponding to the second TCI state(s)—e.g., the second indicator indicated in the (downlink) DCI (e.g., DCI format 1_0/1_1/1_2) that schedules/activates/triggers the PDSCH is set to ‘01’ or ‘10’ or ‘11’ as specified herein in the present disclosure—using the same antenna port quasi co-location parameters as the ones associated with the index q_new;
receive aperiodic CSI-RS resource in a CSI-RS resource set with same indicated TCI state(s)—i.e., the second TCI state(s) here—as for the PDCCH and/or the PDSCH using the same antenna port quasi co-location parameters as the ones associated with the index q_new;
transmit PUCCH associated/corresponding to the second TCI state(s)—e.g., the corresponding PUCCH resource(s) configured/associated with the third indicator set to ‘01’ or ‘10’ or ‘11’ as specified herein in the present disclosure—using a same spatial domain filter as for the last PRACH transmission;
transmit PUSCH associated/corresponding to the second TCI state(s)—e.g., the fourth indicator indicated in the (uplink) DCI (e.g., DCI format 0_0/0_1/0_2) that schedules/activates/triggers the PUSCH is set to ‘01’ or ‘10’ or ‘11’ as specified herein in the present disclosure—using a same spatial domain filter as for the last PRACH transmission;
transmit SRS that uses a same spatial domain filter with same indicated TCI state(s)—i.e., the second TCI state(s) here—as for the PUCCH and/or the PUSCH using a same spatial domain filter as for the last PRACH transmission;
for transmitting the PUCCH, PUSCH and/or SRS as specified herein in the present disclosure, the following parameters for determination of a corresponding power can be used
   the RS index q_{d}=q_{new} for obtaining the downlink pathloss estimate
   the values of P_{O_UE_PUSCH,b,f,c}(j), α_{b,f,c}(j), and the PUSCH power control adjustment state l provided by p0-Alpha-CLID-PUSCH-Set associated with the second TCI state(s) and/or the smallest value of ul-powercontrolId for the PCell or the PSCell
   the value of P_{O_PUCCH,b,f,c}(qᵤ) and the PUCCH power control adjustment state l provided by p0-Alpha-CLID-PUCCH-Set associated with the second TCI state(s) and/or the smallest value of ul-powercontrolId for the PCell or the PSCell
   the values of P_{O_SRS,b,f,c}(qₛ), α_{SRS,b,f,c}(qₛ), and the SRS power control adjustment state l provided by p0-Alpha-CLID-SRS-Set associated with the second TCI state(s) and/or the smallest value of ul-powercontrolId for the PCell or the PSCell

Furthermore, the index q_new could correspond to a RS index determined/selected by the UE from the NBI RS set(s)—as specified herein in the present disclosure—that is associated with the BFD RS set(s) associated/corresponding to the second TCI state(s).

FIG. 11 illustrates an example procedure 1100 for beam resetting/updating according to embodiments of the present disclosure. For example, procedure 1100 for beam resetting/updating can be performed by the UE 116 and the gNB 102 and/or the network 130 in the wireless network 100 of FIG. 1. This example is for illustration only and other embodiments can be used without departing from the scope of the present disclosure.

The procedure begins in 1110, the UE sends declaration of beam failure(s) for the BFD RS set(s) associated to the first TCI state(s) including BFRQ and BFR MAC CE to the gNB 102 and/or the network 130. In 1120, the gNB 102 and/or the network 130 sends beam failure recovery response (BFRR) to the UE 116. In 1130, the UE 116 resets/updates beam(s) for various channels and/or signals, e.g., according to q_new.

If a UE is indicated/configured/provided by the network, e.g., via higher layer RRC signaling and/or MAC CE command (e.g., via a TCI codepoint in a TCI state(s) indication/activation MAC CE) and/or dynamic DCI based L1 signaling (e.g., via a TCI codepoint of a TCI field in a beam indication DCI 1_1/1_2 with or without DL assignment), a set of one or more (unified) TCI states/pairs of TCI states for the PCell or the PSCell, and/or if the PCell or the PSCell is associated with one or more (e.g., two) BFD RS sets, and/or if the UE has declared beam failure(s)—including sending the corresponding BFRQ and information (in PUSCH MAC CE for BFR) related to the beam failure(s)—for the BFD RS set(s) associated to the second TCI state(s) among the set of one or more (e.g., N=2) TCI states/pairs of TCI states indicated, e.g., by a TCI codepoint, in a beam indication DCI or MAC CE as specified herein in the present disclosure, after 28 symbols from a last symbol of a PDCCH reception with a DCI format scheduling a PUSCH transmission with a same HARQ process number as for the transmission of the PUSCH that carries the information related to the beam failure(s) and having a toggled NDI field value, the UE could
monitor PDCCH in CORESETs or one or more CORESETs associated/corresponding to the second TCI state(s)—e.g., the one or more CORESETs configured/associated with the first indicator set to ‘01’ or ‘10’ or ‘11’ as specified herein in the present disclosure—using the same antenna port quasi co-location parameters as the ones associated with the index q_new;
receive PDSCH associated/corresponding to the second TCI state(s)—e.g., the second indicator indicated in the (downlink) DCI (e.g., DCI format 1_0/1_1/1_2) that schedules/activates/triggers the PDSCH is set to ‘01’ or ‘10’ or ‘11’ as specified herein in the present disclosure—using the same antenna port quasi co-location parameters as the ones associated with the index q_new;
receive aperiodic CSI-RS resource in a CSI-RS resource set with same indicated TCI state(s)—i.e., the second TCI state(s) here—as for the PDCCH and/or the PDSCH using the same antenna port quasi co-location parameters as the ones associated with the index q_new;
transmit PUCCH associated/corresponding to the second TCI state(s)—e.g., the corresponding PUCCH resource(s) configured/associated with the third indicator set to ‘01’ or ‘10’ or ‘11’ as specified herein in the present disclosure—using a same spatial domain filter as the one corresponding to q_new;
transmit PUSCH associated/corresponding to the second TCI state(s)—e.g., the fourth indicator indicated in the (uplink) DCI (e.g., DCI format 0_0/0_1/0_2) that schedules/activates/triggers the PUSCH is set to ‘01’ or ‘10’ or ‘11’ as specified herein in the present disclosure—using a same spatial domain filter as the one corresponding to q_new;
transmit SRS that uses a same spatial domain filter with same indicated TCI state(s)—i.e., the second TCI state(s) here—as for the PUCCH and/or the PUSCH using a same spatial domain filter as the one corresponding to q_new;
for transmitting the PUCCH, PUSCH and/or SRS as specified herein in the present disclosure, the following parameters for determination of a corresponding power can be used
   the RS index q=q_{new} for obtaining the downlink pathloss estimate
   the values of P_{O_UE_PUSCH,b,f,c}(j), α_{b,f,c}(j), and the PUSCH power control adjustment state l provided by p0-Alpha-CLID-PUSCH-Set associated with the second TCI state(s) and/or the smallest value of ul-powercontrolId for the PCell or the PSCell
   the value of P_{O_PUCCH,b,f,c}(qᵤ) and the PUCCH power control adjustment state l provided by p0-Alpha-CLID-PUCCH-Set associated with the second TCI state(s) and/or the smallest value of ul-powercontrolId for the PCell or the PSCell
   the values of P_{O_SRS,b,f,c}(qₛ), α_{SRS,b,f,c}(qₛ), and the SRS power control adjustment state l provided by p0-Alpha-CLID-SRS-Set associated with the second TCI state(s) and/or the smallest value of ul-powercontrolId for the PCell or the PSCell

Furthermore, the index q_new could correspond to a RS index determined/selected by the UE from the NBI RS set(s)—as specified herein in the present disclosure—that is associated with the BFD RS set(s) associated/corresponding to the second TCI state(s).

With reference to FIG. 11, a conceptual example depicting the described beam resetting/updating procedure herein is shown. After 28 symbols upon receiving the BFRR for the BFD RS set(s) associated to the second TCI state(s)—i.e., the BFD RS set(s) that has radio link quality worse than Q_{out,LR}, the UE would reset/update the beams for PDCCH and PUCCH that are associated with/to the second TCI state(s)—e.g., their respective first and third indicators are set to ‘01’—according to the index q_new. For this example, the UE would not reset/update the beam(s) for PDSCH and PUSCH according to the index q_new because they are associated with/to the first TCI state(s)—e.g., the second and fourth indicators indicated for the PDSCH and PUSCH are set to ‘00’.

In one embodiment, a UE could monitor and declare beam failure(s) for one or more TRPs in a (single-DCI based) MTRP system. As specified herein, a UE could assess the radio link quality(s) of one or more BFD RSs in one or more BFD RS sets associated to the first TCI state(s) and/or the second TCI state(s) among the set of one or more (e.g., N=2) TCI states/pairs of TCI states indicated, e.g., by a TCI codepoint, in a beam indication DCI or MAC CE as specified herein in the present disclosure. For this case, the (higher layers of) UE could declare beam failure(s) for the one or more BFD RS sets having radio link quality(s) worse than Qout,LR (and therefore, the corresponding/associated first and/or second TCI state(s)). As specified herein in the present disclosure, the one or more BFD RS sets (and therefore, the one or more BFD RSs provided therein) being corresponding/associated to the first TCI state(s) and/or the second TCI state(s) could be according to the value(s) of the first indicator configured for CORESET(s)/PDCCH reception (e.g., when/if the first indicator is set to ‘00’, the BFD RS set(s) is associated to the first TCI state(s), when/if the first indicator is set to ‘01’, the BFD RS set(s) is associated to the second TCI state(s), while when/if the first indicator is set to ‘10’ or ‘11’, the BFD RS set(s) is associated to both the first and second TCI states) and/or the second indicator indicated for PDSCH reception (e.g., when/if the second indicator is set to ‘00’, the BFD RS set(s) is associated to the first TCI state(s), when/if the second indicator is set to ‘01’, the BFD RS set(s) is associated to the second TCI state(s), while when/if the second indicator is set to ‘10’ or ‘11’, the BFD RS set(s) is associated to both the first and second TCI states) and/or the third indicator configured for PUCCH transmission (e.g., when/if the third indicator is set to ‘00’, the BFD RS set(s) is associated to the first TCI state(s), when/if the third indicator is set to ‘01’, the BFD RS set(s) is associated to the second TCI state(s), while when/if the third indicator is set to ‘10’ or ‘11’, the BFD RS set(s) is associated to both the first and second TCI states) and/or the fourth indicator indicated for PUSCH transmission (e.g., when/if the fourth indicator is set to ‘00’, the BFD RS set(s) is associated to the first TCI state(s), when/if the fourth indicator is set to ‘01’, the BFD RS set(s) is associated to the second TCI state(s), while when/if the fourth indicator is set to ‘10’ or ‘11’, the BFD RS set(s) is associated to both the first and second TCI states).

In one example, the UE could declare beam failure(s) for the BFD RS set(s) associated to both the first and second TCI states among the set of one or more (e.g., N=2) TCI states/pairs of TCI states indicated, e.g., by a TCI codepoint, in a beam indication DCI or MAC CE as specified herein in the present disclosure. For this design example, after the UE has sent to the network beam failure recovery request (BFRQ) and necessary information related to the BFD RS set(s) having radio link quality(s) worse than Qout,LR and etc., the UE could expect to receive from the network a beam failure recovery response (BFRR), upon which the UE could reset/update the beam(s) for transmitting or receiving channels/signals associated to the BFD RS set(s)—and therefore, the first TCI state(s) and/or the second TCI state(s)—as the newly identified beam(s).

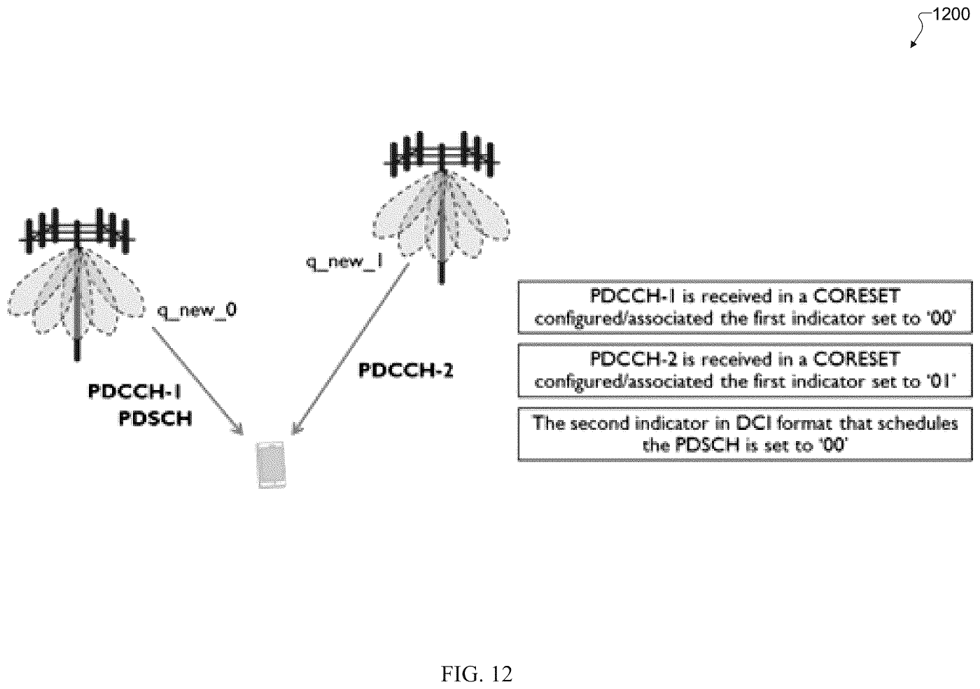

FIG. 12 illustrates an example system 1200 for receiving PDCCH(s) and PDSCH according to embodiments of the present disclosure. For example, the system 1200 may operate within the wireless network 100 in FIG. 1. This example is for illustration only and other embodiments can be used without departing from the scope of the present disclosure.

If a UE is indicated/configured/provided by the network, e.g., via higher layer RRC signaling and/or MAC CE command (e.g., via a TCI codepoint in a TCI state(s) indication/activation MAC CE) and/or dynamic DCI based L1 signaling (e.g., via a TCI codepoint of a TCI field in a beam indication DCI 1_1/1_2 with or without DL assignment), a set of one or more (unified) TCI states/pairs of TCI states for the PCell or the PSCell, and/or if the PCell or the PSCell is associated with one or more (e.g., two) BFD RS sets, and/or if the UE has declared beam failure(s)—including sending the corresponding BFRQ and information (in PUSCH MAC CE for BFR) related to the beam failure(s)—for the BFD RS set(s) associated to the first TCI state(s) and/or the second TCI state(s) among the set of one or more (e.g., N=2) TCI states/pairs of TCI states indicated, e.g., by a TCI codepoint, in a beam indication DCI or MAC CE as specified herein in the present disclosure, and/or the UE provides BFR MAC CE in Msg3 or MsgA of contention based random access procedure, after 28 symbols from a last symbol of a first PDCCH reception in a search space set provided by recoverySearchSpaceId where the UE detects a DCI format with CRC scrambled by C-RNTI or MCS-C-RNTI or after 28 symbols from the last symbol of the PDCCH reception that determines the completion of the contention based random access procedure,
for PDCCH reception, the UE could
   monitor PDCCH in CORESETs or one or more CORESETs associated/corresponding to the first TCI state(s)—e.g., the one or more CORESETs configured/associated with the first indicator set to ‘00’ as specified herein in the present disclosure—using the same antenna port quasi co-location parameters as the ones associated with the index q_new_0;
   monitor PDCCH in CORESETs or one or more CORESETs associated/corresponding to the second TCI state(s)—e.g., the one or more CORESETs configured/associated with the first indicator set to ‘01’ as specified herein in the present disclosure—using the same antenna port quasi co-location parameters as the ones associated with the index q_new_1;
   monitor first PDCCH in CORESETs or one or more CORESETs associated/corresponding to the first (or second) TCI state(s)—e.g., the one or more CORESETs configured/associated with the first indicator set to ‘10’ (or ‘11’) as specified herein in the present disclosure—using the same antenna port quasi co-location parameters as the ones associated with the index q_new_0 (or q_new_1), and monitor second PDCCH in CORESETs or one or more CORESETs associated/corresponding to the second (or first) TCI state(s)—e.g., the one or more CORESETs configured/associated with the first indicator set to ‘10’ (or ‘11’) as specified herein in the present disclosure—using the same antenna port quasi co-location parameters as the ones associated with the index q_new_1 (or q_new_0), wherein the first and second PDCCHs could be fully overlapping in time or frequency (e.g., PDCCH-SFN) or partially/non-overlapping in time or frequency (e.g., PDCCH repetitions wherein the first and second PDCCHs could be received in search space sets that are higher layer linked by RRC signaling/parameter searchSpaceLinking).
for PDSCH reception, the UE could
   receive PDSCH associated/corresponding to the first TCI state(s)—e.g., the second indicator indicated in the (downlink) DCI (e.g., DCI format 1_0/1_1/1_2) that schedules/activates/triggers the PDSCH is set to ‘00’ as specified herein in the present disclosure—using the same antenna port quasi co-location parameters as the ones associated with the index q_new_0;
   receive PDSCH associated/corresponding to the second TCI state(s)—e.g., the second indicator indicated in the (downlink) DCI (e.g., DCI format 1_0/1_1/1_2) that schedules/activates/triggers the PDSCH is set to ‘01’ as specified herein in the present disclosure—using the same antenna port quasi co-location parameters as the ones associated with the index q_new_1;
   receive first PDSCH associated/corresponding to the first (or second) TCI state(s)—e.g., the second indicator indicated in the (downlink) DCI (e.g., DCI format 1_0/1_1/1_2) that schedules/activates/triggers the first PDSCH is set to ‘10’ (or ‘11’) as specified herein in the present disclosure—using the same antenna port quasi co-location parameters as the ones associated with the index q_new_0, and receive second PDSCH associated/corresponding to the second (or first) TCI state(s)—e.g., the second indicator indicated in the (downlink) DCI (e.g., DCI format 1_0/1_1/1_2) that schedules/activates/triggers the second PDSCH is set to ‘10’ (or ‘11’) as specified herein in the present disclosure—using the same antenna port quasi co-location parameters as the ones associated with the index q_new_1, wherein the first and second PDSCHs could be fully overlapping in time or frequency (e.g., PDSCH-SFN) or partially/non-overlapping in time or frequency (e.g., PDSCH repetitions or transmission occasions).
for CSI-RS reception, the UE could receive aperiodic CSI-RS resource in a CSI-RS resource set with same indicated TCI state(s)—i.e., the first and/or second TCI states here—as for the PDCCH(s) and/or the PDSCH(s) using the same antenna port quasi co-location parameters as the ones associated with the index q_new_0 and/or q_new_1
   for example, the UE could receive the aperiodic CSI-RS associated/corresponding to the first TCI state(s)—e.g., triggered by DCI format/PDCCH received in CORESET(s) configured/associated with the first indicator set to ‘00’ as specified herein in the present disclosure—using the same antenna port quasi co-location parameters as the ones associated with the index q_new_0;
   for another example, the UE could receive the aperiodic CSI-RS associated/corresponding to the second TCI state(s)—e.g., triggered by DCI format/PDCCH received in CORESET(s) configured/associated with the first indicator set to ‘01’ as specified herein in the present disclosure—using the same antenna port quasi co-location parameters as the ones associated with the index q_new_1;
   yet for another example, the UE could receive the aperiodic CSI-RS associated/corresponding to the first TCI state(s) and/or the second TCI state(s)—e.g., triggered by DCI format/PDCCH received in CORESET(s) configured/associated with the first indicator set to ‘10’ or ‘11’ as specified herein in the present disclosure—using the same antenna port quasi co-location parameters as the ones associated with the index q_new_0 and/or q_new_1.
for PUCCH transmission, the UE could
   transmit PUCCH associated/corresponding to the first TCI state(s)—e.g., the corresponding PUCCH resource(s) configured/associated with the third indicator set to ‘00’ as specified herein in the present disclosure—using a same spatial domain filter as for the last PRACH transmission—e.g., associated/corresponding to the first TCI state(s);
   transmit PUCCH associated/corresponding to the second TCI state(s)—e.g., the corresponding PUCCH resource(s) configured/associated with the third indicator set to ‘01’ as specified herein in the present disclosure—using a same spatial domain filter as for the last PRACH transmission—e.g., associated/corresponding to the second TCI state(s);
   transmit first PUCCH associated/corresponding to the first (or second) TCI state(s)—e.g., the corresponding PUCCH resource(s) configured/associated with the third indicator set to ‘10’ (or ‘11’) as specified herein in the present disclosure—using a same spatial domain filter as for the last PRACH transmission—e.g., associated/corresponding to the first TCI state(s), and transmit second PUCCH associated/corresponding to the second (or first) TCI state(s)—e.g., the corresponding PUCCH resource(s) configured/associated with the third indicator set to ‘10’ (or ‘11’) as specified herein in the present disclosure—using a same spatial domain filter as for the last PRACH transmission—e.g., associated/corresponding to the second TCI state(s), wherein the first and second PUCCHs could be fully overlapping in time or frequency (e.g., PUCCH-SFN) or partially/non-overlapping in time or frequency (e.g., PUCCH repetitions or transmission occasions).
for PUSCH transmission, the UE (e.g. the UE 116) could
   transmit PUSCH associated/corresponding to the first TCI state(s)—e.g., the fourth indicator indicated in the (uplink) DCI (e.g., DCI format 0_0/0_1/0_2) that schedules/activates/triggers the PUSCH is set to ‘00’ as specified herein in the present disclosure—using a same spatial domain filter as for the last PRACH transmission—e.g., associated/corresponding to the first TCI state(s);
   transmit PUSCH associated/corresponding to the second TCI state(s)—e.g., the fourth indicator indicated in the (uplink) DCI (e.g., DCI format 0_0/0_1/0_2) that schedules/activates/triggers the PUSCH is set to ‘01’ as specified herein in the present disclosure—using a same spatial domain filter as for the last PRACH transmission—e.g., associated/corresponding to the second TCI state(s);
   transmit first PUSCH associated/corresponding to the first (or second) TCI state(s)—e.g., the fourth indicator indicated in the (uplink) DCI (e.g., DCI format 0_0/0_1/0_2) that schedules/activates/triggers the PUSCH is set to ‘10’ (or ‘11’) as specified herein in the present disclosure—using a same spatial domain filter as for the last PRACH transmission—e.g., associated/corresponding to the first TCI state(s), and transmit second PUSCH associated/corresponding to the second (or first) TCI state(s)—e.g., the fourth indicator indicated in the (uplink) DCI (e.g., DCI format 0_0/0_1/0_2) that schedules/activates/triggers the PUSCH is set to ‘10’ (or ‘11’) as specified herein in the present disclosure—using a same spatial domain filter as for the last PRACH transmission—e.g., associated/corresponding to the second TCI state(s), wherein the first and second PUSCHs could be fully overlapping in time or frequency (e.g., PUSCH-SFN) or partially/non-overlapping in time or frequency (e.g., PUSCH repetitions or transmission occasions).
for SRS transmission, the UE could transmit SRS that uses same spatial filter(s) with same indicated TCI state(s)—i.e., the first and/or second TCI states here—as for the PUCCH(s) and/or the PUSCH(s) using same spatial domain filter(s) as for the last PRACH transmission(s)—e.g., associated/corresponding to the first TCI state(s) and/or the second TCI state(s)
   for example, the UE could transmit the (aperiodic) SRS associated/corresponding to the first TCI state(s)—e.g., triggered by DCI format/PDCCH received in CORESET(s) configured/associated with the first indicator set to ‘00’ as specified herein in the present disclosure—using a same spatial domain filter as for the last PRACH transmission—e.g., associated/corresponding to the first TCI state(s);
   for another example, the UE could transmit the (aperiodic) SRS associated/corresponding to the second TCI state(s)—e.g., triggered by DCI format/PDCCH received in CORESET(s) configured/associated with the first indicator set to ‘01’ as specified herein in the present disclosure—using a same spatial domain filter as for the last PRACH transmission—e.g., associated/corresponding to the second TCI state(s);
   yet for another example, the UE could transmit the (aperiodic) SRS associated/corresponding to the first TCI state(s) and/or the second TCI state(s)—e.g., triggered by DCI format/PDCCH received in CORESET(s) configured/associated with the first indicator set to ‘10’ or ‘11’ as specified herein in the present disclosure—using same spatial domain filter(s) as for the last PRACH transmission(s)—e.g., associated/corresponding to the first TCI state(s) and/or the second TCI state(s);
for transmitting the PUCCH, PUSCH and/or SRS associated/corresponding to the first TCI state(s) as specified herein in the present disclosure, the following parameters for determination of a corresponding power can be used
   the RS index q_d=q_new_0 for obtaining the downlink pathloss estimate
   the values of P_{O_UE_PUSCH,b,f,c}(j), α_{b,f,c}(j), and the PUSCH power control adjustment state l provided by p0-Alpha-CLID-PUSCH-Set associated with the first TCI state(s) and/or the smallest value of ul-powercontrolId for the PCell or the PSCell
   the value of P_{O_PUCCH,b,f,c}(qᵤ) and the PUCCH power control adjustment state l provided by p0-Alpha-CLID-PUCCH-Set associated with the first TCI state(s) and/or the smallest value of ul-powercontrolId for the PCell or the PSCell
   the values of P_{O_SRS,b,f,c}(qₛ), α_{SRS,b,f,c}(qₛ), and the SRS power control adjustment state l provided by p0-Alpha-CLID-SRS-Set associated with the first TCI state(s) and/or the smallest value of ul-powercontrolId for the PCell or the PSCell
for transmitting the PUCCH, PUSCH and/or SRS associated/corresponding to the second TCI state(s) as specified herein in the present disclosure, the following parameters for determination of a corresponding power can be used
   the RS index q_d=q_new_1 for obtaining the downlink pathloss estimate
   the values of P_{O_UE_PUSCH,b,f,c}(j), α_{b,f,c}(j), and the PUSCH power control adjustment state l provided by p0-Alpha-CLID-PUSCH-Set associated with the second TCI state(s) and/or the smallest value of ul-powercontrolId for the PCell or the PSCell
   the value of P_{O_PUCCH,b,f,c}(qᵤ) and the PUCCH power control adjustment state l provided by p0-Alpha-CLID-PUCCH-Set associated with the second TCI state(s) and/or the smallest value of ul-powercontrolId for the PCell or the PSCell
   the values of P_{O_SRS,b,f,c}(qₛ), α_{SRS,b,f,c}(qₛ), and the SRS power control adjustment state l provided by p0-Alpha-CLID-SRS-Set associated with the second TCI state(s) and/or the smallest value of ul-powercontrolId for the PCell or the PSCell

Furthermore, the index q_new_0 could correspond to a RS index determined/selected by the UE from the NBI RS set(s)—as specified herein in the present disclosure—that is associated with the BFD RS set(s) associated/corresponding to the first TCI state(s), and the index q_new_1 could correspond to a RS index determined/selected by the UE from the NBI RS set(s)—as specified herein in the present disclosure—that is associated with the BFD RS set(s) associated/corresponding to the second TCI state(s).

With reference to FIG. 12, a conceptual example depicting the described design procedures herein is shown. The UE would reset/update the TCI state(s)/beam(s) for receiving PDCCH-1 and PDSCH according to the index q_new_0 as the first indicator configured for PDCCH-1 and the second indicator indicated for the PDSCH are set to ‘00’, while the UE would reset/update the TCI state(s)/beam(s) for receiving PDCCH-2 according to the index q_new_1 because the first indicator configured for PDCCH-1 is set to ‘01’.

If a UE is indicated/configured/provided by the network (e.g. the network 130), e.g., via higher layer RRC signaling and/or MAC CE command (e.g., via a TCI codepoint in a TCI state(s) indication/activation MAC CE) and/or dynamic DCI based L1 signaling (e.g., via a TCI codepoint of a TCI field in a beam indication DCI 1_1/1_2 with or without DL assignment), a set of one or more (unified) TCI states/pairs of TCI states for the PCell or the PSCell, and/or if the PCell or the PSCell is associated with one or more (e.g., two) BFD RS sets, and/or if the UE has declared beam failure(s)—including sending the corresponding BFRQ and information (in PUSCH MAC CE for BFR) related to the beam failure(s)—for the BFD RS set(s) associated to the first TCI state(s) and/or the second TCI state(s) among the set of one or more (e.g., N=2) TCI states/pairs of TCI states indicated, e.g., by a TCI codepoint, in a beam indication DCI or MAC CE as specified herein in the present disclosure, after 28 symbols from a last symbol of a PDCCH reception with a DCI format scheduling a PUSCH transmission with a same HARQ process number as for the transmission of the PUSCH that carries the information related to the beam failure(s) and having a toggled NDI field value,
for PDCCH reception, the UE could
   monitor PDCCH in CORESETs or one or more CORESETs associated/corresponding to the first TCI state(s)—e.g., the one or more CORESETs configured/associated with the first indicator set to ‘00’ as specified herein in the present disclosure—using the same antenna port quasi co-location parameters as the ones associated with the index q_new_0;
   monitor PDCCH in CORESETs or one or more CORESETs associated/corresponding to the second TCI state(s)—e.g., the one or more CORESETs configured/associated with the first indicator set to ‘01’ as specified herein in the present disclosure—using the same antenna port quasi co-location parameters as the ones associated with the index q_new_1;
   monitor first PDCCH in CORESETs or one or more CORESETs associated/corresponding to the first (or second) TCI state(s)—e.g., the one or more CORESETs configured/associated with the first indicator set to ‘10’ (or ‘11’) as specified herein in the present disclosure—using the same antenna port quasi co-location parameters as the ones associated with the index q_new_0 (or q_new_1), and monitor second PDCCH in CORESETs or one or more CORESETs associated/corresponding to the second (or first) TCI state(s)—e.g., the one or more CORESETs configured/associated with the first indicator set to ‘10’ (or ‘11’) as specified herein in the present disclosure—using the same antenna port quasi co-location parameters as the ones associated with the index q_new_1 (or q_new_0), wherein the first and second PDCCHs could be fully overlapping in time or frequency (e.g., PDCCH-SFN) or partially/non-overlapping in time or frequency (e.g., PDCCH repetitions wherein the first and second PDCCHs could be received in search space sets that are higher layer linked by RRC signaling/parameter searchSpaceLinking).
for PDSCH reception, the UE could
   receive PDSCH associated/corresponding to the first TCI state(s)—e.g., the second indicator indicated in the (downlink) DCI (e.g., DCI format 1_0/1_1/1_2) that schedules/activates/triggers the PDSCH is set to ‘00’ as specified herein in the present disclosure—using the same antenna port quasi co-location parameters as the ones associated with the index q_new_0;
   receive PDSCH associated/corresponding to the second TCI state(s)—e.g., the second indicator indicated in the (downlink) DCI (e.g., DCI format 1_0/1_1/1_2) that schedules/activates/triggers the PDSCH is set to ‘01’ as specified herein in the present disclosure—using the same antenna port quasi co-location parameters as the ones associated with the index q_new_1;
   receive first PDSCH associated/corresponding to the first (or second) TCI state(s)—e.g., the second indicator indicated in the (downlink) DCI (e.g., DCI format 1_0/1_1/1_2) that schedules/activates/triggers the first PDSCH is set to ‘10’ (or ‘11’) as specified herein in the present disclosure—using the same antenna port quasi co-location parameters as the ones associated with the index q_new_0, and receive second PDSCH associated/corresponding to the second (or first) TCI state(s)—e.g., the second indicator indicated in the (downlink) DCI (e.g., DCI format 1_0/1_1/1_2) that schedules/activates/triggers the second PDSCH is set to ‘10’ (or ‘11’) as specified herein in the present disclosure—using the same antenna port quasi co-location parameters as the ones associated with the index q_new_1, wherein the first and second PDSCHs could be fully overlapping in time or frequency (e.g., PDSCH-SFN) or partially/non-overlapping in time or frequency (e.g., PDSCH repetitions or transmission occasions).
for CSI-RS reception, the UE could receive aperiodic CSI-RS resource in a CSI-RS resource set with same indicated TCI state(s)—i.e., the first and/or second TCI states here—as for the PDCCH(s) and/or the PDSCH(s) using the same antenna port quasi co-location parameters as the ones associated with the index q_new_0 and/or q_new_1
   for example, the UE could receive the aperiodic CSI-RS associated/corresponding to the first TCI state(s)—e.g., triggered by DCI format/PDCCH received in CORESET(s) configured/associated with the first indicator set to ‘00’ as specified herein in the present disclosure—using the same antenna port quasi co-location parameters as the ones associated with the index q_new_0;
   for another example, the UE could receive the aperiodic CSI-RS associated/corresponding to the second TCI state(s)—e.g., triggered by DCI format/PDCCH received in CORESET(s) configured/associated with the first indicator set to ‘01’ as specified herein in the present disclosure—using the same antenna port quasi co-location parameters as the ones associated with the index q_new_1;
   yet for another example, the UE could receive the aperiodic CSI-RS associated/corresponding to the first TCI state(s) and/or the second TCI state(s)—e.g., triggered by DCI format/PDCCH received in CORESET(s) configured/associated with the first indicator set to ‘10’ or ‘11’ as specified herein in the present disclosure—using the same antenna port quasi co-location parameters as the ones associated with the index q_new_0 and/or q_new_1.
for PUCCH transmission, the UE could
   transmit PUCCH associated/corresponding to the first TCI state(s)—e.g., the corresponding PUCCH resource(s) configured/associated with the third indicator set to ‘00’ as specified herein in the present disclosure—using a same spatial domain filter as the one corresponding to q_new_0;
   transmit PUCCH associated/corresponding to the second TCI state(s)—e.g., the corresponding PUCCH resource(s) configured/associated with the third indicator set to ‘01’ as specified herein in the present disclosure—using a same spatial domain filter as the one corresponding to q_new_1;
   transmit first PUCCH associated/corresponding to the first (or second) TCI state(s)—e.g., the corresponding PUCCH resource(s) configured/associated with the third indicator set to ‘10’ (or ‘11’) as specified herein in the present disclosure—using a same spatial domain filter as the one corresponding to q_new_0, and transmit second PUCCH associated/corresponding to the second (or first) TCI state(s)—e.g., the corresponding PUCCH resource(s) configured/associated with the third indicator set to ‘10’ (or ‘11’) as specified herein in the present disclosure—using a same spatial domain filter as the one corresponding to q_new_1, wherein the first and second PUCCHs could be fully overlapping in time or frequency (e.g., PUCCH-SFN) or partially/non-overlapping in time or frequency (e.g., PUCCH repetitions or transmission occasions).
for PUSCH transmission, the UE could
   transmit PUSCH associated/corresponding to the first TCI state(s)—e.g., the fourth indicator indicated in the (uplink) DCI (e.g., DCI format 0_0/0_1/0_2) that schedules/activates/triggers the PUSCH is set to ‘00’ as specified herein in the present disclosure—using a same spatial domain filter as the one corresponding to q_new_0;
   transmit PUSCH associated/corresponding to the second TCI state(s)—e.g., the fourth indicator indicated in the (uplink) DCI (e.g., DCI format 0_0/0_1/0_2) that schedules/activates/triggers the PUSCH is set to ‘01’ as specified herein in the present disclosure—using a same spatial domain filter as the one corresponding to q_new_1;
   transmit first PUSCH associated/corresponding to the first (or second) TCI state(s)—e.g., the fourth indicator indicated in the (uplink) DCI (e.g., DCI format 0_0/0_1/0_2) that schedules/activates/triggers the PUSCH is set to ‘10’ (or ‘11’) as specified herein in the present disclosure—using a same spatial domain filter as the one corresponding to q_new_0, and transmit second PUSCH associated/corresponding to the second (or first) TCI state(s)—e.g., the fourth indicator indicated in the (uplink) DCI (e.g., DCI format 0_0/0_1/0_2) that schedules/activates/triggers the PUSCH is set to ‘10’ (or ‘11’) as specified herein in the present disclosure—using a same spatial domain filter as the one corresponding to q_new_1, wherein the first and second PUSCHs could be fully overlapping in time or frequency (e.g., PUSCH-SFN) or partially/non-overlapping in time or frequency (e.g., PUSCH repetitions or transmission occasions).
for SRS transmission, the UE could transmit SRS that uses same spatial filter(s) with same indicated TCI state(s)—i.e., the first and/or second TCI states here—as for the PUCCH(s) and/or the PUSCH(s) using same spatial domain filter(s) as the one(s) corresponding to q_new_0 and q_new_1
   for example, the UE could transmit the (aperiodic) SRS associated/corresponding to the first TCI state(s)—e.g., triggered by DCI format/PDCCH received in CORESET(s) configured/associated with the first indicator set to ‘00’ as specified herein in the present disclosure—using a same spatial domain filter as the one corresponding to q_new_0;
   for another example, the UE could transmit the (aperiodic) SRS associated/corresponding to the second TCI state(s)—e.g., triggered by DCI format/PDCCH received in CORESET(s) configured/associated with the first indicator set to ‘01’ as specified herein in the present disclosure—using a same spatial domain filter as the one corresponding to q_new_1;
   yet for another example, the UE could transmit the (aperiodic) SRS associated/corresponding to the first TCI state(s) and/or the second TCI state(s)—e.g., triggered by DCI format/PDCCH received in CORESET(s) configured/associated with the first indicator set to ‘10’ or ‘11’ as specified herein in the present disclosure—using same spatial domain filter(s) as the one(s) corresponding to q_new_0 and/or q_new_1;
for transmitting the PUCCH, PUSCH and/or SRS associated/corresponding to the first TCI state(s) as specified herein in the present disclosure, the following parameters for determination of a corresponding power can be used
   the RS index q_d=q_new_0 for obtaining the downlink pathloss estimate
   the values of P_{O_UE_PUSCH,b,f,c}(j), α_{b,f,c}(j), and the PUSCH power control adjustment state l provided by p0-Alpha-CLID-PUSCH-Set associated with the first TCI state(s) and/or the smallest value of ul-powercontrolId for the PCell or the PSCell
   the value of P_{O_PUCCH,b,f,c}(qᵤ) and the PUCCH power control adjustment state l provided by p0-Alpha-CLID-PUCCH-Set associated with the first TCI state(s) and/or the smallest value of ul-powercontrolId for the PCell or the PSCell
   the values of P_{O_SRS,b,f,c}(qₛ), α_{SRS,b,f,c}(qₛ), and the SRS power control adjustment state l provided by p0-Alpha-CLID-SRS-Set associated with the first TCI state(s) and/or the smallest value of ul-powercontrolId for the PCell or the PSCell
for transmitting the PUCCH, PUSCH and/or SRS associated/corresponding to the second TCI state(s) as specified herein in the present disclosure, the following parameters for determination of a corresponding power can be used
   the RS index q_d=q_new_1 for obtaining the downlink pathloss estimate
   the values of P_{O_UE_PUSCH,b,f,c}(j), α_{b,f,c}(j), and the PUSCH power control adjustment state l provided by p0-Alpha-CLID-PUSCH-Set associated with the second TCI state(s) and/or the smallest value of ul-powercontrolId for the PCell or the PSCell
   the value of P_{O_PUCCH,b,f,c}(qᵤ) and the PUCCH power control adjustment state l provided by p0-Alpha-CLID-PUCCH-Set associated with the second TCI state(s) and/or the smallest value of ul-powercontrolId for the PCell or the PSCell
   the values of P_{O_SRS,b,f,c}(qₛ), α_{SRS,b,f,c}(qₛ), and the SRS power control adjustment state l provided by p0-Alpha-CLID-SRS-Set associated with the second TCI state(s) and/or the smallest value of ul-powercontrolId for the PCell or the PSCell

Furthermore, the index q_new_0 could correspond to a RS index determined/selected by the UE from the NBI RS set(s)—as specified herein in the present disclosure—that is associated with the BFD RS set(s) associated/corresponding to the first TCI state(s), and the index q_new_1 could correspond to a RS index determined/selected by the UE from the NBI RS set(s)—as specified herein in the present disclosure—that is associated with the BFD RS set(s) associated/corresponding to the second TCI state(s).

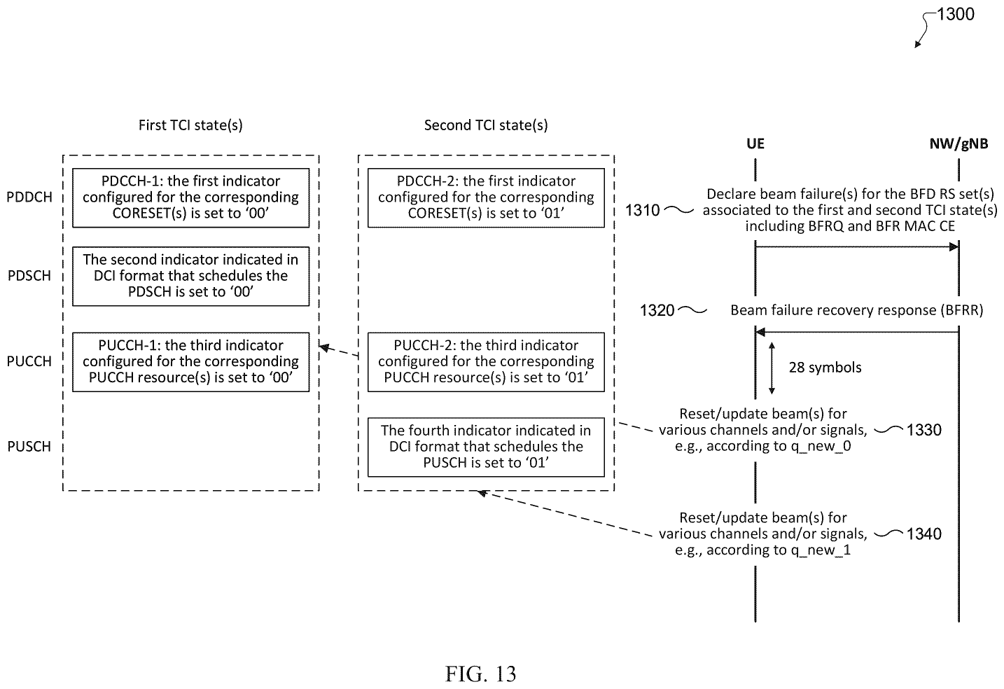

FIG. 13 illustrates an example procedure 1300 for beam resetting/updating according to embodiments of the present disclosure. For example, procedure 1300 for beam resetting/updating can be performed by the UE 116 and the gNB 102 and/or the network 130 in the wireless network 100 of FIG. 1. This example is for illustration only and other embodiments can be used without departing from the scope of the present disclosure.

The procedure begins in 1310 the UE sends declaration of beam failure(s) for the BFD RS set(s) associated to the first TCI state(s) including BFRQ and BFR MAC CE to the gNB 102 and/or the network 130. In 1320, the gNB 102 and/or the network 130 sends beam failure recovery response (BFRR) to the UE 116. In 1330, the UE 116 resets/updates beam(s) for various channels and/or signals, e.g., according to q_new_0. In 1340, the UE 116 resets/updates beam(s) for various channels and/or signals, e.g., according to q_new_1.

With reference to FIG. 13, the UE declares beam failure(s) for the BFD RS set(s) associated to both the first and second TCI states. 28 symbols after receiving the BFRR, the UE resets/updates the TCI state(s)/beam(s) for receiving PDCCH-1 and the PDSCH, and for transmitting PUCCH-1 and the PUSCH according to the index q_new_0, while the UE resets/updates the TCI state(s)/beam(s) for receiving PDCCH-2 and for transmitting PUCCH-2 according to the index q_new_1. As illustrated in FIG. 13, PDCCH-1 is associated to the first TCI state(s) as the respective first indicator is set to ‘00’, PDCCH-2 is associated to the second TCI state(s) as the respective first indicator is set to ‘01’. For the PDSCH, as the respective second indicator is set to ‘00’, it is associated to the first TCI state(s). Furthermore, PUCCH-1 and PUCCH-2 are respectively associated to the first and second TCI states as their respective third indicators are set to ‘00’ and ‘01’, respectively. For the PUSCH, as the respective fourth indicator is set to ‘01’, it is associated to the second TCI state(s).

In one example, the presence or absence of the first indicator for PDCCH reception could be configured by the network, e.g., via higher layer RRC signaling/parameter and/or MAC CE command and/or dynamic DCI based L1 signaling. When/if the first indicator is not present or is not configured, the UE could use/apply fallback or default TCI state(s)/beam(s) to receive/monitor the corresponding PDCCH(s). For this case, when/if the fallback or default TCI state(s) correspond to the first TCI state(s) and/or the second TCI state(s), 28 symbols after receiving the BFRR, the UE could reset/update the TCI state(s)/beam(s) for receiving/monitoring the PDCCH(s) according to those specified herein in the present disclosure for the corresponding first TCI state(s) and/or the second TCI state(s).

In one example, the presence or absence of the second indicator for PDSCH reception could be configured by the network, e.g., via higher layer RRC signaling/parameter and/or MAC CE command and/or dynamic DCI based L1 signaling. When/if the second indicator is not present or is not configured, the UE could use/apply fallback or default TCI state(s)/beam(s) to receive the corresponding PDSCH(s). For this case, when/if the fallback or default TCI state(s) correspond to the first TCI state(s) and/or the second TCI state(s), 28 symbols after receiving the BFRR, the UE could reset/update the TCI state(s)/beam(s) for receiving the PDSCH(s) according to those specified herein in the present disclosure for the corresponding first TCI state(s) and/or the second TCI state(s).

In one example, the presence or absence of the third indicator for PUCCH transmission could be configured by the network, e.g., via higher layer RRC signaling/parameter and/or MAC CE command and/or dynamic DCI based L1 signaling. When/if the third indicator is not present or is not configured, the UE could use/apply fallback or default TCI state(s)/beam(s) to transmit the corresponding PUCCH(s). For this case, when/if the fallback or default TCI state(s) correspond to the first TCI state(s) and/or the second TCI state(s), 28 symbols after receiving the BFRR, the UE could reset/update the TCI state(s)/beam(s) for transmitting the PUCCH(s) according to those specified herein in the present disclosure for the corresponding first TCI state(s) and/or the second TCI state(s).

In one example, the presence or absence of the fourth indicator for PUSCH transmission could be configured by the network, e.g., via higher layer RRC signaling/parameter and/or MAC CE command and/or dynamic DCI based L1 signaling. When/if the fourth indicator is not present or is not configured, the UE could use/apply fallback or default TCI state(s)/beam(s) to transmit the corresponding PUSCH(s). For this case, when/if the fallback or default TCI state(s) correspond to the first TCI state(s) and/or the second TCI state(s), 28 symbols after receiving the BFRR, the UE could reset/update the TCI state(s)/beam(s) for transmitting the PUSCH(s) according to those specified herein in the present disclosure for the corresponding first TCI state(s) and/or the second TCI state(s).

For MDCI based MTRP operation (e.g., if a UE is provided two coresetPoolIndex values 0 and 1 for the first and second CORESETs, or is not provided coresetPoolIndex value for the first CORESETs and is provided coresetPoolIndex value of 1 for the second CORESETs, respectively), the UE could receive from the network an (enhanced) unified TCI state(s) activation/deactivation MAC CE command used to map up to Ntci (e.g., Ntci=8) TCI states and/or pairs of TCI states, with one TCI state for DL channels/signals and/or one TCI state for UL channels/signals to the TCI codepoints of the DCI field ‘Transmission Configuration Indication’ for one or for a set of CCs/DL BWPs, and if applicable, for one or for a set of CCs/UL BWPs. If the (enhanced) unified TCI state(s) activation/deactivation MAC CE command maps TCI-State and/or UL-TCI-State to only one TCI codepoint, the UE would apply the indicated TCI-State and/or UL-TCI-State to one or to a set of CCs/DL BWPs, and if applicable, to one or to a set of CCs/UL BWPs once the indicated mapping for the one single TCI codepoint is applied. Furthermore, the (enhanced) unified TCI state(s) activation/deactivation MAC CE command could also provide/indicate/configure/include/contain/comprise a coresetPoolIndex value field. When/if the coresetPoolIndex value field in the (enhanced) unified TCI state(s) activation/deactivation MAC CE is set to ‘0’ (or ‘1’), the joint/DL/UL TCI state(s) activated by/in the (enhanced) unified TCI state(s) activation/deactivation MAC CE could be specific/associated to/with the coresetPoolIndex value 0 (or 1).

In one example, the UE could be indicated by the network, e.g., via one or more TCI codepoints of one or more TCI fields in one or more DCIs (e.g., DCI format 1_1/1_2 with or without DL assignment) received in one or more CORESETs associated/configured with coresetPoolIndex value 0, at least one TCI state for DL channels/signals and/or one TCI state for UL channels/signals for one or for a set of CCs/DL BWPs, and if applicable, for one or for a set of CCs/UL BWPs; for this case, the one TCI state for DL channels/signals and/or the one TCI state for UL channels/signals could be specific/associated to/with the coresetPoolIndex value 0. Furthermore, the one TCI state for DL channels/signals (and/or the one TCI state for UL channels/signals) could correspond to or replace the first TCI state(s) used throughout the present disclosure for specifying the beam resetting behaviors/operations in a single-DCI based multi-TRP system to specify beam resetting behaviors/operations in a multi-DCI based multi-TRP system (e.g., if a UE is provided two coresetPoolIndex values 0 and 1 for the first and second CORESETs, or is not provided coresetPoolIndex value for the first CORESETs and is provided coresetPoolIndex value of 1 for the second CORESETs, respectively). Furthermore, for this case, any channels, signals, information, parameters, configurations, indications, settings and etc. associated/specific to/with the first TCI state(s) as specified throughout the present disclosure could also be (said to be) associated/specific to/with coresetPoolIndex value 0 in a multi-DCI based multi-TRP system (e.g., if a UE is provided two coresetPoolIndex values 0 and 1 for the first and second CORESETs, or is not provided coresetPoolIndex value for the first CORESETs and is provided coresetPoolIndex value of 1 for the second CORESETs, respectively).

In one example, the UE (e.g. the UE 116) could be indicated by the network (e.g. the network 130), e.g., via one or more TCI codepoints of one or more TCI fields in one or more DCIs (e.g., DCI format 1_1/1_2 with or without DL assignment) received in one or more CORESETs associated/configured with coresetPoolIndex value 1, at least one TCI state for DL channels/signals and/or one TCI state for UL channels/signals for one or for a set of CCs/DL BWPs, and if applicable, for one or for a set of CCs/UL BWPs; for this case, the one TCI state for DL channels/signals and/or the one TCI state for UL channels/signals could be specific/associated to/with the coresetPoolIndex value 1. Furthermore, the one TCI state for DL channels/signals (and/or the one TCI state for UL channels/signals) could correspond to or replace the second TCI state(s) used throughout the present disclosure for specifying the beam resetting behaviors/operations in a single-DCI based multi-TRP system to specify beam resetting behaviors/operations in a multi-DCI based multi-TRP system (e.g., if a UE is provided two coresetPoolIndex values 0 and 1 for the first and second CORESETs, or is not provided coresetPoolIndex value for the first CORESETs and is provided coresetPoolIndex value of 1 for the second CORESETs, respectively). Furthermore, for this case, any channels, signals, information, parameters, configurations, indications, settings and etc. associated/specific to/with the second TCI state(s) as specified throughout the present disclosure could also be (said to be) associated/specific to/with coresetPoolIndex value 1 in a multi-DCI based multi-TRP system (e.g., if a UE is provided two coresetPoolIndex values 0 and 1 for the first and second CORESETs, or is not provided coresetPoolIndex value for the first CORESETs and is provided coresetPoolIndex value of 1 for the second CORESETs, respectively).

In one embodiment, if a UE is provided dl-OrJointTCI-StateList or TCI-UL-State and is indicated a first TCI-State or TCI-UL-State and a second TCI-State or TCI-UL-State, and/or if the UE reports its capability of supporting TRP-specific BFR under unified TCI framework with unified TCI state(s), the UE/serving cell could be configured/associated a first BFD RS set and a first NBI RS set q̅_{0,0} and q̅_{1,0}, and with a second BFD RS set and a second NBI RS set q̅_{0,1} and q̅q_{1,1}. When/if the first BFD RS set and/or the second BFD RS set (and therefore, the BFD RS resources provided/configured/indicated/determined/identified therein) is/are having radio link quality worse than Q_{out,LR}, after 28 symbols from a last symbol of a PDCCH reception with a DCI format scheduling a PUSCH transmission with a same HARQ process number as for the transmission of the PUSCH and having a toggled NDI field value, the UE
monitors PDCCH that applies the first TCI-State state, and receives PDSCH and aperiodic CSI-RS resource that apply the first TCI-State, using same antenna port quasi co-location parameters as the ones associated with a corresponding index q_{new} from q̅_{1,0}, if any, on the serving cell
monitors PDCCH that applies the second TCI-State, and receives PDSCH and aperiodic CSI-RS resource that apply the second TCI-State, on the serving cell using same antenna port quasi co-location parameters as the ones associated with a corresponding index q_{new} from q̅_{1,1}, if any, on the serving cell
transmits PUSCH, PUCCH, and SRS that apply the first TCI-State or TCI-UL-State using a same spatial domain filter as the one corresponding to q_{new} from q̅_{1,0}, if any, on the serving cell and using the following parameters for determination of a corresponding power
   the RS index q_{d}=q_{new} from q̅_{1,0}, if any, for obtaining a corresponding downlink pathloss estimate for the serving cell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
   the value of P_{O_UE_PUCCH}(qᵤ) and the PUCCH power control adjustment state l provided by p0AlphaSetforPUCCH associated with the smallest value of ul-powercontrolId for the serving cell
   the values of P_{O_UE_SRS,b,f,c}(qₛ) α_{SRS,b,f,c}(qₛ), and the SRS power control adjustment state l provided by p0AlphaSetforSRS associated with the smallest value of ul-powercontrolId for the serving cell
transmits PUSCH, PUCCH, and SRS that apply the second TCI-State or TCI-UL-State using a same spatial domain filter as the one corresponding to q_{new} from q̅_{1,1}, if any, on the serving cell and using the following parameters for determination of a corresponding power
   the RS index q_{d}=q_{new} from q̅_{1,1}, if any, for obtaining a corresponding downlink pathloss estimate for the serving cell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
   the value of P_{O_UE_PUCCH}(qᵤ) and the PUCCH power control adjustment state l provided by p0AlphaSetforPUCCH associated with the smallest value of ul-powercontrolId for the serving cell
   the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell
      where the subcarrier spacing (SCS) configuration for the 28 symbols is the smallest of the SCS configurations of the active DL BWP for the PDCCH reception and of the active DL BWP(s) of the serving cells.

In one embodiment, if a UE is provided dl-OrJointTCI-StateList or TCI-UL-State and is indicated a first TCI-State or TCI-UL-State and a second TCI-State or TCI-UL-State, and/or if the UE does not report its capability of supporting TRP-specific BFR under unified TCI framework with unified TCI state(s), the UE/serving cell could be configured/associated with a single BFD RS set q̅₀ and with a single NBI RS set q̅₁ (other than two BFD RS sets q̅_{0,0} and q̅_{0,1} and two NBI RS sets q̅_{1,0} and q̅_{1,1} when/if the UE reports its capability of supporting TRP-specific BFR under unified TCI framework with unified TCI state(s)). In this case, when the BFD RS set q₀ (and therefore, the BFD RS resource(s) provided/configured/indicated/determined/identified therein) is having radio link quality worse than Q_{out,LR}, after 28 symbols from a last symbol of a PDCCH reception with a DCI format scheduling a PUSCH transmission with a same HARQ process number as for the transmission of the PUSCH and having a toggled NDI field value, the UE could
monitor PDCCHs, and receive PDSCHs and aperiodic CSI-RS resources, using the same antenna port quasi co-location parameters as the ones associated with a corresponding index q_{new} from the NBI RS set q̅₁, if any, on the serving cell, and/or
monitor PDCCH(s) that applies the first TCI-State and/or the second TCI-State, and receive PDSCH(s) and aperiodic CSI-RS resource(s) that apply the first TCI-State and/or the second TCI-State, using the same antenna port quasi co-location parameters as the ones associated with a corresponding index q_{new} from the NBI RS set q̅₁, if any, one the serving cell, and/or
transmit PUSCHs, PUCCHs, and SRSs using a same spatial domain filter as the one corresponding to q_{new} from q̅₁, if any, on the serving cell and using the following parameters for determination of a corresponding power
   the RS index q_{d}=q_{new} from q̅₁, if any, for obtaining a corresponding downlink pathloss estimate for the serving cell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
   the value of P_{O_UE_PUCCH}(qᵤ) and the PUCCH power control adjustment state l provided by p0AlphaSetforPUCCH associated with the smallest value of ul-powercontrolId for the serving cell
   the values of P_{O_UE_SRS,b,f,c}(qₛ), α_{SRS,b,f,c}(s), and the SRS power control adjustment state l provided by p0AlphaSetforSRS associated with the smallest value of ul-powercontrolId for the serving cell and/or
transmit PUSCH, PUCCH, and SRS that apply the first TCI-State or TCI-UL-State and/or the second TCI-State or TCI-UL-State using a same spatial domain filter as the one corresponding to q_{new} from q̅₁, if any, on the serving cell and using the following parameters for determination of a corresponding power
   the RS index q=q_{new} from q̅₁, if any, for obtaining a corresponding downlink pathloss estimate for the serving cell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
   the value of P_{O_UE_PUCCH}(qᵤ) and the PUCCH power control adjustment state l provided by p0AlphaSetforPUCCH associated with the smallest value of ul-powercontrolId for the serving cell
   the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell
      where the SCS configuration for the 28 symbols is the smallest of the SCS configurations of the active DLBWP for the PDCCH reception and of the active DL BWP(s) of the serving cells. For this case—i.e., after the specified beam resetting procedure herein has been completed,
In one example, the UE could expect to receive a first or third (unified) TCI state(s) activation/deactivation MAC CE command as specified herein in the present disclosure, and/or the UE could be expected to apply the TCI codepoints—when they become applicable—activated by/in a first or third (unified) TCI state(s) activation/deactivation MAC CE command as specified herein in the present disclosure, and/or the UE could be expected to apply TCI codepoint(s) from a first/third unified TCI state(s) activation/deactivation MAC CE command as specified herein in the present disclosure to the TCI field of DCI format 1_1/1_2. Or, the UE may not expect to receive a second or fourth (unified) TCI state(s) activation/deactivation MAC CE command as specified herein in the present disclosure, and/or the UE may not be expected to apply the TCI codepoints—when they become applicable—activated by/in a second or fourth (unified) TCI state(s) activation/deactivation MAC CE command as specified herein in the present disclosure, and/or the UE may not be expected to apply TCI codepoint(s) from a second/fourth unified TCI state(s) activation/deactivation MAC CE command as specified herein in the present disclosure to the TCI field of DCI format 1_1/1_2. For this case/design example, when/if the joint/DL/UL TCI state indicated by a TCI codepoint—from the first/third (unified) TCI state(s) activation/deactivation MAC CE command as specified herein in the present disclosure—has become applicable (e.g., after the corresponding beam application time),
   For example, the UE could apply the indicated joint/DL/UL TCI state to monitor PDCCHs, and receive PDSCHs and aperiodic CSI-RS resources, and/or to transmit PUSCHs, PUCCHs, and SRSs.
   For another example, the UE could apply the indicated joint/DL/UL TCI state to monitor PDCCH(s) that applies the first TCI-State and/or the second TCI-State, and receive PDSCH(s) and aperiodic CSI-RS resource(s) that apply the first TCI-State and/or the second TCI-State, and/or to transmit PUSCH, PUCCH, and SRS that apply the first TCI-State or TCI-UL-State and/or the second TCI-State or TCI-UL-State.
In another example, the UE could expect to receive a second or fourth (unified) TCI state(s) activation/deactivation MAC CE command as specified herein in the present disclosure, and/or the UE could be expected to apply the TCI codepoints—when they become applicable—activated by/in a second or fourth (unified) TCI state(s) activation/deactivation MAC CE command as specified herein in the present disclosure, and/or the UE could be expected to apply TCI codepoint(s) from a second or fourth unified TCI state(s) activation/deactivation MAC CE command as specified herein in the present disclosure to the TCI field of DCI format 1_1/1_2. Or, the UE may not expect to receive a first or third (unified) TCI state(s) activation/deactivation MAC CE command as specified herein in the present disclosure, and/or the UE may not be expected to apply the TCI codepoints—when they become applicable—activated by/in a first or third (unified) TCI state(s) activation/deactivation MAC CE command as specified herein in the present disclosure, and/or the UE may not be expected to apply TCI codepoint(s) from a first/third unified TCI state(s) activation/deactivation MAC CE command as specified herein in the present disclosure to the TCI field of DCI format 1_1/1_2. For this case/design example, when/if the joint/DL/UL TCI state(s) indicated by a TCI codepoint—from the second/fourth (unified) TCI state(s) activation/deactivation MAC CE command as specified herein in the present disclosure—has become applicable (e.g., after the corresponding beam application time),
   For example, when/if the indicated joint/DL/UL TCI state(s) corresponds to a first TCI state,
      the UE could apply the indicated first joint/DL/UL TCI state to monitor PDCCHs, and receive PDSCHs and aperiodic CSI-RS resources, and/or to transmit PUSCHs, PUCCHs, and SRSs, and/or
      the UE could apply the indicated first joint/DL/UL TCI state to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or apply the TCI state corresponding to q_{new} from q̅₁ to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State.
   For another example, when/if the indicated joint/DL/UL TCI state(s) corresponds to a second TCI state,
      the UE could apply the indicated second joint/DL/UL TCI state to monitor PDCCHs, and receive PDSCHs and aperiodic CSI-RS resources, and/or to transmit PUSCHs, PUCCHs, and SRSs, and/or
      the UE could apply the indicated second joint/DL/UL TCI state to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State, and/or apply the TCI state corresponding to q_{new} from q̅₁ to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State.
   For another example, when/if the indicated joint/DL/UL TCI state(s) corresponds to a first TCI state and a second TCI state,
      the UE could apply the indicated first joint/DL/UL TCI state to monitor PDCCHs, and receive PDSCHs and aperiodic CSI-RS resources, and/or to transmit PUSCHs, PUCCHs, and SRSs, and/or
      the UE could apply the indicated first joint/DL/UL TCI state to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or apply the TCI state corresponding to q_{new} from q̅₁ to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State, and/or
      the UE could apply the indicated second joint/DL/UL TCI state to monitor PDCCHs, and receive PDSCHs and aperiodic CSI-RS resources, and/or to transmit PUSCHs, PUCCHs, and SRSs, and/or
      the UE could apply the indicated second joint/DL/UL TCI state to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State, and/or apply the TCI state corresponding to q_{new} from q̅₁ to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or
      the UE could apply the indicated first joint/DL/UL TCI state to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or apply the indicated second joint/DL/UL TCI state to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State.

In one embodiment, if a UE is provided dl-OrJointTCI-StateList or TCI-UL-State and is indicated a first TCI-State or TCI-UL-State and a second TCI-State or TCI-UL-State, and/or if the UE does not report its capability of supporting TRP-specific BFR under unified TCI framework with unified TCI state(s), the UE/serving cell could be configured/associated a first BFD RS set and a first NBI RS set q̅_{0,0} and q̅_{1,0}, and with a second BFD RS set and a second NBI RS set q̅_{0,1} and q̅_{1,1}. When/if the first BFD RS set and/or the second BFD RS set (and therefore, the BFD RS resources provided/configured/indicated/determined/identified therein) is/are having radio link quality worse than Q_{out,LR}, after 28 symbols from a last symbol of a PDCCH reception with a DCI format scheduling a PUSCH transmission with a same HARQ process number as for the transmission of the PUSCH and having a toggled NDI field value, the UE could monitor PDCCHs, and receive PDSCHs and aperiodic CSI-RS resources, using the same antenna port quasi co-location parameters as the ones associated with a corresponding index q_{new} from a reference NBI RS set corresponding to the NBI RS set q̅_{1,0} or q̅_{1,1}, if any, on the serving cell, and/or monitor PDCCH(s) that applies the first TCI-State and/or the second TCI-State, and receive PDSCH(s) and aperiodic CSI-RS resource(s) that apply the first TCI-State and/or the second TCI-State, using the same antenna port quasi co-location parameters as the ones associated with a corresponding index q_{new} from a reference NBI RS set corresponding to the NBI RS set q̅_{1,0} or q̅_{1,1}, if any, one the serving cell, and/or transmit PUSCHs, PUCCHs, and SRSs using a same spatial domain filter as the one corresponding to q_{new} from a reference NBI RS set corresponding to the NBI RS set q̅_{1,0} or q̅_{1,1}, if any, on the serving cell and using the following parameters for determination of a corresponding power
the RS index q_{d}=q_{new} from a reference NBI RS set corresponding to the NBI RS set q̅_{1,0} or q̅_{1,1}, if any, for obtaining a corresponding downlink pathloss estimate for the serving cell
the values of P_{O_UE_PUSCH,b,f,c}(j) α_{b,f,c}(j), and the PUSCH power control adjustment state l provided by p0AlphaSetforPUSCH associated with the smallest value of ul-powercontrolId for the serving cell
the value of P_{O_UE_PUCCH}(qᵤ) and the PUCCH power control adjustment state l provided by p0AlphaSetforPUCCH associated with the smallest value of ul-powercontrolId for the serving cell
the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell and/or
transmit PUSCH, PUCCH, and SRS that apply the first TCI-State or TCI-UL-State and/or the second TCI-State or TCI-UL-State using a same spatial domain filter as the one corresponding to q_{new} from a reference NBI RS set corresponding to the NBI RS set q̅_{1,0} or q̅_{1,1}, on the serving cell and using the following parameters for determination of a corresponding power
   the RS index q_{d}=q_{new} from a reference NBI RS set corresponding to the NBI RS set q̅_{1,0} or q̅q_{1,1}, if any, for obtaining a corresponding downlink pathloss estimate for the serving cell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
   the value of P_{O_UE_PUCCH}(qᵤ) and the PUCCH power control adjustment state l provided by p0AlphaSetforPUCCH associated with the smallest value of ul-powercontrolId for the serving cell
   the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell
      where the SCS configuration for the 28 symbols is the smallest of the SCS configurations of the active DL BWP for the PDCCH reception and of the active DL BWP(s) of the serving cells. The UE could determine/identify the reference NBI RS set (corresponding to the first NBI RS set q̅_{1,0} or the second NBI RS set q̅_{1,1}) according to: (1) fixed rule(s) in system specifications—e.g., the reference NBI RS set could correspond to the first NBI RS set q̅_{1,0}, (2) network's configuration(s)/indication(s), e.g., via higher layer RRC signalling(s)/parameter(s) and/or MAC CE command(s) and/or dynamic DCI based L1 signalling(s), and/or (3) UE's autonomous determination/selection, which could be further sent to the network via/in part of a beam/CSI report and/or UE's capability signalling(s). For this case—i.e., after the specified beam resetting procedure herein has been completed,
In one example, the UE could expect to receive a first or third (unified) TCI state(s) activation/deactivation MAC CE command as specified herein in the present disclosure, and/or the UE could be expected to apply the TCI codepoints—when they become applicable—activated by/in a first or third (unified) TCI state(s) activation/deactivation MAC CE command as specified herein in the present disclosure, and/or the UE could be expected to apply TCI codepoint(s) from a first/third unified TCI state(s) activation/deactivation MAC CE command as specified herein in the present disclosure to the TCI field of DCI format 1_1/1_2. Or, the UE may not expect to receive a second or fourth (unified) TCI state(s) activation/deactivation MAC CE command as specified herein in the present disclosure, and/or the UE may not be expected to apply the TCI codepoints—when they become applicable—activated by/in a second or fourth (unified) TCI state(s) activation/deactivation MAC CE command as specified herein in the present disclosure, and/or the UE may not be expected to apply TCI codepoint(s) from a second/fourth unified TCI state(s) activation/deactivation MAC CE command as specified herein in the present disclosure to the TCI field of DCI format 1_1/1_2. For this case/design example, when/if the joint/DL/UL TCI state indicated by a TCI codepoint—from the first/third (unified) TCI state(s) activation/deactivation MAC CE command as specified herein in the present disclosure—has become applicable (e.g., after the corresponding beam application time),
   For example, the UE could apply the indicated joint/DL/UL TCI state to monitor PDCCHs, and receive PDSCHs and aperiodic CSI-RS resources, and/or to transmit PUSCHs, PUCCHs, and SRSs.
   For another example, the UE could apply the indicated joint/DL/UL TCI state to monitor PDCCH(s) that applies the first TCI-State and/or the second TCI-State, and receive PDSCH(s) and aperiodic CSI-RS resource(s) that apply the first TCI-State and/or the second TCI-State, and/or to transmit PUSCH, PUCCH, and SRS that apply the first TCI-State or TCI-UL-State and/or the second TCI-State or TCI-UL-State.
In another example, the UE could expect to receive a second or fourth (unified) TCI state(s) activation/deactivation MAC CE command as specified herein in the present disclosure, and/or the UE could be expected to apply the TCI codepoints—when they become applicable—activated by/in a second or fourth (unified) TCI state(s) activation/deactivation MAC CE command as specified herein in the present disclosure, and/or the UE could be expected to apply TCI codepoint(s) from a second or fourth unified TCI state(s) activation/deactivation MAC CE command as specified herein in the present disclosure to the TCI field of DCI format 1_1/1_2. Or, the UE may not expect to receive a first or third (unified) TCI state(s) activation/deactivation MAC CE command as specified herein in the present disclosure, and/or the UE may not be expected to apply the TCI codepoints—when they become applicable—activated by/in a first or third (unified) TCI state(s) activation/deactivation MAC CE command as specified herein in the present disclosure, and/or the UE may not be expected to apply TCI codepoint(s) from a first/third unified TCI state(s) activation/deactivation MAC CE command as specified herein in the present disclosure to the TCI field of DCI format 1_1/1_2. For this case/design example, when/if the joint/DL/UL TCI state(s) indicated by a TCI codepoint—from the second/fourth (unified) TCI state(s) activation/deactivation MAC CE command as specified herein in the present disclosure—has become applicable (e.g., after the corresponding beam application time),
   For example, when/if the indicated joint/DL/UL TCI state(s) corresponds to a first TCI state,
      the UE (e.g. the UE 116) could apply the indicated first joint/DL/UL TCI state to monitor PDCCHs, and receive PDSCHs and aperiodic CSI-RS resources, and/or to transmit PUSCHs, PUCCHs, and SRSs, and/or
      the UE could apply the indicated first joint/DL/UL TCI state to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or apply the TCI state corresponding to q_{new} from the reference NBI RS set as specified herein in the present disclosure to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State.
   For another example, when/if the indicated joint/DL/UL TCI state(s) corresponds to a second TCI state,
      the UE could apply the indicated second joint/DL/UL TCI state to monitor PDCCHs, and receive PDSCHs and aperiodic CSI-RS resources, and/or to transmit PUSCHs, PUCCHs, and SRSs, and/or
      the UE could apply the indicated second joint/DL/UL TCI state to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State, and/or apply the TCI state corresponding to q_{new} from the reference NBI RS set as specified herein in the present disclosure to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State.
   For another example, when/if the indicated joint/DL/UL TCI state(s) corresponds to a first TCI state and a second TCI state,
      the UE could apply the indicated first joint/DL/UL TCI state to monitor PDCCHs, and receive PDSCHs and aperiodic CSI-RS resources, and/or to transmit PUSCHs, PUCCHs, and SRSs, and/or
      the UE could apply the indicated first joint/DL/UL TCI state to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or apply the TCI state corresponding to q_{new} from the reference NBI RS set as specified herein in the present disclosure to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State, and/or
      the UE could apply the indicated second joint/DL/UL TCI state to monitor PDCCHs, and receive PDSCHs and aperiodic CSI-RS resources, and/or to transmit PUSCHs, PUCCHs, and SRSs, and/or
      the UE could apply the indicated second joint/DL/UL TCI state to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State, and/or apply the TCI state corresponding to q_{new} from the reference NBI RS set as specified herein in the present disclosure to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or
      the UE could apply the indicated first joint/DL/UL TCI state to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or apply the indicated second joint/DL/UL TCI state to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State.

In one embodiment, if a UE is provided two coresetPoolIndex values 0 and 1 for the first and second CORESETs, or is not provided coresetPoolIndex value for the first CORESETs and is provided coresetPoolIndex value of 1 for the second CORESETs, respectively, and the UE is provided dl-OrJointTCI-StateList or TCI-UL-State, and/or if the UE reports its capability of supporting TRP-specific BFR under unified TCI framework with unified TCI state(s), the UE/serving cell could be configured/associated a first BFD RS set and a first NBI RS set q̅_{0,0} and q̅_{1,0}, and with a second BFD RS set and a second NBI RS set q̅_{0,1} and q̅q_{1,1}. When/if the first BFD RS set and/or the second BFD RS set (and therefore, the BFD RS resources provided/configured/indicated/determined/identified therein) is/are having radio link quality worse than Q_{out,LR}, after 28 symbols from a last symbol of a PDCCH reception with a DCI format scheduling a PUSCH transmission with a same HARQ process number as for the transmission of the PUSCH and having a toggled NDI field value, the UE
monitors PDCCH in the first CORESETs, and receives PDSCH scheduled/activated by PDCCH in the first CORESETs, and aperiodic CSI-RS resource that apply a TCI-State specific to the first CORESETs, using same antenna port quasi co-location parameters as the ones associated with a corresponding index q_{new} from q̅_{1,0}, if any, for the serving cell
monitors PDCCH in the second CORESETs, and receives PDSCH scheduled/activated by PDCCH in the second CORESETs, and aperiodic CSI-RS resource that apply a TCI-State specific to the second CORESETs, using the same antenna port quasi co-location parameters as the ones associated with the corresponding index q_{new} from q̅_{1,1}, if any, for the serving cell
transmits PUSCH, PUCCH, and SRS that apply TCI-State or TCI-UL-State specific to the first CORESETs using a same spatial domain filter as the one corresponding to q_{new} from q̅_{1,0}, if any, for the serving cell and using the following parameters for determination of a corresponding power
   the RS index q_{d}=q_{new} from q̅_{1,0}, if any, for obtaining a corresponding downlink pathloss estimate for the serving cell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
   the value of P_{O_UE_PUCCH}(qᵤ) and the PUCCH power control adjustment state l provided by p0AlphaSetforPUCCH associated with the smallest value of ul-powercontrolId for the serving cell
   the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell
transmits PUSCH, PUCCH, and SRS that apply TCI-State or TCI-UL-State specific to the second CORESETs using a same spatial domain filter as the one corresponding to q_{new} from q̅_{1,1}, if any, for the serving cell and using the following parameters for determination of a corresponding power
   the RS index q_{d}=q_{new} from q̅_{1,1}, if any, for obtaining a corresponding downlink pathloss estimate for the serving cell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
   the value of P_{O_UE_PUCCH}(qᵤ) and the PUCCH power control adjustment state l provided by p0AlphaSetforPUCCH associated with the smallest value of ul-powercontrolId for the serving cell
   the values of P_{O_UE_SRS,b,f,c}, α_{SRS,b,f,c}(qₛ), and the SRS power control adjustment state l provided by p0AlphaSetforSRS associated with the smallest value of ul-powercontrolId for the serving cell where the SCS configuration for the 28 symbols is the smallest of the SCS configurations of the active DL BWP for the PDCCH reception and of the active DL BWP(s) of the serving cells.

In one embodiment, if a UE is provided two coresetPoolIndex values 0 and 1 for the first and second CORESETs, or is not provided coresetPoolIndex value for the first CORESETs and is provided coresetPoolIndex value of 1 for the second CORESETs, respectively, and if a UE is provided dl-OrJointTCI-StateList or TCI-UL-State, and/or if the UE does not report its capability of supporting TRP-specific BFR under unified TCI framework with unified TCI state(s), the UE/serving cell could be configured/associated with a single BFD RS set q̅₀ and with a single NBI RS set q̅₁ (other than two BFD RS sets q̅_{0,0} and q̅_{0,1} and two NBI RS sets q̅_{1,0} and q̅_{1,1} when/if the UE reports its capability of supporting TRP-specific BFR under unified TCI framework with unified TCI state(s)). In this case, when the BFD RS set q̅₀ (and therefore, the BFD RS resource(s) provided/configured/indicated/determined/identified therein) is having radio link quality worse than Q_{out,LR}, after 28 symbols from a last symbol of a PDCCH reception with a DCI format scheduling a PUSCH transmission with a same HARQ process number as for the transmission of the PUSCH and having a toggled NDI field value, the UE could
monitor PDCCHs, and receive PDSCHs and aperiodic CSI-RS resources, using the same antenna port quasi co-location parameters as the ones associated with a corresponding index q_{new} from the NBI RS set q̅₁, if any, on the serving cell, and/or
monitor PDCCH(s) in the first CORESETs and/or the second CORESETs, and receive PDSCH(s) scheduled/activated by PDCCH(s) in the first CORESETs and/or the second CORESETs, and aperiodic CSI-RS resource(s) applying TCI-State(s) specific to the first CORESETs and/or second CORESET(s), using same antenna port quasi co-location parameters as the ones associated with a corresponding index q_{new} from the NBI RS set q̅₁, if any, for the serving cell, and/or
transmit PUSCHs, PUCCHs, and SRSs using a same spatial domain filter as the one corresponding to q_{new} from q̅₁, if any, on the serving cell and using the following parameters for determination of a corresponding power
   the RS index q_{d}=q_{new} from q̅₁, if any, for obtaining a corresponding downlink pathloss estimate for the serving cell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
   the value of P_{O_UE_PUCCH}(qᵤ) and the PUCCH power control adjustment state l provided by p0AlphaSetforPUCCH associated with the smallest value of ul-powercontrolId for the serving cell
   the values of P_{O_UE_SRS,b,f,c}(qₛ), α_{SRS,b,f,c}(s), and the SRS power control adjustment state l provided by p0AlphaSetforSRS associated with the smallest value of ul-powercontrolId for the serving cell and/or
transmit PUSCH, PUCCH, and SRS that apply the TCI-State(s) or TCI-UL-State(s) specific to the first CORESETs and/or the second CORESETs using a same spatial domain filter as the one corresponding to q_{new} from q̅₁, if any, on the serving cell and using the following parameters for determination of a corresponding power
   the RS index q=q_{new} from q̅₁, if any, for obtaining a corresponding downlink pathloss estimate for the serving cell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
   the value of P_{O_UE_PUCCH}(qᵤ) and the PUCCH power control adjustment state l provided by p0AlphaSetforPUCCH associated with the smallest value of ul-powercontrolId for the serving cell
   the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell
      where the SCS configuration for the 28 symbols is the smallest of the SCS configurations of the active DL BWP for the PDCCH reception and of the active DL BWP(s) of the serving cells. For this case—i.e., after the specified beam resetting procedure herein has been completed,
In one example, the UE could expect to receive a (unified) TCI state(s) activation/deactivation MAC CE command (e.g., a first (unified) TCI state(s) activation/deactivation command as specified herein in the present disclosure) not specific to any value(s) of coresetPoolIndex, and/or the UE could be expected to apply the TCI codepoints—when they become applicable—activated by/in a (unified) TCI state(s) activation/deactivation MAC CE command not specific to any value(s) of coresetPoolIndex, and/or the UE could be expected to apply TCI codepoint(s) from a (unified) TCI state(s) activation/deactivation MAC CE command not specific to any value(s) of coresetPoolIndex to the TCI field of DCI format 1_1/1_2. Or, the UE may not expect to receive a (unified) TCI state(s) activation/deactivation MAC CE command (e.g., a first (unified) TCI state(s) activation/deactivation MAC CE command as specified herein in the present disclosure) specific to a value of coresetPoolIndex (e.g., 0 or 1), and/or the UE may not be expected to apply the TCI codepoints—when they become applicable—activated by/in a (unified) TCI state(s) activation/deactivation MAC CE command specific to a value of coresetPoolIndex, and/or the UE may not be expected to apply TCI codepoint(s) from a (unified) TCI state(s) activation/deactivation MAC CE command specific to a value of coresetPoolIndex to the TCI field of DCI format 1_1/1_2. For this case/design example, when/if the joint/DL/UL TCI state indicated by a TCI codepoint—from the (unified) TCI state(s) activation/deactivation MAC CE command not specific to any value(s) of coresetPoolIndex—has become applicable (e.g., after the corresponding beam application time),
   For example, the UE could apply the indicated joint/DL/UL TCI state to monitor PDCCHs, and receive PDSCHs and aperiodic CSI-RS resources, and/or to transmit PUSCHs, PUCCHs, and SRSs.
   For another example, the UE could apply the indicated joint/DL/UL TCI state to monitor PDCCH(s) in the first and/or second CORESETs, and receive PDSCH(s) scheduled/activated by PDCCH(s) in the first and/or second CORESETs, and aperiodic CSI-RS resource(s) applying the TCI-State(s) specific to the first and/or second CORESETs, and/or to transmit PUSCH, PUCCH, and SRS that apply the TCI-State(s) or TCI-UL-State(s) specific to the first and/or second CORESETs.
In another example, the UE could expect to receive a (unified) TCI state(s) activation/deactivation MAC CE command (e.g., a first (unified) TCI state(s) activation/deactivation command as specified herein in the present disclosure) specific to a value of coresetPoolIndex (e.g., 0 or 1), and/or the UE could be expected to apply the TCI codepoints—when they become applicable—activated by/in a (unified) TCI state(s) activation/deactivation MAC CE command specific to a value of coresetPoolIndex (e.g., 0 or 1), and/or the UE could be expected to apply TCI codepoint(s) from a (unified) TCI state(s) activation/deactivation MAC CE command specific to a value of coresetPoolIndex to the TCI field of DCI format 1_1/1_2 specific to the same value of coresetPoolIndex. Or, the UE may not expect to receive a (unified) TCI state(s) activation/deactivation MAC CE command (e.g., a first (unified) TCI state(s) activation/deactivation MAC CE command as specified herein in the present disclosure) not specific to any value(s) of coresetPoolIndex, and/or the UE may not be expected to apply the TCI codepoints—when they become applicable—activated by/in a (unified) TCI state(s) activation/deactivation MAC CE command not specific to any value(s) of coresetPoolIndex, and/or the UE may not be expected to apply TCI codepoint(s) from a (unified) TCI state(s) activation/deactivation MAC CE command not specific to any value(s) of coresetPoolIndex to the TCI field of DCI format 1_1/1_2. For this case/design example, when/if the joint/DL/UL TCI state indicated by a TCI codepoint—from the (unified) TCI state(s) activation/deactivation MAC CE command specific to a value of coresetPoolIndex (e.g., 0 or 1)—has become applicable (e.g., after the corresponding beam application time),
   For example, when/if the indicated joint/DL/UL TCI state(s) is of a TCI codepoint from the (unified) TCI state(s) activation/deactivation MAC CE command specific to value 0 of coresetPoolIndex,
      the UE could apply the indicated joint/DL/UL TCI state to monitor PDCCHs, and receive PDSCHs and aperiodic CSI-RS resources, and/or to transmit PUSCHs, PUCCHs, and SRSs, and/or
      the UE could apply the indicated joint/DL/UL TCI state to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or apply the TCI state corresponding to q_{new} from q̅₁ to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs.
   For another example, when/if the indicated joint/DL/UL TCI state(s) is of a TCI codepoint from the (unified) TCI state(s) activation/deactivation MAC CE command specific to value 1 of coresetPoolIndex,
      the UE could apply the indicated joint/DL/UL TCI state to monitor PDCCHs, and receive PDSCHs and aperiodic CSI-RS resources, and/or to transmit PUSCHs, PUCCHs, and SRSs, and/or
      the UE could apply the indicated joint/DL/UL TCI state to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs, and/or apply the TCI state corresponding to q_{new} from q̅₁ to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs.
In another example, the UE could expect to receive a 1^{st} (unified) TCI state(s) activation/deactivation MAC CE command (e.g., a first (unified) TCI state(s) activation/deactivation command as specified herein in the present disclosure) specific to value 0 of coresetPoolIndex and a 2^{nd} (unified) TCI state(s) activation/deactivation MAC CE command (e.g., a first (unified) TCI state(s) activation/deactivation command as specified herein in the present disclosure) specific to value 1 of coresetPoolIndex, and/or the UE could be expected to apply the TCI codepoints—when they become applicable—activated by/in a 1^{st} (unified) TCI state(s) activation/deactivation MAC CE command specific to value 0 of coresetPoolIndex and a 2^{nd} (unified) TCI state(s) activation/deactivation MAC CE command specific to value 1 of coresetPoolIndex, and/or the UE could be expected to apply TCI codepoint(s) from a 1^{st} (unified) TCI state(s) activation/deactivation MAC CE command specific to value 0 of coresetPoolIndex to the TCI field of DCI format 1_1/1_2 specific to the same value 0 of coresetPoolIndex, and apply TCI codepoint(s) from a 2^{nd} (unified) TCI state(s) activation/deactivation MAC CE command specific to value 1 of coresetPoolIndex to the TCI field of DCI format 1_1/1_2 specific to the same value 1 of coresetPoolIndex. Or, the UE may not expect to receive a (unified) TCI state(s) activation/deactivation MAC CE command (e.g., a first (unified) TCI state(s) activation/deactivation MAC CE command as specified herein in the present disclosure) not specific to any value(s) of coresetPoolIndex, and/or the UE may not be expected to apply the TCI codepoints—when they become applicable—activated by/in a (unified) TCI state(s) activation/deactivation MAC CE command not specific to any value(s) of coresetPoolIndex, and/or the UE may not be expected to apply TCI codepoint(s) from a (unified) TCI state(s) activation/deactivation MAC CE command not specific to any value(s) of coresetPoolIndex to the TCI field of DCI format 1_1/1_2. For this case/design example, when/if a first joint/DL/UL TCI states indicated by a TCI codepoint—from the 1^{st} (unified) TCI state(s) activation/deactivation MAC CE command specific to value 0 of coresetPoolIndex—and a second joint/DL/UL TCI states indicated by a TCI codepoint—from the 2^{nd} (unified) TCI state(s) activation/deactivation MAC CE command specific to value 1 of coresetPoolIndex—have become applicable (e.g., after the corresponding beam application time),
   the UE could apply the indicated first joint/DL/UL TCI state specific to value 0 of coresetPoolIndex to monitor PDCCHs, and receive PDSCHs and aperiodic CSI-RS resources, and/or to transmit PUSCHs, PUCCHs, and SRSs, and/or
   the UE could apply the indicated first joint/DL/UL TCI state specific to value 0 of coresetPoolIndex to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or apply the TCI state corresponding to q_{new} from q̅₁ to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs, and/or
   the UE could apply the indicated second joint/DL/UL TCI state specific to value 1 of coresetPoolIndex to monitor PDCCHs, and receive PDSCHs and aperiodic CSI-RS resources, and/or to transmit PUSCHs, PUCCHs, and SRSs, and/or
   the UE could apply the indicated second joint/DL/UL TCI state specific to value 1 of coresetPoolIndex to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs, and/or apply the TCI state corresponding to q_{new} from q̅₁ to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or
   the UE (e.g. the UE 116) could apply the indicated first joint/DL/UL TCI state specific to value 0 of coresetPoolIndex to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or apply the indicated second joint/DL/UL TCI state specific to value 1 of coresetPoolIndex to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs.

In one embodiment, if a UE is provided two coresetPoolIndex values 0 and 1 for the first and second CORESETs, or is not provided coresetPoolIndex value for the first CORESETs and is provided coresetPoolIndex value of 1 for the second CORESETs, respectively, and if a UE is provided dl-OrJointTCI-StateList or TCI-UL-State, and/or if the UE does not report its capability of supporting TRP-specific BFR under unified TCI framework with unified TCI state(s), the UE/serving cell could be configured/associated a first BFD RS set and a first NBI RS set q̅_{0,0} and q̅_{1,0}, and with a second BFD RS set and a second NBI RS set q̅_{0,1} and q̅_{1,1}. When/if the first BFD RS set and/or the second BFD RS set (and therefore, the BFD RS resources provided/configured/indicated/determined/identified therein) is/are having radio link quality worse than Q_{out,LR}, after 28 symbols from a last symbol of a PDCCH reception with a DCI format scheduling a PUSCH transmission with a same HARQ process number as for the transmission of the PUSCH and having a toggled NDI field value, the UE could
monitor PDCCHs, and receive PDSCHs and aperiodic CSI-RS resources, using the same antenna port quasi co-location parameters as the ones associated with a corresponding index q_{new} from a reference NBI RS set corresponding to the NBI RS set q̅_{1,0} or q̅_{1,1}, if any, on the serving cell, and/or
monitor PDCCH(s) in the first CORESETs and/or the second CORESETs, and receive PDSCH(s) scheduled/activated by PDCCH(s) in the first CORESETs and/or the second CORESETs, and aperiodic CSI-RS resource(s) applying TCI-State(s) specific to the first CORESETs and/or second CORESET(s), using same antenna port quasi co-location parameters as the ones associated with a corresponding index q_{new} from a reference NBI RS set corresponding to the NBI RS set q̅_{1,0} or q̅_{1,1}, if any, for the serving cell, and/or
transmit PUSCHs, PUCCHs, and SRSs using a same spatial domain filter as the one corresponding to q_{new} from a reference NBI RS set corresponding to the NBI RS set q̅_{1,0} or q̅_{1,1}, if any, on the serving cell and using the following parameters for determination of a corresponding power
   the RS index q_{d}=q_{new} from a reference NBI RS set corresponding to the NBI RS set q̅_{1,0} or q̅_{1,1}, if any, for obtaining a corresponding downlink pathloss estimate for the serving cell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
   the value of P_{O_UE_PUCCH}(qᵤ) and the PUCCH power control adjustment state l provided by p0AlphaSetforPUCCH associated with the smallest value of ul-powercontrolId for the serving cell
   the values of P_{O_UE_SRS,b,f,c}(qₛ), α_{SRS,b,f,c}(s), and the SRS power control adjustment state l provided by p0AlphaSetforSRS associated with the smallest value of ul-powercontrolId for the serving cell and/or
transmit PUSCH, PUCCH, and SRS that apply the TCI-State(s) or TCI-UL-State(s) specific to the first CORESETs and/or the second CORESETs using a same spatial domain filter as the one corresponding to q_{new} from a reference NBI RS set corresponding to the NBI RS set q̅_{1,0} or q̅_{1,1}, if any, on the serving cell and using the following parameters for determination of a corresponding power
   the RS index q_{d}=q_{new} from a reference NBI RS set corresponding to the NBI RS set q̅_{1,0} or q̅q_{1,1}, if any, for obtaining a corresponding downlink pathloss estimate for the serving cell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
   the value of P_{O_UE_PUCCH}(qᵤ) and the PUCCH power control adjustment state l provided by p0AlphaSetforPUCCH associated with the smallest value of ul-powercontrolId for the serving cell
   the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell
      where the SCS configuration for the 28 symbols is the smallest of the SCS configurations of the active DL BWP for the PDCCH reception and of the active DL BWP(s) of the serving cells. The UE could determine/identify the reference NBI RS set (corresponding to the first NBI RS set q̅_{1,0} or the second NBI RS set q̅_{1,1}) according to: (1) fixed rule(s) in system specifications—e.g., the reference NBI RS set could correspond to the first NBI RS set q̅_{1,0}, (2) network's configuration(s)/indication(s), e.g., via higher layer RRC signalling(s)/parameter(s) and/or MAC CE command(s) and/or dynamic DCI based L1 signalling(s), and/or (3) UE's autonomous determination/selection, which could be further sent to the network (e.g. the network 130) via/in part of a beam/CSI report and/or UE's capability signalling(s). For this case—i.e., after the specified beam resetting procedure herein has been completed,
In one example, the UE could expect to receive a (unified) TCI state(s) activation/deactivation MAC CE command (e.g., a first (unified) TCI state(s) activation/deactivation command as specified herein in the present disclosure) not specific to any value(s) of coresetPoolIndex, and/or the UE could be expected to apply the TCI codepoints—when they become applicable—activated by/in a (unified) TCI state(s) activation/deactivation MAC CE command not specific to any value(s) of coresetPoolIndex, and/or the UE could be expected to apply TCI codepoint(s) from a (unified) TCI state(s) activation/deactivation MAC CE command not specific to any value(s) of coresetPoolIndex to the TCI field of DCI format 1_1/1_2. Or, the UE may not expect to receive a (unified) TCI state(s) activation/deactivation MAC CE command (e.g., a first (unified) TCI state(s) activation/deactivation MAC CE command as specified herein in the present disclosure) specific to a value of coresetPoolIndex (e.g., 0 or 1), and/or the UE may not be expected to apply the TCI codepoints—when they become applicable—activated by/in a (unified) TCI state(s) activation/deactivation MAC CE command specific to a value of coresetPoolIndex, and/or the UE may not be expected to apply TCI codepoint(s) from a (unified) TCI state(s) activation/deactivation MAC CE command specific to a value of coresetPoolIndex to the TCI field of DCI format 1_1/1_2. For this case/design example, when/if the joint/DL/UL TCI state indicated by a TCI codepoint—from the (unified) TCI state(s) activation/deactivation MAC CE command not specific to any value(s) of coresetPoolIndex—has become applicable (e.g., after the corresponding beam application time),
   For example, the UE could apply the indicated joint/DL/UL TCI state to monitor PDCCHs, and receive PDSCHs and aperiodic CSI-RS resources, and/or to transmit PUSCHs, PUCCHs, and SRSs.
   For another example, the UE could apply the indicated joint/DL/UL TCI state to monitor PDCCH(s) in the first and/or second CORESETs, and receive PDSCH(s) scheduled/activated by PDCCH(s) in the first and/or second CORESETs, and aperiodic CSI-RS resource(s) applying the TCI-State(s) specific to the first and/or second CORESETs, and/or to transmit PUSCH, PUCCH, and SRS that apply the TCI-State(s) or TCI-UL-State(s) specific to the first and/or second CORESETs.
In another example, the UE could expect to receive a (unified) TCI state(s) activation/deactivation MAC CE command (e.g., a first (unified) TCI state(s) activation/deactivation command as specified herein in the present disclosure) specific to a value of coresetPoolIndex (e.g., 0 or 1), and/or the UE could be expected to apply the TCI codepoints—when they become applicable—activated by/in a (unified) TCI state(s) activation/deactivation MAC CE command specific to a value of coresetPoolIndex (e.g., 0 or 1), and/or the UE could be expected to apply TCI codepoint(s) from a (unified) TCI state(s) activation/deactivation MAC CE command specific to a value of coresetPoolIndex to the TCI field of DCI format 1_1/1_2 specific to the same value of coresetPoolIndex. Or, the UE may not expect to receive a (unified) TCI state(s) activation/deactivation MAC CE command (e.g., a first (unified) TCI state(s) activation/deactivation MAC CE command as specified herein in the present disclosure) not specific to any value(s) of coresetPoolIndex, and/or the UE may not be expected to apply the TCI codepoints—when they become applicable—activated by/in a (unified) TCI state(s) activation/deactivation MAC CE command not specific to any value(s) of coresetPoolIndex, and/or the UE may not be expected to apply TCI codepoint(s) from a (unified) TCI state(s) activation/deactivation MAC CE command not specific to any value(s) of coresetPoolIndex to the TCI field of DCI format 1_1/1_2. For this case/design example, when/if the joint/DL/UL TCI state indicated by a TCI codepoint—from the (unified) TCI state(s) activation/deactivation MAC CE command specific to a value of coresetPoolIndex (e.g., 0 or 1)—has become applicable (e.g., after the corresponding beam application time),
   For example, when/if the indicated joint/DL/UL TCI state(s) is of a TCI codepoint from the (unified) TCI state(s) activation/deactivation MAC CE command specific to value 0 of coresetPoolIndex,
      the UE could apply the indicated joint/DL/UL TCI state to monitor PDCCHs, and receive PDSCHs and aperiodic CSI-RS resources, and/or to transmit PUSCHs, PUCCHs, and SRSs, and/or
      the UE could apply the indicated joint/DL/UL TCI state to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or apply the TCI state corresponding to q_{new} from the reference NBI RS set corresponding to the NBI RS set q̅_{1,0} or q̅_{1,1} to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs.
   For another example, when/if the indicated joint/DL/UL TCI state(s) is of a TCI codepoint from the (unified) TCI state(s) activation/deactivation MAC CE command specific to value 1 of coresetPoolIndex,
      the UE could apply the indicated joint/DL/UL TCI state to monitor PDCCHs, and receive PDSCHs and aperiodic CSI-RS resources, and/or to transmit PUSCHs, PUCCHs, and SRSs, and/or
      the UE could apply the indicated joint/DL/UL TCI state to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs, and/or apply the TCI state corresponding to q_{new} from the reference NBI RS set corresponding to the NBI RS set q̅_{1,0} or q̅_{1,1} to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs.
In another example, the UE could expect to receive a 1^{st} (unified) TCI state(s) activation/deactivation MAC CE command (e.g., a first (unified) TCI state(s) activation/deactivation command as specified herein in the present disclosure) specific to value 0 of coresetPoolIndex and a 2^{nd} (unified) TCI state(s) activation/deactivation MAC CE command (e.g., a first (unified) TCI state(s) activation/deactivation command as specified herein in the present disclosure) specific to value 1 of coresetPoolIndex, and/or the UE could be expected to apply the TCI codepoints—when they become applicable—activated by/in a 1^{st} (unified) TCI state(s) activation/deactivation MAC CE command specific to value 0 of coresetPoolIndex and a 2^{nd} (unified) TCI state(s) activation/deactivation MAC CE command specific to value 1 of coresetPoolIndex, and/or the UE could be expected to apply TCI codepoint(s) from a 1^{st} (unified) TCI state(s) activation/deactivation MAC CE command specific to value 0 of coresetPoolIndex to the TCI field of DCI format 1_1/1_2 specific to the same value 0 of coresetPoolIndex, and apply TCI codepoint(s) from a 2^{nd} (unified) TCI state(s) activation/deactivation MAC CE command specific to value 1 of coresetPoolIndex to the TCI field of DCI format 1_1/1_2 specific to the same value 1 of coresetPoolIndex. Or, the UE may not expect to receive a (unified) TCI state(s) activation/deactivation MAC CE command (e.g., a first (unified) TCI state(s) activation/deactivation MAC CE command as specified herein in the present disclosure) not specific to any value(s) of coresetPoolIndex, and/or the UE may not be expected to apply the TCI codepoints—when they become applicable—activated by/in a (unified) TCI state(s) activation/deactivation MAC CE command not specific to any value(s) of coresetPoolIndex, and/or the UE may not be expected to apply TCI codepoint(s) from a (unified) TCI state(s) activation/deactivation MAC CE command not specific to any value(s) of coresetPoolIndex to the TCI field of DCI format 1_1/1_2. For this case/design example, when/if a first joint/DL/UL TCI states indicated by a TCI codepoint—from the 1^{st} (unified) TCI state(s) activation/deactivation MAC CE command specific to value 0 of coresetPoolIndex—and a second joint/DL/UL TCI states indicated by a TCI codepoint—from the 2^{nd} (unified) TCI state(s) activation/deactivation MAC CE command specific to value 1 of coresetPoolIndex—have become applicable (e.g., after the corresponding beam application time),
   the UE could apply the indicated first joint/DL/UL TCI state specific to value 0 of coresetPoolIndex to monitor PDCCHs, and receive PDSCHs and aperiodic CSI-RS resources, and/or to transmit PUSCHs, PUCCHs, and SRSs, and/or
   the UE could apply the indicated first joint/DL/UL TCI state specific to value 0 of coresetPoolIndex to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or apply the TCI state corresponding to q_{new} from the reference NBI RS set corresponding to the NBI RS set q̅_{1,0} or q̅_{1,1} to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs, and/or
   the UE could apply the indicated second joint/DL/UL TCI state specific to value 1 of coresetPoolIndex to monitor PDCCHs, and receive PDSCHs and aperiodic CSI-RS resources, and/or to transmit PUSCHs, PUCCHs, and SRSs, and/or
   the UE could apply the indicated second joint/DL/UL TCI state specific to value 1 of coresetPoolIndex to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs, and/or apply the TCI state corresponding to q_{new} from the reference NBI RS set corresponding to the NBI RS set q̅_{1,0} or q̅_{1,1} to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or
   the UE could apply the indicated first joint/DL/UL TCI state specific to value 0 of coresetPoolIndex to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or apply the indicated second joint/DL/UL TCI state specific to value 1 of coresetPoolIndex to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs.

Furthermore, in a wireless communications system, a radio link failure (RLF) could occur if a significant/sudden link quality drop is observed at the UE side. If a RLF occurs, fast RLF recovery mechanisms, therefore, become essential to promptly re-establish the communication link(s) and avoid severe service interruption. At higher frequencies, e.g., millimeter-wave (mmWave) frequencies or FR2 in the 3GPP NR, both the transmitter and receiver could use directional (analog) beams to transmit and receive various RSs/channels such as SSBs, CSI-RSs, PDCCHs or PDSCHs. Hence, prior to declaring a full RLF, the UE could first detect and recover a beam failure if the signal qualities/strengths of certain beam pair links (BPLs) are below a certain threshold for a certain period of time.

The 3GPP Rel. 15 beam failure recovery (BFR) procedure mainly targets for a primary cell (PCell or PSCell) under the carrier aggregation (CA) framework (FIG. 8). The BFR procedure in the 3GPP Rel. 15 comprises the following key components:
Beam failure detection (BFD)
New beam identification (NBI)
BFR request (BFRQ)
BFRQ response (BFRR)

The UE is first configured by the gNB (e.g. the gNB 102) a set of BFD RS resources to monitor the link qualities between the gNB and the UE. One BFD RS resource could correspond to one (periodic) CSI-RS/SSB RS resource, which could be a quasi-co-located (QCL) source RS with typeD in a TCI state for a CORESET. If the received signal qualities of the BFD RS resources are below a given threshold (implying that the hypothetical BLERs of the corresponding CORESETs/PDCCHs are above a given threshold), the UE could declare a beam failure instance (BFI). Furthermore, if the UE has declared N_BFI consecutive BFIs within a given time period, the UE would declare a beam failure.

After declaring/detecting the beam failure, the UE would transmit the BFRQ to the gNB via a contention-free (CF) PRACH (CF BFR-PRACH) resource, whose index is associated with a new beam identified by the UE. Specifically, to determine a new beam, the UE could be first configured by the network a set of SSB and/or CSI-RS resources (NBI RS resources) via a higher layer parameter candidateBeamRSList. The UE would then measure the NBI RSs and calculate their L1-RSRPs. If at least one of the measured L1-RSRPs of the NBI RSs is beyond a given threshold, the UE would select the beam that corresponds to the NBI RS with the highest L1-RSRP as the new beam q_new. To determine a CF BFR-PRACH resource to convey the BFRQ, the UE could be first configured by the network a set of PRACH resources, each associated with a NBI RS resource. The UE could then select the PRACH resource that has the one-to-one correspondence to the selected NBI RS resource (and therefore, the new beam index q_new) to send the BFRQ to the gNB. From the index of the selected CF PRACH resource, the gNB could also know which beam is selected by the UE as the new beam.

Four slots after the UE has transmitted the BFRQ, the UE could start to monitor a dedicated CORESET/search space for BFRQ response. The dedicated CORESET is addressed to the UE-specific C-RNTI, and would be transmitted by the gNB using the newly identified beam. If the UE detects a valid UE-specific DCI in the dedicated CORESET for BFRR, the UE expects that the beam failure recovery request has been successfully received by the network, and the UE would complete the BFR process. Otherwise, if the UE does not receive the BFRR within a configured time window, the UE would initiate a contention based (CB) random access (RA) process to reconnect to the network.

In the 3GPP Rel. 16, the BFR procedures were customized for the secondary cell (SCell) under the CA framework, in which the BPL(s) between the PCell and the UE is expected to be working. With reference to FIG. 9, an illustrative example of the SCell beam failure is given.

After declaring/detecting the beam failure for the SCell, the UE would transmit the BFRQ in form of a scheduling request (SR) over a PUCCH for the working PCell. Furthermore, the UE could only transmit the BFRQ at this stage without indicating any new beam index, failed SCell index or other information to the network. This is different from the Rel. 15 PCell/PSCell procedure, in which the UE would indicate both the BFRQ and the identified new beam index to the network at the same time. Allowing the gNB to quickly know the beam failure status of the SCell without waiting for the UE to identify a new beam could be beneficial. For instance, the gNB could deactivate the failed SCell and allocate the resources to other working SCells.

The UE could be indicated by the network an uplink grant in response to the BFRQ SR, which would allocate necessary resources for the MAC CE to carry new beam index q_new (if identified), failed SCell index and etc. over the PUSCH for the working PCell. After transmitting the MAC CE for BFR to the working PCell, the UE would start to monitor the BFRR. The BFRR could be a TCI state indication for a CORESET for the corresponding SCell. The BFRR to the MAC CE for BFR could also be a normal uplink grant for scheduling a new transmission for the same HARQ process as the PUSCH carrying the MAC CE for BFR. If the UE could not receive the BFRR within a configured time window, the UE could transmit BFR-PUCCH again, or fall back to contention-based random access (CBRA) process.

This disclosure provides various design aspects related to sending beam failure recovery request (BFRQ) and information related to beams having radio link quality worse than a threshold in a multi-TRP system, wherein beams/TRPs selection is conducted under the unified TCI framework.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

A UE (e.g. the UE 116) could receive from the network (e.g. the network 130) a first (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of CCs/DL BWPs, and/or a second (unified) TCI state(s) activation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of component carriers (CCs)/DL BWPs, and if applicable, to one or to a set of CCs/UL BWPs once the indicated mapping for the one single TCI codepoint is applied. That is, e.g., when/if the UE is provided/configured with dl-OrJointTCI-StateList and/or ul-TCI-StateList and/or is having one or two indicated TCI states and/or is having first and/or second indicated TCI states, an activated TCI codepoint in the second MAC CE activation command could be composed/comprised of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 16: a first TCI state for DL channel(s)/signal(s) and UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

Furthermore, when/if the UE is configured by higher layer parameter PDCCH-Config that contains two values of coresetPoolIndex (e.g., 0 and 1) in ControlResourceSet, the first/second (unified) TCI state(s) activation command as specified herein in the present disclosure could also incorporate/provide/indicate/include/contain a value of coresetPoolIndex (e.g., 0 or 1). For this case, the TCI state(s)/TCI codepoint(s) activated by/in the first/second (unified) TCI state(s) activation command could be specific to the same coresetPoolIndex value (i.e., 0 or 1) provided/indicated therein.

In one example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a third (unified) TCI state(s) activation MAC CE command, wherein the TCI codepoint(s) activated by/in the third (unified) TCI state(s) activation MAC CE command could be comprised of or mapped to or could correspond to one of:
Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
Case 21: first TCI state(s) for both DL and UL channels/signals
Case 22: second TCI state(s) for both DL and UL channels/signals

That is, the TCI codepoint(s) activated by/in a third (unified) TCI state(s) activation command could be comprised of or mapped to either first joint/DL/UL TCI state(s)/pair(s) of first DL and UL TCI states or second joint/DL/UL TCI state(s)/pair(s) of second DL and UL TCI states.

In another example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a fourth (unified) TCI state(s) activation MAC CE command as specified herein in the present disclosure with (1) at least one TCI codepoint activated therein composing/comprising of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s), and/or (2) at least one TCI codepoint activated therein composing/comprising of at least first TCI state(s) as specified herein in the present disclosure and another TCI codepoint activated therein composing/comprising of at least second TCI state(s) as specified herein in the present disclosure. That is, for this case/design example, the UE may or may not expect, or may or may not be expected to receive a fourth (unified) TCI state(s) activation MAC CE command as specified herein in the present disclosure with (1) at least one TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and/or (2) at least one TCI codepoint activated therein composing/comprising of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 16: a first TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and another TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0_1/0_2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

In one embodiment, if a UE is provided dl-OrJointTCI-StateList or TCI-UL-State and is indicated/having two TCI states including a first TCI-State or TCI-UL-State and a second TCI-State or TCI-UL-State, and/or if the UE does not report its capability of supporting TRP-specific BFR under unified TCI framework with unified TCI state(s), and/or if the UE is not configured/provided/indicated by the network a (higher layer) parameter perTRP-BFR (e.g., via RRC signalling(s) and/or MAC CE command(s) and/or dynamic DCI based L1 signalling(s)), e.g., set to ‘enabled’, and/or if the UE is configured/provided/indicated by the network, e.g., via RRC signalling(s) and/or MAC CE command(s) and/or dynamic DCI based L1 signalling(s), a (higher layer) parameter perTRP-BFR set to ‘disabled’, and/or if the UE reports its capability of supporting TRP-specific BFR under unified TCI framework with unified TCI state(s), and/or if the UE is configured/provided/indicated by the network, e.g., via RRC signalling(s) and/or MAC CE command(s) and/or dynamic DCI based L1 signalling(s), a (higher layer) parameter perTRP-BFR, e.g., set to ‘enabled’, and/or if the UE does not report its capability of supporting cell-specific BFR under unified TCI framework with unified TCI state(s), and/or if the UE is not configured/provided/indicated by the network a (higher layer) parameter cellSpecific-BFR (e.g., via RRC signalling(s) and/or MAC CE command(s) and/or dynamic DCI based L1 signalling(s)), e.g., set to ‘enabled’, and/or if the UE is configured/provided/indicated by the network, e.g., via RRC signalling(s) and/or MAC CE command(s) and/or dynamic DCI based L1 signalling(s), a (higher layer) parameter cellSpecific-BFR set to ‘disabled’, and/or if the UE reports its capability of supporting cell-specific BFR under unified TCI framework with unified TCI state(s), and/or if the UE is configured/provided/indicated by the network, e.g., via RRC signalling(s) and/or MAC CE command(s) and/or dynamic DCI based L1 signalling(s), a (higher layer) parameter cellSpecific-BFR set to ‘enabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is provided/configured/associated with respective two NBI RS sets q̅_{1,0} and/or q̅q_{1,1} for a BWP of the serving cell, and/or if the UE/serving cell is not provided/configured/associated with, e.g., via higher layer RRC signalling(s)/parameter(s) and/or MAC CE command(s) and/or DCI based L1 signalling(s), BFD RS set(s) q̅_{0,0} and/or q̅_{0,1} and/or NBI RS set(s) q̅_{1,0} and/or q̅q_{1,1} for a BWP of the serving cell, and/or if the UE (e.g. the UE 116) is not expected/configured/indicated, e.g., via higher layer RRC signalling(s) and/or MAC CE command(s) and/or dynamic DCI based L1 signalling(s), to determine BFD RS set(s) q̅_{0,0} and/or q̅_{0,1} according to the first TCI-State/TCI-UL-State and/or the second TCI-State/TCI-UL-State following those specified herein in the present disclosure—e.g., the UE is not provided/configured/indicated by the network a (higher layer) parameter TRPspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter TRPspecific-implicit-BFDRS set to ‘disabled’, and/or if the UE/serving cell is provided/configured/associated with a single NBI RS set q̅₁ for a BWP of the serving cell, and/or if the UE/serving cell is not provided/configured/associated with, e.g., via higher layer RRC signalling(s)/parameter(s) and/or MAC CE command(s) and/or dynamic DCI based L1 signalling(s), a single BFD RS set q̅₀ and/or a single NBI RS set q̅₁ for a BWP of the serving cell, and/or if the UE is not expected/configured/indicated, e.g., via higher layer RRC signalling(s) and/or MAC CE command(s) and/or dynamic DCI based L1 signalling(s), to determine a single BFD RS set q̅₀ according to the first TCI-State/TCI-UL-State and/or the second TCI-State/TCI-UL-State following those specified herein in the present disclosure—e.g., the UE is not provided/configured/indicated by the network a (higher layer) parameter Cellspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter Cellspecific-implicit-BFDRS set to ‘disabled’, and/or if the UE is not provided/configured by the network (e.g. the network 130) the higher layer parameter applyIndicatedTCIState (or the first indicator as specified herein in the present disclosure) to the CORESET(s) for PDCCH reception, and/or if the UE is provided/configured by the network the higher layer parameter applyIndicatedTCIState (or the first indicator as specified herein in the present disclosure) to the CORESET(s) for PDCCH reception, which could be further set to ‘first’, ‘second’, ‘both’ or ‘none’, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if the UE is not provided/configured by the network the higher layer parameter tciSelection-PresentInDCI, and the TCI selection field indicator (or the second indicator as specified herein in the present disclosure) for PDSCH reception is not present or absent or corresponds to a 0-bit field in the corresponding DCI format(s) 1_1/1_2, and/or if the UE is provided/configured by the network the higher layer parameter tciSelection-PresentInDCI, and the TCI selection field indicator (or the second indicator as specified herein in the present disclosure) for PDSCH reception is present or corresponds to a 2-bit field in the corresponding DCI format(s) 1_1/1_2, wherein the DCI codepoint of the TCI selection field (or the second indicator as specified herein in the present disclosure) could be set to ‘00’, ‘01’, ‘10’ or ‘11’, and/or if the UE is not provided/configured by the network the higher layer parameter applyIndicatedTCIState (or the third indicator as specified herein in the present disclosure) to the PUCCH transmission, and/or if the UE is provided/configured by the network the higher layer parameter applyIndicatedTCIState (or the third indicator as specified herein in the present disclosure) to the PUCCH transmission, which could be further set to ‘first’, ‘second’ or ‘both’, and/or if the UE is provided/configured by the network a single SRS resource set associated with usage of value ‘nonCodeBook’ or ‘codebook’, and the SRS resource set indicator (or the fourth indicator as specified herein in the present disclosure) for PUSCH transmission is not present or absent or corresponds to a 0-bit field in the corresponding DCI format(s) 0_1/0_2, and/or if the UE is provided/configured by the network two SRS resource sets each associated with usage of value ‘nonCodeBook’ or ‘codebook’, and the SRS resource set indicator (or the fourth indicator as specified herein in the present disclosure) for PUSCH transmission is present or corresponds to a 2-bit field in the corresponding DCI format(s) 0_1/0_2, wherein the DCI codepoint of the SRS resource set indicator (or the fourth indicator as specified herein in the present disclosure) could be set to ‘00’, ‘01’, ‘10’ or ‘11’, and/or if SSB-MTC-AdditionalPCJ is not provided, the UE could be provided (e.g., via higher layer RRC signaling(s)/parameter(s) and/or MAC CE command(s) and/or dynamic DCI based L1 signaling(s)), for each BWP of a serving cell, a set q̅₀ of periodic CSI-RS resource configuration indexes, wherein the set q₀ (and therefore, the periodic CSI-RS resource configuration indexes provided therein) could be activated by a MAC CE; otherwise—e.g., one or more of the specified conditions herein of a UE to be provided q̅₀ for a BWP of the serving cell are satisfied, held or achieved and/or one or more of the specified conditions herein of a UE to be provided q̅₀ for a BWP of the serving cell are not satisfied, held or achieved, for each BWP of a serving cell, the UE could be provided respective two sets q̅_{0,0} and q̅_{0,0} of periodic CSI-RS resource configuration indexes by failureDetectionSet1 and failureDetectionSet2 that can be activated by a MAC CE. If the UE is not provided q̅₀ for a BWP of the serving cell—e.g., one or more of the specified conditions herein of a UE to be provided q̅₀ for a BWP of the serving cell are satisfied, held or achieved and/or one or more of the specified conditions herein of a UE to be provided q̅₀ for a BWP of the serving cell are not satisfied, held or achieved, and/or if one or more of the following conditions are achieved, held or satisfied,
Condition-A: the UE is provided dl-OrJointTCI-StateList or TCI-UL-State, and is indicated/having two TCI states including a first TCI-State or TCI-UL-State and a second TCI-State or TCI-UL-State
Condition-B: the UE does not report (or reports) its capability of supporting TRP-specific BFR under unified TCI framework with unified TCI state(s), and/or the UE is not (or is) configured/provided/indicated by the network a (higher layer) parameter perTRP-BFR (e.g., via RRC signalling(s) and/or MAC CE command(s) and/or dynamic DCI based L1 signalling), e.g., set to ‘enabled’ (or ‘disabled’), and/or the UE is (or is not) configured/provided/indicated by the network, e.g., via RRC signalling(s) and/or MAC CE command(s) and/or dynamic DCI based L1 signalling(s), a (higher layer) parameter perTRP-BFR set to ‘disabled’ (or ‘enabled’)
Condition-C: the UE reports (or does not report) its capability of supporting cell-specific BFR under unified TCI framework with unified TCI state(s), and/or the UE is (or is not) configured/provided/indicated by the network, e.g., via RRC signalling(s) and/or MAC CE command(s) and/or dynamic DCI based L1 signalling(s), a (higher layer) parameter cellSpecific-BFR set to ‘enabled’ (or set to ‘disabled’)
Condition-D: the UE is not provided in PDCCH-Config two different values of coresetPoolIndex (e.g., 0 and 1) in CORESETs, and/or the UE is not provided coresetPoolIndex value for the first CORESETs and is not provided coresetPoolIndex value for the second CORESETs, respectively
Condition-E: the UE/serving cell is not provided/configured/associated with, e.g., via higher layer RRC signalling(s)/parameter(s) and/or MAC CE command(s) and/or dynamic DCI based L1 signalling(s), BFD RS set(s) q̅_{0,0} and/or q̅_{0,1} and/or NBI RS set(s) q̅_{1,0} and/or q̅q_{1,1} for a BWP of the serving cell, and/or the UE is not expected/configured/indicated, e.g., via higher layer RRC signalling(s) and/or MAC CE command(s) and/or dynamic DCI based L1 signalling(s), to determine BFD RS set(s) q̅_{0,0} and/or q̅_{0,1} according to the first TCI-State/TCI-UL-State and/or the second TCI-State/TCI-UL-State following those specified herein in the present disclosure—e.g., the UE is not provided/configured/indicated by the network a (higher layer) parameter TRPspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter TRPspecific-implicit-BFDRS set to ‘disabled’
Condition-F: the UE/serving cell is provided/configured/associated with a single NBI RS set q̅₁ for a BWP of the serving cell, and/or the UE/serving cell is provided/configured/associated with respective two NBI RS sets q̅_{1,0} and/or q̅q_{1,1} for a BWP of the serving cell
Condition-G: the UE is expected/configured/indicated, e.g., via higher layer RRC signaling(s) and/or MAC CE command(s) and/or dynamic DCI based L1 signaling(s), to determine a single BFD RS set q̅₀ according to the first TCI-State/TCI-UL-State and/or the second TCI-State/TCI-UL-State—e.g., the UE is provided/configured/indicated by the network a (higher layer) parameter Cellspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter Cellspecific-implicit-BFDRS set to ‘enabled’
Condition-H: the UE is not provided/configured by the network the higher layer parameter applyIndicatedTCIState (or the first indicator as specified herein in the present disclosure) to the CORESET(s) for PDCCH reception
Condition-I: the UE is provided/configured by the network the higher layer parameter applyIndicatedTCIState (or the first indicator as specified herein in the present disclosure) to the CORESET(s) for PDCCH reception, which could be further set to ‘first’, ‘second’, ‘both’ or ‘none’
Condition-J: the UE is not provided/configured by the network the higher layer parameter tciSelection-PresentInDCI, and the TCI selection field indicator (or the second indicator as specified herein in the present disclosure) for PDSCH reception is not present or absent or corresponds to a 0-bit field in the corresponding DCI format(s) 1_1/1_2
Condition-K: the UE is provided/configured by the network the higher layer parameter tciSelection-PresentInDCI, and the TCI selection field indicator (or the second indicator as specified herein in the present disclosure) for PDSCH reception is present or corresponds to a 2-bit field in the corresponding DCI format(s) 1_1/1_2, wherein the DCI codepoint of the TCI selection field (or the second indicator as specified herein in the present disclosure) could be set to ‘00’, ‘01’, ‘10’ or ‘11’
Condition-L: the UE is not provided/configured by the network the higher layer parameter applyIndicatedTCIState (or the third indicator as specified herein in the present disclosure) to the PUCCH transmission
Condition-M: the UE is provided/configured by the network the higher layer parameter applyIndicatedTCIState (or the third indicator as specified herein in the present disclosure) to the PUCCH transmission, which could be further set to ‘first’, ‘second’ or ‘both’
Condition-N: the UE is provided/configured by the network a single SRS resource set associated with usage of value ‘nonCodeBook’ or ‘codebook’, and the SRS resource set indicator (or the fourth indicator as specified herein in the present disclosure) for PUSCH transmission is not present or absent or corresponds to a 0-bit field in the corresponding DCI format(s) 0_1/0_2
Condition-O: the UE is provided/configured by the network two SRS resource sets each associated with usage of value ‘nonCodeBook’ or ‘codebook’, and the SRS resource set indicator (or the fourth indicator as specified herein in the present disclosure) for PUSCH transmission is present or corresponds to a 2-bit field in the corresponding DCI format(s) 0_1/0_2, wherein the DCI codepoint of the SRS resource set indicator (or the fourth indicator as specified herein in the present disclosure) could be set to ‘00’, ‘01’, ‘10’ or ‘11’
   The UE could Determine a Single Set q̅₀ According to One of:
In one example, the UE could determine the set q̅₀ to include periodic CSI-RS resource configuration indexes with same values as the RS indexes in the RS sets indicated by both the first TCI-State TCI-UL-State and the second TCI-State TCI-UL-State
In another example, the UE could determine the set q̅₀ to include periodic CSI-RS resource configuration indexes with same values as the RS indexes in the RS sets indicated by the first TCI-State TCI-UL-State and/or the second TCI-State TCI-UL-State according to one of:
   Fixed rule(s) in system specifications: e.g., the first TCI-State TCI-UL-State, or the second TCI-State TCI-UL-State, or the first TCI-State TCI-UL-State and the second TCI-State TCI-UL-State
   Network's configuration(s)/indication(s) via/by higher layer RRC signalling(s)/parameter(s) and/or MAC CE command(s) and/or dynamic DCI based L1 signalling(s): e.g., the UE could determine the set q̅₀ to include periodic CSI-RS resource configuration indexes with same values as the RS indexes in the RS sets indicated by the first TCI-State TCI-UL-State and/or the second TCI-State TCI-UL-State according to the RRC configuration applyIndicatedTCIState (or equivalently, the first indicator as specified herein in the present disclosure) provided to the corresponding CORESET(s)—for this case,
      if applyIndicatedTCIState=‘first’, the UE expects that a demodulation reference signal (DM-RS) antenna port for PDCCH receptions in the CORESET(s) is quasi co-located with the reference signals provided by the first TCI-State
      if applyIndicatedTCIState=‘second’, the UE expects that a DM-RS antenna port for PDCCH receptions in the CORESET is quasi co-located with the reference signals provided by the second TCI-State
      if applyIndicatedTCIState=‘both’, the UE expects that a DM-RS antenna port for PDCCH receptions in the CORESET is quasi co-located with the reference signals provided by the first TCI-State and the second TCI-State

Otherwise—e.g., one or more of the specified conditions herein (e.g., Condition-A—Condition-O) are satisfied, held or achieved and/or one or more of the specified conditions herein (e.g., Condition-A—Condition-O) are not satisfied, held or achieved, (1) the UE could determine a set q̅₀ to include periodic CSI-RS resource configuration indexes with same values as the RS indexes in the RS sets indicated by TCI-State for respective CORESETs that the UE uses for monitoring PDCCH—e.g., when/if the UE is provided dl-OrJointTCI-StateList or TCI-UL-State, and is indicated/having one TCI state TCI-State, and/or the UE is not provided q̅₀ for a BWP of the serving cell; (2) the UE could determine a set q̅_{0,0} to include periodic CSI-RS resource configuration indexes with same values as the RS indexes in the RS sets indicated by the first TCI-State TCI-UL-State and a set q̅_{0,1} to include periodic CSI-RS resource configuration indexes with same values as the RS indexes in the RS sets indicated by the second TCI-State TCI-UL-State—e.g., when/if the UE is provided dl-OrJointTCI-StateList or TCI-UL-State, and is indicated/having two TCI states including a first TCI-State or TCI-UL-State and a second TCI-State or TCI-UL-State, and/or the UE is not provided q̅₀, q̅_{0,0} or q̅_{0,1} for a BWP of the serving cell, and/or the UE/serving cell is provided/configured/associated with two NBI RS sets q̅_{1,0} and q̅q_{1,1} for a BWP of the serving cell; (3) the UE could be provided respective two sets q̅_{0,0} and q̅_{0,1} of periodic CSI-RS resource configuration indexes by failureDetectionSet1 and failureDetectionSet2 that can be activated by a MAC CE for each BWP of a serving cell. For the described/specified design examples herein, if there are two RS indexes in the first/second TCI-State TCI-UL-State, the set q̅₀ could include RS indexes configured with qcl-Type set to ‘typeD’ for the corresponding first/second TCI-State TCI-UL-State, and the UE could expect the set q̅₀ to include up to two RS indexes, or up to a number of N_{BFD} RS indexes indicated by maxBFD-RS-resourcesPerSetPerBWP (e.g., if q̅₀ is provided/configured by the network). The physical layer in the UE could assess the radio link quality according to the set q̅₀ of resource configurations against the threshold Q_{out,LR}, when/if one or more of the specified conditions herein of a UE to be provided q̅₀ for a BWP of the serving cell are (or not) satisfied, held or achieved, and/or when/if one or more of the specified conditions herein (e.g., Condition-A—Condition-O) are (or not) satisfied, held or achieved.
In one example, the UE could assess the radio link quality only according to synchronization signal/physical broadcast channel (SS/PBCH) blocks on the PCell or the PSCell or periodic CSI-RS resource configurations that are quasi co-located with the RSs in the RS sets indicated by both the first TCI-State TCI-UL-State and the second TCI-State TCI-UL-State.
In another example, the UE could assess the radio link quality only according to SS/PBCH blocks on the PCell or the PSCell or periodic CSI-RS resource configurations that are quasi co-located with the RSs in the RS sets indicated by the first TCI-State TCI-UL-State and/or the second TCI-State TCI-UL-State according to one of:
   Fixed rule(s) in system specifications: e.g., the first TCI-State TCI-UL-State, or the second TCI-State TCI-UL-State, or the first TCI-State TCI-UL-State and the second TCI-State TCI-UL-State
   Network's configuration(s)/indication(s) via/by higher layer RRC signalling(s)/parameter(s) and/or MAC CE command(s) and/or dynamic DCI based L1 signalling(s): e.g., the UE could assess the radio link quality only according to SS/PBCH blocks on the PCell or the PSCell or periodic CSI-RS resource configurations that are quasi co-located with the RSs in the RS sets indicated by the first TCI-State TCI-UL-State and/or the second TCI-State TCI-UL-State according to the RRC configuration applyIndicatedTCIState (or equivalently, the first indicator as specified herein in the present disclosure) provided to the corresponding CORESET(s)—for this case,
      if applyIndicatedTCIState=‘first’, the UE expects that a DM-RS antenna port for PDCCH receptions in the CORESET(s) is quasi co-located with the reference signals provided by the first TCI-State
      if applyIndicatedTCIState=‘second’, the UE expects that a DM-RS antenna port for PDCCH receptions in the CORESET is quasi co-located with the reference signals provided by the second TCI-State
      if applyIndicatedTCIState=‘both’, the UE expects that a DM-RS antenna port for PDCCH receptions in the CORESET is quasi co-located with the reference signals provided by the first TCI-State and the second TCI-State

For one or more of the described/specified design examples herein, the UE could assess a first radio link quality according to SS/PBCH blocks on the PCell or the PSCell or periodic CSI-RS resource configurations that are quasi co-located with the RSs in the RS sets indicated by the first TCI-State TCI-UL-State, and/or a second radio link quality according to SS/PBCH blocks on the PCell or the PSCell or periodic CSI-RS resource configurations that are quasi co-located with the RSs in the RS sets indicated by the second TCI-State/TCI-UL-State.

In one embodiment, if a UE is provided dl-OrJointTCI-StateList or TCI-UL-State and is indicated/having two TCI states including a first TCI-State or TCI-UL-State and a second TCI-State or TCI-UL-State, and/or if the UE does not report its capability of supporting TRP-specific BFR under unified TCI framework with unified TCI state(s), and/or if the UE is not configured/provided/indicated by the network a (higher layer) parameter perTRP-BFR (e.g., via RRC signalling(s) and/or MAC CE command(s) and/or dynamic DCI based L1 signalling(s)), e.g., set to ‘enabled’, and/or if the UE is configured/provided/indicated by the network, e.g., via RRC signalling(s) and/or MAC CE command(s) and/or dynamic DCI based L1 signalling(s), a (higher layer) parameter perTRP-BFR set to ‘disabled’, and/or if the UE reports its capability of supporting TRP-specific BFR under unified TCI framework with unified TCI state(s), and/or if the UE is configured/provided/indicated by the network, e.g., via RRC signalling(s) and/or MAC CE command(s) and/or dynamic DCI based L1 signalling(s), a (higher layer) parameter perTRP-BFR, e.g., set to ‘enabled’, and/or if the UE does not report its capability of supporting cell-specific BFR under unified TCI framework with unified TCI state(s), and/or if the UE is not configured/provided/indicated by the network a (higher layer) parameter cellSpecific-BFR (e.g., via RRC signalling(s) and/or MAC CE command(s) and/or dynamic DCI based L1 signalling(s)), e.g., set to ‘enabled’, and/or if the UE is configured/provided/indicated by the network, e.g., via RRC signalling(s) and/or MAC CE command(s) and/or dynamic DCI based L1 signalling(s), a (higher layer) parameter cellSpecific-BFR set to ‘disabled’, and/or if the UE reports its capability of supporting cell-specific BFR under unified TCI framework with unified TCI state(s), and/or if the UE is configured/provided/indicated by the network, e.g., via RRC signalling(s) and/or MAC CE command(s) and/or dynamic DCI based L1 signalling(s), a (higher layer) parameter cellSpecific-BFR set to ‘enabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is provided/configured/associated with respective two NBI RS sets q̅_{1,0} and/or q̅_{1,1} for a BWP of the serving cell, and/or if the UE/serving cell is not provided/configured/associated with, e.g., via higher layer RRC signalling(s)/parameter(s) and/or MAC CE command(s) and/or dynamic DCI based L1 signalling(s), BFD RS set(s) q̅_{0,0} and/or q̅_{0,1} and/or NBI RS set(s) q̅_{1,0} and/or q_{1,1} for a BWP of the serving cell, and/or if the UE is not expected/configured/indicated, e.g., via higher layer RRC signalling(s) and/or MAC CE command(s) and/or dynamic DCI based L1 signalling(s), to determine BFD RS set(s) q̅_{0,0} and/or q̅_{0,1} according to the first TCI-State/TCI-UL-State and/or the second TCI-State/TCI-UL-State following those specified herein in the present disclosure—e.g., the UE is not provided/configured/indicated by the network a (higher layer) parameter TRPspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter TRPspecific-implicit-BFDRS set to ‘disabled’, and/or if the UE/serving cell is provided/configured/associated with a single NBI RS set q̅₁ for a BWP of the serving cell, and/or if the UE/serving cell is not provided/configured/associated with, e.g., via higher layer RRC signalling(s)/parameter(s) and/or MAC CE command(s) and/or dynamic DCI based L1 signalling(s), a single BFD RS set q̅₀ and/or a single NBI RS set q̅₁ for a BWP of the serving cell, and/or if the UE is not expected/configured/indicated, e.g., via higher layer RRC signalling(s) and/or MAC CE command(s) and/or dynamic DCI based L1 signalling(s), to determine a single BFD RS set q̅₀ according to the first TCI-State/TCI-UL-State and/or the second TCI-State/TCI-UL-State following those specified herein in the present disclosure—e.g., the UE is not provided/configured/indicated by the network a (higher layer) parameter Cellspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter Cellspecific-implicit-BFDRS set to ‘disabled’, and/or if the UE is not provided/configured by the network the higher layer parameter applyIndicatedTCIState (or the first indicator as specified herein in the present disclosure) to the CORESET(s) for PDCCH reception, and/or if the UE is provided/configured by the network the higher layer parameter applyIndicatedTCIState (or the first indicator as specified herein in the present disclosure) to the CORESET(s) for PDCCH reception, which could be further set to ‘first’, ‘second’, ‘both’ or ‘none’, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if the UE is not provided/configured by the network the higher layer parameter tciSelection-PresentInDCI, and the TCI selection field indicator (or the second indicator as specified herein in the present disclosure) for PDSCH reception is not present or absent or corresponds to a 0-bit field in the corresponding DCI format(s) 1_1/1_2, and/or if the UE is provided/configured by the network (e.g. the network 130) the higher layer parameter tciSelection-PresentInDCI, and the TCI selection field indicator (or the second indicator as specified herein in the present disclosure) for PDSCH reception is present or corresponds to a 2-bit field in the corresponding DCI format(s) 1_1/1_2, wherein the DCI codepoint of the TCI selection field (or the second indicator as specified herein in the present disclosure) could be set to ‘00’, ‘01’, ‘10’ or ‘11’, and/or if the UE is not provided/configured by the network the higher layer parameter applyIndicatedTCIState (or the third indicator as specified herein in the present disclosure) to the PUCCH transmission, and/or if the UE is provided/configured by the network the higher layer parameter applyIndicatedTCIState (or the third indicator as specified herein in the present disclosure) to the PUCCH transmission, which could be further set to ‘first’, ‘second’ or ‘both’, and/or if the UE is provided/configured by the network a single SRS resource set associated with usage of value ‘nonCodeBook’ or ‘codebook’, and the SRS resource set indicator (or the fourth indicator as specified herein in the present disclosure) for PUSCH transmission is not present or absent or corresponds to a 0-bit field in the corresponding DCI format(s) 0_1/0_2, and/or if the UE is provided/configured by the network two SRS resource sets each associated with usage of value ‘nonCodeBook’ or ‘codebook’, and the SRS resource set indicator (or the fourth indicator as specified herein in the present disclosure) for PUSCH transmission is present or corresponds to a 2-bit field in the corresponding DCI format(s) 0_1/0_2, wherein the DCI codepoint of the SRS resource set indicator (or the fourth indicator as specified herein in the present disclosure) could be set to ‘00’, ‘01’, ‘10’ or ‘11’, and/or if SSB-MTC-AdditionalPCJ is not provided, the UE could be provided, for each BWP of a serving cell, respective two sets q̅_{0,0} and q̅_{0,1} of periodic CSI-RS resource configuration indexes, wherein the set q̅_{0,0} and/or the set q̅_{0,1} (and therefore, the periodic CSI-RS resource configuration indexes provided therein) could be activated by a MAC CE; otherwise, e.g., one or more of the specified conditions herein of a UE to be provided q̅_{0,0} and q̅_{0,1} for a BWP of the serving cell are satisfied, held or achieved and/or one or more of the specified conditions herein of a UE to be provided q̅_{0,0} and q̅_{0,1} for a BWP of the serving cell are not satisfied, held or achieved, the UE could be provided, for each BWP of a serving cell, a set q̅₀ of periodic CSI-RS resource configuration indexes, wherein the set q̅₀ (and therefore, the periodic CSI-RS resource configuration indexes provided therein) could be activated by a MAC CE. If the UE is not provided q̅_{0,0} and q̅_{0,1} for a BWP of the serving cell—e.g., one or more of the specified conditions herein of a UE to be provided q̅_{0,0} and q̅_{0,1} for a BWP of the serving cell are satisfied, held or achieved and/or one or more of the specified conditions herein of a UE to be provided q̅_{0,0} and q̅_{0,1} for a BWP of the serving cell are not satisfied, held or achieved, the UE could determine the set q̅_{0,0} to include periodic CSI-RS resource configuration indexes with same values as the RS indexes in the RS sets indicated by the first TCI-State TCI-UL-State and the set q̅_{0,1} to include periodic CSI-RS resource configuration indexes with same values as the RS indexes in the RS sets indicated by the second TCI-State TCI-UL-State. Otherwise—e.g., one or more of the specified conditions herein of a UE (e.g. the UE 116) to be provided q̅_{0,0} and q̅_{0,1} for a BWP of the serving cell are satisfied, held or achieved and/or one or more of the specified conditions herein of a UE to be provided q̅_{0,0} and q̅_{0,1} for a BWP of the serving cell are not satisfied, held or achieved, (1) the UE could determine a set q̅₀ to include periodic CSI-RS resource configuration indexes with same values as the RS indexes in the RS sets indicated by TCI-State for respective CORESETs that the UE uses for monitoring PDCCH—e.g., when/if the UE is provided dl-OrJointTCI-StateList or TCI-UL-State, and is indicated/having one TCI state TCI-State, and/or the UE is not provided q₀, q̅_{0,0} and/or q̅_{0,1} for a BWP of the serving cell; (2) the UE could determine a set q̅₀ to include periodic CSI-RS resource configuration indexes with same values as the RS indexes in the RS sets indicated by the first TCI-State TCI-UL-State and/or the second TCI-State TCI-UL-State according to those specified herein in the present disclosure—e.g., when/if the UE is provided dl-OrJointTCI-StateList or TCI-UL-State, and is indicated/having two TCI states including a first TCI-State or TCI-UL-State and a second TCI-State or TCI-UL-State, and/or the UE is not provided q̅₀, q̅_{0,0} or q̅_{0,1} for a BWP of the serving cell, and/or the UE/serving cell is provided/configured/associated with a single NBI RS set q̅₁ for a BWP of the serving cell; (3) the UE could be provided, for each BWP of a serving cell, a set q̅₀ of periodic CSI-RS resource configuration indexes, wherein the set q₀ (and therefore, the periodic CSI-RS resource configuration indexes provided therein) could be activated by a MAC CE. If there are two RS indexes in the first/second TCI-State TCI-UL-State, the set q̅_{0,0}/q̅_{0,1} could include RS indexes configured with qcl-Type set to ‘typeD’ for the corresponding first/second TCI-State TCI-UL-State, and the UE could expect the set q̅_{0,0}/q̅_{0,1} to include up to two RS indexes, or up to a number of N_{BFD} RS indexes indicated by maxBFD-RS-resourcesPerSetPerBWP (e.g., if q̅_{0,0} and/or q̅_{0,1} is provided/configured by the network). When/if one or more of the specified conditions herein of a UE to be provided q₀, q̅_{0,0} and q̅_{0,1} are satisfied, held or achieved, and/or when/if one or more of the specified conditions herein of a UE to be provided q₀, q̅_{0,0} and q̅_{0,1} are not satisfied, held or achieved, and/or when/if one or more of the following conditions are achieved, held or satisfied,
Condition-A: the UE is provided dl-OrJointTCI-StateList or TCI-UL-State, and is indicated/having two TCI states including a first TCI-State or TCI-UL-State and a second TCI-State or TCI-UL-State
Condition-B: the UE does not report (or reports) its capability of supporting TRP-specific BFR under unified TCI framework with unified TCI state(s), and/or the UE is not (or is) configured/provided/indicated by the network a (higher layer) parameter perTRP-BFR (e.g., via RRC signalling(s) and/or MAC CE command(s) and/or dynamic DCI based L1 signalling), e.g., set to ‘enabled’ (or ‘disabled’), and/or the UE is (or is not) configured/provided/indicated by the network, e.g., via RRC signalling(s) and/or MAC CE command(s) and/or dynamic DCI based L1 signalling(s), a (higher layer) parameter perTRP-BFR set to ‘disabled’ (or ‘enabled’)
Condition-C: the UE reports (or does not report) its capability of supporting cell-specific BFR under unified TCI framework with unified TCI state(s), and/or the UE is (or is not) configured/provided/indicated by the network, e.g., via RRC signalling(s) and/or MAC CE command(s) and/or dynamic DCI based L1 signalling(s), a (higher layer) parameter cellSpecific-BFR set to ‘enabled’ (or set to ‘disabled’)
Condition-D: the UE is not provided in PDCCH-Config two different values of coresetPoolIndex (e.g., 0 and 1) in CORESETs, and/or the UE is not provided coresetPoolIndex value for the first CORESETs and is not provided coresetPoolIndex value for the second CORESETs, respectively
Condition-E: the UE/serving cell is not provided/configured/associated with, e.g., via higher layer RRC signalling(s)/parameter(s) and/or MAC CE command(s) and/or dynamic DCI based L1 signalling(s), BFD RS set(s) q̅_{0,0} and/or q̅_{0,1} and/or NBI RS set(s) q̅_{1,0} and/or q̅q_{1,1} for a BWP of the serving cell, and/or the UE is not expected/configured/indicated, e.g., via higher layer RRC signalling(s) and/or MAC CE command(s) and/or dynamic DCI based L1 signalling(s), to determine BFD RS set(s) q̅_{0,0} and/or q̅_{0,1} according to the first TCI-State/TCI-UL-State and/or the second TCI-State/TCI-UL-State following those specified herein in the present disclosure—e.g., the UE is not provided/configured/indicated by the network a (higher layer) parameter TRPspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter TRPspecific-implicit-BFDRS set to ‘disabled’
Condition-F: the UE/serving cell is provided/configured/associated with a single NBI RS set q̅₁ for a BWP of the serving cell, and/or the UE/serving cell is provided/configured/associated with respective two NBI RS sets q̅_{1,0} and/or q̅q_{1,1} for a BWP of the serving cell
Condition-G: the UE is expected/configured/indicated, e.g., via higher layer RRC signaling(s) and/or MAC CE command(s) and/or dynamic DCI based L1 signaling(s), to determine a single BFD RS set q̅₀ according to the first TCI-State/TCI-UL-State and/or the second TCI-State/TCI-UL-State—e.g., the UE is provided/configured/indicated by the network a (higher layer) parameter Cellspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter Cellspecific-implicit-BFDRS set to ‘enabled’
Condition-H: the UE is not provided/configured by the network the higher layer parameter applyIndicatedTCIState (or the first indicator as specified herein in the present disclosure) to the CORESET(s) for PDCCH reception
Condition-I: the UE is provided/configured by the network the higher layer parameter applyIndicatedTCIState (or the first indicator as specified herein in the present disclosure) to the CORESET(s) for PDCCH reception, which could be further set to ‘first’, ‘second’, ‘both’ or ‘none’
Condition-J: the UE is not provided/configured by the network the higher layer parameter tciSelection-PresentInDCI, and the TCI selection field indicator (or the second indicator as specified herein in the present disclosure) for PDSCH reception is not present or absent or corresponds to a 0-bit field in the corresponding DCI format(s) 1_1/1_2
Condition-K: the UE is provided/configured by the network the higher layer parameter tciSelection-PresentInDCI, and the TCI selection field indicator (or the second indicator as specified herein in the present disclosure) for PDSCH reception is present or corresponds to a 2-bit field in the corresponding DCI format(s) 1_1/1_2, wherein the DCI codepoint of the TCI selection field (or the second indicator as specified herein in the present disclosure) could be set to ‘00’, ‘01’, ‘10’ or ‘11’
Condition-L: the UE is not provided/configured by the network the higher layer parameter applyIndicatedTCIState (or the third indicator as specified herein in the present disclosure) to the PUCCH transmission
Condition-M: the UE is provided/configured by the network the higher layer parameter applyIndicatedTCIState (or the third indicator as specified herein in the present disclosure) to the PUCCH transmission, which could be further set to ‘first’, ‘second’ or ‘both’
Condition-N: the UE is provided/configured by the network a single SRS resource set associated with usage of value ‘nonCodeBook’ or ‘codebook’, and the SRS resource set indicator (or the fourth indicator as specified herein in the present disclosure) for PUSCH transmission is not present or absent or corresponds to a 0-bit field in the corresponding DCI format(s) 0_1/0_2
Condition-O: the UE is provided/configured by the network two SRS resource sets each associated with usage of value ‘nonCodeBook’ or ‘codebook’, and the SRS resource set indicator (or the fourth indicator as specified herein in the present disclosure) for PUSCH transmission is present or corresponds to a 2-bit field in the corresponding DCI format(s) 0_1/0_2, wherein the DCI codepoint of the SRS resource set indicator (or the fourth indicator as specified herein in the present disclosure) could be set to ‘00’, ‘01’, ‘10’ or ‘11’
   the UE could determine a single set q̅₀ to include periodic CSI-RS resource configuration indexes with same values as those in q̅_{0,0} and/or q̅_{0,1} (or equivalently, the UE could determine a single set q̅₀ to correspond to q̅_{0,0} or q̅_{0,1}) according to one of:
Fixed rule(s) in system specifications: e.g., the set q̅_{0,0}, or the set q̅_{0,1}
Network's configuration(s)/indication(s) via/by higher layer RRC signalling(s)/parameter(s) and/or MAC CE command(s) and/or dynamic DCI based L1 signalling(s): e.g., the UE could determine the set q̅₀ to include periodic CSI-RS resource configuration indexes with same values as those in q̅_{0,0} or q̅_{0,1} according to the RRC configuration applyIndicatedTCIState (or equivalently, the first indicator as specified herein in the present disclosure) provided to the corresponding CORESET(s)—for this case,
   if applyIndicatedTCIState=‘first’, the UE could determine the set q̅₀ to include periodic CSI-RS resource configuration indexes with same values as those in q̅_{0,0} (or equivalently, the UE could determine the set q̅₀ to correspond to q̅_{0,0}).
   if applyIndicatedTCIState=‘second’, the UE could determine the set q̅₀ to include periodic CSI-RS resource configuration indexes with same values as those in q̅_{0,1} (or equivalently, the UE could determine the set q̅₀ to correspond to q̅_{0,1})
   if applyIndicatedTCIState=‘both’, the UE could determine the set q̅₀ to include periodic CSI-RS resource configuration indexes with same values as those in both q̅_{0,0} and q̅_{0,1}.

The physical layer in the UE could assess the radio link quality according to the set q̅₀ of resource configurations against the threshold Q_{out,LR}. For this case, when/if one or more of the specified conditions herein of a UE to be provided q̅₀, q̅_{0,0} and/or q̅_{0,1} for a BWP of the serving cell are (or not) satisfied, held or achieved, and/or when/if one or more of the specified conditions herein (e.g., Condition-A—Condition-O) are (or not) satisfied, held or achieved, the UE could assess the radio link quality of the set q̅₀ only according to SS/PBCH blocks on the PCell or the PSCell or periodic CSI-RS resource configurations that are quasi co-located with the RSs in the RS sets indicated by the first TCI-State/TCI-UL-State and/or the second TCI-State/TCI-UL-State according to one of:
Fixed rule(s) in system specifications: e.g., the first TCI-State/TCI-UL-State, or the second TCI-State/TCI-UL-State
Network's configuration(s)/indication(s) via/by higher layer RRC signalling(s)/parameter(s) and/or MAC CE command(s) and/or dynamic DCI based L1 signalling(s): e.g., the UE could assess the radio link quality only according to SS/PBCH blocks on the PCell or the PSCell or periodic CSI-RS resource configurations that are quasi co-located with the RSs in the RS sets indicated by the first TCI-State/TCI-UL-State or the second TCI-State/TCI-UL-State according to the RRC configuration applyIndicatedTCIState (or equivalently, the first indicator as specified herein in the present disclosure) provided to the corresponding CORESET(s)—for this case,
   if applyIndicatedTCIState=‘first’, the UE expects that a DM-RS antenna port for PDCCH receptions in the CORESET(s) is quasi co-located with the reference signals provided by the first TCI-State
   if applyIndicatedTCIState=‘second’, the UE expects that a DM-RS antenna port for PDCCH receptions in the CORESET is quasi co-located with the reference signals provided by the second TCI-State
   if applyIndicatedTCIState=‘both’, the UE expects that a DM-RS antenna port for PDCCH receptions in the CORESET is quasi co-located with the reference signals provided by the first TCI-State and the second TCI-State

For one or more of the described/specified design examples herein, the UE could assess a first radio link quality according to the set q̅_{0,0} of resource configurations against the threshold Q_{out,LR}, and/or a second radio link quality according to the set q̅_{0,1} of resource configurations against the threshold Q_{out,LR}.

In one embodiment, if a UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or if the UE is provided dl-OrJointTCI-StateList or TCI-UL-State with (first) TCI-State or TCI-UL-State specific to the first CORESET(s) and (second) TCI-State or TCI-UL-State specific to the second CORESET(s), and/or if the UE does not report its capability of supporting TRP-specific BFR under unified TCI framework with unified TCI state(s), and/or if the UE is not configured/provided/indicated by the network a (higher layer) parameter perTRP-BFR (e.g., via RRC signalling(s) and/or MAC CE command(s) and/or dynamic DCI based L1 signalling(s)), e.g., set to ‘enabled’, and/or if the UE is configured/provided/indicated by the network, e.g., via RRC signalling(s) and/or MAC CE command(s) and/or DCI based L1 signalling(s), a (higher layer) parameter perTRP-BFR set to ‘disabled’, and/or if the UE reports its capability of supporting TRP-specific BFR under unified TCI framework with unified TCI state(s), and/or if the UE is configured/provided/indicated by the network, e.g., via RRC signalling(s) and/or MAC CE command(s) and/or dynamic DCI based L1 signalling(s), a (higher layer) parameter perTRP-BFR, e.g., set to ‘enabled’, and/or if the UE does not report its capability of supporting cell-specific BFR under unified TCI framework with unified TCI state(s), and/or if the UE is not configured/provided/indicated by the network a (higher layer) parameter cellSpecific-BFR (e.g., via RRC signalling(s) and/or MAC CE command(s) and/or dynamic DCI based L1 signalling(s)), e.g., set to ‘enabled’, and/or if the UE is configured/provided/indicated by the network, e.g., via RRC signalling(s) and/or MAC CE command(s) and/or dynamic DCI based L1 signalling(s), a (higher layer) parameter cellSpecific-BFR set to ‘disabled’, and/or if the UE reports its capability of supporting cell-specific BFR under unified TCI framework with unified TCI state(s), and/or if the UE is configured/provided/indicated by the network, e.g., via RRC signalling(s) and/or MAC CE command(s) and/or dynamic DCI based L1 signalling(s), a (higher layer) parameter cellSpecific-BFR set to ‘enabled’, and/or if the UE/serving cell is provided/configured/associated with respective two NBI RS sets q̅_{1,0} and/or q̅_{1,1} for a BWP of the serving cell, and/or if the UE/serving cell is not provided/configured/associated with, e.g., via higher layer RRC signalling(s)/parameter(s) and/or MAC CE command(s) and/or dynamic DCI based L1 signalling(s), BFD RS set(s) q̅_{0,0} and/or q̅_{0,1} and/or NBI RS set(s) q̅_{1,0} and/or q̅_{1,1} for a BWP of the serving cell, and/or if the UE is not expected/configured/indicated, e.g., via higher layer RRC signalling(s) and/or MAC CE command(s) and/or dynamic DCI based L1 signalling(s), to determine BFD RS set(s) R_{0,0} and/or q̅_{0,1} according to the (first and/or second) TCI-State(s)/TCI-UL-State(s) specific to the first and/or second CORESET(s) following those specified herein in the present disclosure—e.g., the UE is not provided/configured/indicated by the network a (higher layer) parameter TRPspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter TRPspecific-implicit-BFDRS set to ‘disabled’, and/or if the UE/serving cell is provided/configured/associated with a single NBI RS set q̅₁ for a BWP of the serving cell, and/or if the UE/serving cell is not provided/configured/associated with, e.g., via higher layer RRC signalling(s)/parameter(s) and/or MAC CE command(s) and/or dynamic DCI based L1 signalling(s), a single BFD RS set q̅₀ and/or a single NBI RS set q̅₁ for a BWP of the serving cell, and/or if the UE is not expected/configured/indicated, e.g., via higher layer RRC signalling(s)/parameter(s) and/or MAC CE command(s) and/or dynamic DCI based L1 signalling(s), to determine a single BFD RS set q̅₀ according to the (first and/or second) TCI-State(s)/TCI-UL-State(s) specific to the first and/or second CORESET(s) following those specified herein in the present disclosure—e.g., the UE is not provided/configured/indicated by the network a (higher layer) parameter Cellspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter Cellspecific-implicit-BFDRS set to ‘disabled’, and/or if the UE is not provided/configured by the network the higher layer parameter applyIndicatedTCIState (or the third indicator as specified herein in the present disclosure) to the PUCCH transmission, and/or if the UE is provided/configured by the network the higher layer parameter applyIndicatedTCIState (or the third indicator as specified herein in the present disclosure) to the PUCCH transmission, which could be further set to ‘first’ or ‘second’, and/or if SSB-MTC-AdditionalPCI is not provided, the UE could be provided (e.g., via higher layer RRC signaling(s)/parameter(s) and/or MAC CE command(s) and/or dynamic DCI based L1 signaling(s)), for each BWP of a serving cell, a set q̅₀ of periodic CSI-RS resource configuration indexes, wherein the set q̅₀ (and therefore, the periodic CSI-RS resource configuration indexes provided therein) could be activated by a MAC CE; otherwise—e.g., one or more of the specified conditions herein of a UE to be provided q̅₀ for a BWP of the serving cell are satisfied, held or achieved and/or one or more of the specified conditions herein of a UE to be provided q̅₀ for a BWP of the serving cell are not satisfied, held or achieved, for each BWP of a serving cell, the UE could be provided respective two sets q̅_{0,0} and q̅_{0,1} of periodic CSI-RS resource configuration indexes by failureDetectionSet1 and failureDetectionSet2 that can be activated by a MAC CE. If the UE is not provided q̅₀ for a BWP of the serving cell—e.g., one or more of the specified conditions herein of a UE to be provided q̅₀ for a BWP of the serving cell are satisfied, held or achieved and/or one or more of the specified conditions herein of a UE to be provided q̅₀ for a BWP of the serving cell are not satisfied, held or achieved, and/or if one or more of the following conditions are achieved, held or satisfied,
Condition-a: the UE is provided dl-OrJointTCI-StateList or TCI-UL-State with (first) TCI-State or TCI-UL-State specific to the first CORESET(s) and (second) TCI-State or TCI-UL-State specific to the second CORESET(s)
Condition-b: the UE does not report (or reports) its capability of supporting TRP-specific BFR under unified TCI framework with unified TCI state(s), and/or the UE is not (or is) configured/provided/indicated by the network a (higher layer) parameter perTRP-BFR (e.g., via RRC signalling(s) and/or MAC CE command(s) and/or dynamic DCI based L1 signalling), e.g., set to ‘enabled’ (or ‘disabled’), and/or the UE is (or is not) configured/provided/indicated by the network, e.g., via RRC signalling(s) and/or MAC CE command(s) and/or dynamic DCI based L1 signalling(s), a (higher layer) parameter perTRP-BFR set to ‘disabled’ (or ‘enabled’)
Condition-c: the UE reports (or does not report) its capability of supporting cell-specific BFR under unified TCI framework with unified TCI state(s), and/or the UE is (or not) configured/provided/indicated by the network, e.g., via RRC signalling(s) and/or MAC CE command(s) and/or dynamic DCI based L1 signalling(s), a (higher layer) parameter cellSpecific-BFR set to ‘enabled’ (or set to ‘disabled’)
Condition-d: the UE is provided two coresetPoolIndex values 0 and 1 for first and second CORESETs, or is not provided coresetPoolIndex value for the first CORESETs and is provided coresetPoolIndex value of 1 for the second CORESETs, respectively
Condition-e: the UE/serving cell is not provided/configured/associated with, e.g., via higher layer RRC signalling(s)/parameter(s) and/or MAC CE command(s) and/or dynamic DCI based L1 signalling(s), BFD RS set(s) q̅_{0,0} and/or q̅_{0,1} and/or NBI RS set(s) q̅_{1,0} and/or q̅q_{1,1} for a BWP of the serving cell, and/or the UE is not expected/configured/indicated, e.g., via higher layer RRC signalling(s) and/or MAC CE command(s) and/or dynamic DCI based L1 signaling(s), to determine BFD RS set(s) q̅_{0,0} and/or q̅_{0,1} according to the (first and/or second) TCI-State(s)/TCI-UL-State(s) specific to the first and/or second CORESET(s) following those specified herein in the present disclosure—e.g., the UE is not provided/configured/indicated by the network a (higher layer) parameter TRPspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter TRPspecific-implicit-BFDRS set to ‘disabled’
Condition-f: the UE/serving cell is provided/configured/associated with a single NBI RS set q̅₁ for a BWP of the serving cell, and/or the UE/serving cell is provided/configured/associated with respective two NBI RS sets q̅_{1,0} and/or q̅q_{1,1} for a BWP of the serving cell
Condition-g: the UE is expected/configured/indicated, e.g., via higher layer RRC signaling(s) and/or MAC CE command(s) and/or dynamic DCI based L1 signaling(s), to determine a single BFD RS set q̅₀ according to the (first and/or second) TCI-State(s)/TCI-UL-State(s) specific to the first and/or second CORESET(s) following those specified herein in the present disclosure—e.g., the UE is provided/configured/indicated by the network a (higher layer) parameter Cellspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter Cellspecific-implicit-BFDRS set to ‘enabled’
Condition-h: the UE is not provided/configured by the network the higher layer parameter applyIndicatedTCIState (or the third indicator as specified herein in the present disclosure) to the PUCCH transmission
Condition-i: the UE is provided/configured by the network (e.g. the network 130) the higher layer parameter applyIndicatedTCIState (or the third indicator as specified herein in the present disclosure) to the PUCCH transmission, which could be further set to ‘first’, ‘second’ or ‘both’
   The UE could Determine a Single Set q̅₀ According to One of:
In one example, the UE could determine the set q̅₀ to include periodic CSI-RS resource configuration indexes with same values as the RS indexes in the RS sets indicated by both the (first) TCI-State TCI-UL-State specific to the first CORESETs and the (second) TCI-State TCI-UL-State specific to the second CORESETs
In another example, the UE could determine the set q̅₀ to include periodic CSI-RS resource configuration indexes with same values as the RS indexes in the RS sets indicated by the (first) TCI-State TCI-UL-State specific to the first CORESETs and/or the (second) TCI-State TCI-UL-State specific to the second CORESETs according to one of:
   Fixed rule(s) in system specifications: e.g., the (first) TCI-State TCI-UL-State specific to the first CORESETs, or the (second) TCI-State TCI-UL-State specific to the second CORESETs, or the (first) TCI-State TCI-UL-State specific to the first CORESETs and the (second) TCI-State TCI-UL-State specific to the second CORESETs
   Network's configuration(s)/indication(s) via/by higher layer RRC signalling(s)/parameter(s) and/or MAC CE command(s) and/or dynamic DCI based L1 signalling(s).

Otherwise—e.g., one or more of the specified conditions herein (e.g., Condition-a—Condition-i) are satisfied, held or achieved and/or one or more of the specified conditions herein (e.g., Condition-a—Condition-i) are not satisfied, held or achieved, (1) the UE could determine a set q̅_{0,0} to include periodic CSI-RS resource configuration indexes with same values as the RS indexes in the RS sets indicated by the (first) TCI-State TCI-UL-State specific to the first CORESETs and a set q̅_{0,0} to include periodic CSI-RS resource configuration indexes with same values as the RS indexes in the RS sets indicated by the (second) TCI-State TCI-UL-State specific to the second CORESETs—e.g., when/if the UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or the UE is provided dl-OrJointTCI-StateList or TCI-UL-State with (first) TCI-State or TCI-UL-State specific to the first CORESET(s) and (second) TCI-State or TCI-UL-State specific to the second CORESET(s), and/or the UE is not provided q₀, q̅_{0,0} and/or q̅_{0,1} for a BWP of the serving cell, and/or the UE/serving cell is provided/configured/associated with two NBI RS sets q̅_{1,0} and q̅_{1,1} for a BWP of the serving cell; (2) the UE could be provided respective two sets q̅_{0,0} and q̅_{0,1} of periodic CSI-RS resource configuration indexes by failureDetectionSet1 and failureDetectionSet2 that can be activated by a MAC CE for each BWP of a serving cell. For the described/specified design examples herein, if there are two RS indexes in the TCI-State/TCI-UL-State specific to the first/second CORESETs, the set q̅₀ could include RS indexes configured with qcl-Type set to ‘typeD’ for the corresponding TCI-State/TCI-UL-State specific to the first/second CORESETs, and the UE could expect the set q̅₀ to include up to two RS indexes, or up to a number of N_{BFD} RS indexes indicated by maxBFD-RS-resourcesPerSetPerBWP (e.g., if q̅₀ is provided/configured by the network), or if the UE is not provided q₀, and if a number of active TCI states for PDCCH receptions in the first or second CORESETs is larger than N_{BFD}, the UE could determine the set q̅₀ to include periodic CSI-RS resource configuration indexes with same values as the RS indexes in the RS sets associated with the active TCI states for PDCCH receptions in the first or second CORESETs corresponding to search space sets according to an ascending order for PDCCH monitoring periodicity; if more than one first or second CORESETs correspond to search space sets with same monitoring periodicity, the UE could determine the order of the first or second CORESETs according to a descending order of a CORESET index. The physical layer in the UE could assess the radio link quality according to the set q̅₀ of resource configurations against the threshold Q_{out,LR}, when/if one or more of the specified conditions herein of a UE to be provided q̅₀ for a BWP of the serving cell are (or not) satisfied, held or achieved, and/or when/if one or more of the specified conditions herein (e.g., Condition-a—Condition-i) are (or not) satisfied, held or achieved.
In one example, the UE (e.g. the UE 116) could assess the radio link quality only according to SS/PBCH blocks on the PCell or the PSCell or periodic CSI-RS resource configurations that are quasi co-located with the RSs in the RS sets indicated by both the (first) TCI-State/TCI-UL-State specific to the first CORESETs and the (second) TCI-State/TCI-UL-State specific to the second CORESETs.
In another example, the UE could assess the radio link quality only according to SS/PBCH blocks on the PCell or the PSCell or periodic CSI-RS resource configurations that are quasi co-located with the RSs in the RS sets indicated by the (first) TCI-State/TCI-UL-State specific to the first CORESETs and/or the (second) TCI-State/TCI-UL-State specific to the second CORESETs according to one of:
   Fixed rule(s) in system specifications: e.g., the (first) TCI-State/TCI-UL-State specific to the first CORESETs, or the (second) TCI-State/TCI-UL-State specific to the second CORESETs, or the (first) TCI-State/TCI-UL-State specific to the first CORESETs and the (second) TCI-State/TCI-UL-State specific to the second CORESETs
   Network's configuration(s)/indication(s) via/by higher layer RRC signalling(s)/parameter(s) and/or MAC CE command(s) and/or dynamic DCI based L1 signalling(s).

For one or more of the described/specified design examples herein, the UE could assess a first radio link quality according to SS/PBCH blocks on the PCell or the PSCell or periodic CSI-RS resource configurations that are quasi co-located with the RSs in the RS sets indicated by the TCI-State TCI-UL-State specific to the first CORESETs, and/or a second radio link quality according to SS/PBCH blocks on the PCell or the PSCell or periodic CSI-RS resource configurations that are quasi co-located with the RSs in the RS sets indicated by the TCI-State TCI-UL-State specific to the second CORESETs.

In one embodiment, if a UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or if the UE is provided dl-OrJointTCI-StateList or TCI-UL-State with (first) TCI-State or TCI-UL-State specific to the first CORESET(s) and (second) TCI-State or TCI-UL-State specific to the second CORESET(s), and/or if the UE does not report its capability of supporting TRP-specific BFR under unified TCI framework with unified TCI state(s), and/or if the UE is not configured/provided/indicated by the network a (higher layer) parameter perTRP-BFR (e.g., via RRC signalling(s) and/or MAC CE command(s) and/or dynamic DCI based L1 signalling(s)), e.g., set to ‘enabled’, and/or if the UE is configured/provided/indicated by the network, e.g., via RRC signalling(s) and/or MAC CE command(s) and/or DCI based L1 signalling(s), a (higher layer) parameter perTRP-BFR set to ‘disabled’, and/or if the UE reports its capability of supporting TRP-specific BFR under unified TCI framework with unified TCI state(s), and/or if the UE is configured/provided/indicated by the network, e.g., via RRC signalling(s) and/or MAC CE command(s) and/or dynamic DCI based L1 signalling(s), a (higher layer) parameter perTRP-BFR, e.g., set to ‘enabled’, and/or if the UE does not report its capability of supporting cell-specific BFR under unified TCI framework with unified TCI state(s), and/or if the UE is not configured/provided/indicated by the network a (higher layer) parameter cellSpecific-BFR (e.g., via RRC signalling(s) and/or MAC CE command(s) and/or dynamic DCI based L1 signalling(s)), e.g., set to ‘enabled’, and/or if the UE is configured/provided/indicated by the network, e.g., via RRC signalling(s) and/or MAC CE command(s) and/or dynamic DCI based L1 signalling(s), a (higher layer) parameter cellSpecific-BFR set to ‘disabled’, and/or if the UE reports its capability of supporting cell-specific BFR under unified TCI framework with unified TCI state(s), and/or if the UE is configured/provided/indicated by the network, e.g., via RRC signalling(s) and/or MAC CE command(s) and/or dynamic DCI based L1 signalling(s), a (higher layer) parameter cellSpecific-BFR set to ‘enabled’, and/or if the UE/serving cell is provided/configured/associated with respective two NBI RS sets q̅_{1,0} and/or q̅_{1,1} for a BWP of the serving cell, and/or if the UE/serving cell is not provided/configured/associated with, e.g., via higher layer RRC signalling(s)/parameter(s) and/or MAC CE command(s) and/or dynamic DCI based L1 signalling(s), BFD RS set(s) q̅_{0,0} and/or q̅_{0,1} and/or NBI RS set(s) q̅_{1,0} and/or q̅_{1,1} for a BWP of the serving cell, and/or if the UE is not expected/configured/indicated, e.g., via higher layer RRC signalling(s) and/or MAC CE command(s) and/or dynamic DCI based L1 signalling(s), to determine BFD RS set(s) q̅_{0,0} and/or q̅_{0,1} according to the (first and/or second) TCI-State(s)/TCI-UL-State(s) specific to the first and/or second CORESET(s) following those specified herein in the present disclosure—e.g., the UE is not provided/configured/indicated by the network a (higher layer) parameter TRPspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter TRPspecific-implicit-BFDRS set to ‘disabled’, and/or if the UE/serving cell is provided/configured/associated with a single NBI RS set q̅₁ for a BWP of the serving cell, and/or if the UE/serving cell is not provided/configured/associated with, e.g., via higher layer RRC signalling(s)/parameter(s) and/or MAC CE command(s) and/or dynamic DCI based L1 signalling(s), a single BFD RS set q̅₀ and/or a single NBI RS set q̅₁ for a BWP of the serving cell, and/or if the UE is not expected/configured/indicated, e.g., via higher layer RRC signalling(s)/parameter(s) and/or MAC CE command(s) and/or dynamic DCI based L1 signalling(s), to determine a single BFD RS set q̅₀ according to the (first and/or second) TCI-State(s)/TCI-UL-State(s) specific to the first and/or second CORESET(s) following those specified herein in the present disclosure—e.g., the UE is not provided/configured/indicated by the network a (higher layer) parameter Cellspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter Cellspecific-implicit-BFDRS set to ‘disabled’, and/or if the UE is not provided/configured by the network the higher layer parameter applyIndicatedTCIState (or the third indicator as specified herein in the present disclosure) to the PUCCH transmission, and/or if the UE is provided/configured by the network the higher layer parameter applyIndicatedTCIState (or the third indicator as specified herein in the present disclosure) to the PUCCH transmission, which could be further set to ‘first’ or ‘second’, and/or if SSB-MTC-AdditionalPCJ is not provided, the UE could be provided, for each BWP of a serving cell, respective two sets q̅_{0,0} and q̅_{0,1} of periodic CSI-RS resource configuration indexes, wherein the set q̅_{0,0} and/or the set q̅_{0,1} (and therefore, the periodic CSI-RS resource configuration indexes provided therein) could be activated by a MAC CE; otherwise, e.g., one or more of the specified conditions herein of a UE to be provided q̅_{0,0} and q̅_{0,1} for a BWP of the serving cell are satisfied, held or achieved and/or one or more of the specified conditions herein of a UE to be provided q̅_{0,0} and q̅_{0,1} for a BWP of the serving cell are not satisfied, held or achieved, the UE could be provided, for each BWP of a serving cell, a set q̅₀ of periodic CSI-RS resource configuration indexes, wherein the set q̅₀ (and therefore, the periodic CSI-RS resource configuration indexes provided therein) could be activated by a MAC CE. If the UE is not provided q̅_{0,0} and q̅_{0,1} for a BWP of the serving cell—e.g., one or more of the specified conditions herein of a UE to be provided q̅_{0,0} and q̅_{0,1} for a BWP of the serving cell are satisfied, held or achieved and/or one or more of the specified conditions herein of a UE to be provided q̅_{0,0} and q̅_{0,1} for a BWP of the serving cell are not satisfied, held or achieved, the UE could determine the set q̅_{0,0} to include periodic CSI-RS resource configuration indexes with same values as the RS indexes in the RS sets indicated by the (first) TCI-State TCI-UL-State specific to the first CORESETs and the set q̅_{0,0} to include periodic CSI-RS resource configuration indexes with same values as the RS indexes in the RS sets indicated by the (second) TCI-State TCI-UL-State specific to the second CORESETs. Otherwise—e.g., one or more of the specified conditions herein of a UE to be provided q̅_{0,0} and q̅_{0,1} for a BWP of the serving cell are satisfied, held or achieved and/or one or more of the specified conditions herein of a UE to be provided q̅_{0,0} and q̅_{0,1} for a BWP of the serving cell are not satisfied, held or achieved, (1) the UE could determine a set q̅₀ to include periodic CSI-RS resource configuration indexes with same values as the RS indexes in the RS sets indicated by the (first) TCI-State TCI-UL-State specific to the first CORESETs and/or the (second) TCI-State TCI-UL-State specific to the second CORESETs according to those specified herein in the present disclosure—e.g., when/if the UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or the UE is provided dl-OrJointTCI-StateList or TCI-UL-State with (first) TCI-State or TCI-UL-State specific to the first CORESET(s) and (second) TCI-State or TCI-UL-State specific to the second CORESET(s), and/or the UE is not provided q₀, q̅_{0,0} and/or q̅_{0,1} for a BWP of the serving cell, and/or the UE/serving cell is provided/configured/associated with a single NBI RS set q̅₁ for a BWP of the serving cell; (2) the UE could be provided, for each BWP of a serving cell, a set q̅₀ of periodic CSI-RS resource configuration indexes, wherein the set q̅₀ (and therefore, the periodic CSI-RS resource configuration indexes provided therein) could be activated by a MAC CE. If there are two RS indexes in the TCI-State TCI-UL-State specific to the first/second CORESETs, the set q̅_{0,0}/q̅_{0,1} could include RS indexes configured with qcl-Type set to ‘typeD’ for the corresponding TCI-State TCI-UL-State specific to the first/second CORESETs, and the UE could expect the set q̅_{0,0}/q̅_{0,1} to include up to two RS indexes, or up to a number of N_{BFD} RS indexes indicated by maxBFD-RS-resourcesPerSetPerBWP (e.g., if q̅_{0,0} and/or q̅_{0,1} is provided/configured by the network), or if the UE is not provided q̅_{0,0} and/or q̅_{0,1}, and if a number of active TCI states for PDCCH receptions in the first or second CORESETs is larger than N_{BFD}, the UE could determine the set q̅_{0,0} or q̅_{0,1} to include periodic CSI-RS resource configuration indexes with same values as the RS indexes in the RS sets associated with the active TCI states for PDCCH receptions in the first or second CORESETs corresponding to search space sets according to an ascending order for PDCCH monitoring periodicity; if more than one first or second CORESETs correspond to search space sets with same monitoring periodicity, the UE could determine the order of the first or second CORESETs according to a descending order of a CORESET index. When/if one or more of the specified conditions herein of a UE to be provided q₀, q̅_{0,0} and q̅_{0,1} are satisfied, held or achieved, and/or when/if one or more of the specified conditions herein of a UE to be provided q₀, q̅_{0,0} and q̅_{0,1} are not satisfied, held or achieved, and/or when/if one or more of the following conditions are achieved, held or satisfied,
Condition-a: the UE is provided dl-OrJointTCI-StateList or TCI-UL-State with (first) TCI-State or TCI-UL-State specific to the first CORESET(s) and (second) TCI-State or TCI-UL-State specific to the second CORESET(s)
Condition-b: the UE does not report (or reports) its capability of supporting TRP-specific BFR under unified TCI framework with unified TCI state(s), and/or the UE is not (or is) configured/provided/indicated by the network a (higher layer) parameter perTRP-BFR (e.g., via RRC signalling(s) and/or MAC CE command(s) and/or dynamic DCI based L1 signalling), e.g., set to ‘enabled’ (or ‘disabled’), and/or the UE is (or is not) configured/provided/indicated by the network, e.g., via RRC signalling(s) and/or MAC CE command(s) and/or dynamic DCI based L1 signalling(s), a (higher layer) parameter perTRP-BFR set to ‘disabled’ (or set to ‘enabled’)
Condition-c: the UE reports (or does not report) its capability of supporting cell-specific BFR under unified TCI framework with unified TCI state(s), and/or the UE is (or is not) configured/provided/indicated by the network, e.g., via RRC signalling(s) and/or MAC CE command(s) and/or dynamic DCI based L1 signalling(s), a (higher layer) parameter cellSpecific-BFR set to ‘enabled’ (or set to ‘disabled’)
Condition-d: the UE is provided two coresetPoolIndex values 0 and 1 for first and second CORESETs, or is not provided coresetPoolIndex value for the first CORESETs and is provided coresetPoolIndex value of 1 for the second CORESETs, respectively
Condition-e: the UE/serving cell is not provided/configured/associated with, e.g., via higher layer RRC signalling(s)/parameter(s) and/or MAC CE command(s) and/or dynamic DCI based L1 signalling(s), BFD RS set(s) q̅_{0,0} and/or q̅_{0,1} and/or NBI RS set(s) q̅_{1,0} and/or q̅q_{1,1} for a BWP of the serving cell, and/or the UE is not expected/configured/indicated, e.g., via higher layer RRC signalling(s) and/or MAC CE command(s) and/or dynamic DCI based L1 signaling(s), to determine BFD RS set(s) q̅_{0,0} and/or q̅_{0,1} according to the (first and/or second) TCI-State(s)/TCI-UL-State(s) specific to the first and/or second CORESET(s) following those specified herein in the present disclosure—e.g., the UE is not provided/configured/indicated by the network a (higher layer) parameter TRPspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter TRPspecific-implicit-BFDRS set to ‘disabled’
Condition-f: the UE/serving cell is provided/configured/associated with a single NBI RS set q̅₁ for a BWP of the serving cell, and/or the UE/serving cell is provided/configured/associated with respective two NBI RS sets q̅_{1,0} and/or q̅q_{1,1} for a BWP of the serving cell
Condition-g: the UE is expected/configured/indicated, e.g., via higher layer RRC signaling(s) and/or MAC CE command(s) and/or dynamic DCI based L1 signaling(s), to determine a single BFD RS set q̅₀ according to the (first and/or second) TCI-State(s)/TCI-UL-State(s) specific to the first and/or second CORESET(s) following those specified herein in the present disclosure—e.g., the UE is provided/configured/indicated by the network a (higher layer) parameter Cellspecific-implicit-BFDRS (e.g., via higher layer RRC signaling(s) and/or MAC CE command(s) and/or dynamic DCI based L1 signaling(s)), or is provided/configured/indicated by the network, e.g., via higher layer RRC signaling(s) and/or MAC CE command(s) and/or dynamic DCI based L1 signaling(s), the (higher layer) parameter Cellspecific-implicit-BFDRS set to ‘enabled’
Condition-h: the UE is not provided/configured by the network the higher layer parameter applyIndicatedTCIState (or the third indicator as specified herein in the present disclosure) to the PUCCH transmission
Condition-i: the UE is provided/configured by the network the higher layer parameter applyIndicatedTCIState (or the third indicator as specified herein in the present disclosure) to the PUCCH transmission, which could be further set to ‘first’, ‘second’ or ‘both’,
   the UE could determine a single set q̅₀ to include periodic CSI-RS resource configuration indexes with same values as those in q̅_{0,0} for the first CORESETs and/or q̅_{0,1} for the second CORESETs (or equivalently, the UE could determine a single set q̅₀ to correspond to q̅_{0,0} for the first CORESETs or q̅_{0,1} for the second CORESETs) according to one of:
Fixed rule(s) in system specifications: e.g., the set q̅_{0,0} for the first CORESETs, or the set q̅_{0,1} for the second CORESETs, or the set q̅_{0,0} for the first CORESETs and the set q̅_{0,1} for the second CORESETs
Network's configuration(s)/indication(s) via/by higher layer RRC signalling(s)/parameter(s) and/or MAC CE command(s) and/or dynamic DCI based L1 signalling(s)

The physical layer in the UE could assess the radio link quality according to the set q̅₀ of resource configurations against the threshold Q_{out,LR}. For this case, when/if one or more of the specified conditions herein of a UE to be provided q̅₀, q̅_{0,0} and/or q̅_{0,1} for a BWP of the serving cell are (or not) satisfied, held or achieved, and/or when/if one or more of the specified conditions herein (e.g., Condition-a—Condition-i) are (or not) satisfied, held or achieved, the UE could assess the radio link quality only according to SS/PBCH blocks on the PCell or the PSCell or periodic CSI-RS resource configurations that are quasi co-located with the RSs in the RS sets indicated by the (first and/or second) TCI-State(s) TCI-UL-State(s) specific to the first CORESETs and/or the second CORESETs according to one of:
Fixed rule(s) in system specifications: e.g., the (first) TCI-State TCI-UL-State specific to the first CORESETs, or the (second) TCI-State TCI-UL-State specific to the second CORESETs, or the (first) TCI-State TCI-UL-State specific to the first CORESETs and the (second) TCI-State TCI-UL-State specific to the second CORESETs
Network's configuration(s)/indication(s) via/by higher layer RRC signalling(s)/parameter(s) and/or MAC CE command(s) and/or dynamic DCI based L1 signalling(s)

For one or more of the described/specified design examples herein, the UE could assess a first radio link quality according to the set q̅_{0,0} of resource configurations for the first CORESETs against the threshold Q_{out,LR}, and/or a second radio link quality according to the set q̅_{0,1} of resource configurations for the second CORESETs against the threshold Q_{out,LR}.

In one embodiment, if the UE is not provided q̅₀ by failureDetectionResourcesToAddModList for a BWP of the serving cell, and/or if the UE is provided dl-OrJointTCI-StateList or ul-TCI-StateList, the UE could determine the set q̅₀ to include periodic CSI-RS resource configuration indexes with same values as the RS indexes in the RS sets indicated by one or two TCI-State(s) for respective CORESETs that the UE uses for monitoring PDCCH. In this case, if there are two (indicated) TCI-States for respective CORESETs that the UE uses for monitoring the PDCCH reception(s), the UE could be provided two coresetPoolIndex values 0 and 1 for first and second CORESETs, or may not be provided coresetPoolIndex value for the first CORESETs and could be provided coresetPoolIndex value of 1 for the second CORESETs, respectively, on the active DL BWP of the serving cells.

In one embodiment, if a UE is provided dl-OrJointTCI-StateList or TCI-UL-State and is indicated a first TCI-State or TCI-UL-State and a second TCI-State or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the first TCI-State/TCI-UL-State and/or the second TCI-State/TCI-UL-State following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the first TCI-State/TCI-UL-State and/or the second TCI-State/TCI-UL-State following those specified herein in the present disclosure, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if SSB-MTC-AdditionalPCJ is not provided, the UE could be provided, for each BWP of a serving cell, a set q̅₁ of periodic CSI-RS resource configuration indexes and/or SS/PBCH block indexes for radio link quality measurements on the BWP of the serving cell. Furthermore, the set q̅₁ could be specific to q̅₀ (e.g., corresponding to q̅_{0,0} or q̅_{0,1}, or containing/including/providing/comprising RSs specific to the first TCI-State/TCI-UL-State or the second TCI-State/TCI-UL-State) defined/specified herein in the present disclosure and/or could provide/contain/configure one or more periodic CSI-RS resource configuration indexes and/or SS/PBCH block indexes specific to the set q̅_{0,0} and/or the first TCI-State or TCI-UL-State (and therefore, associated to the RSs in the set q̅₀ that are specific to the first TCI-State TCI-UL-State as specified herein in the present disclosure) and/or one or more periodic CSI-RS resource configuration indexes and/or SS/PBCH block indexes specific to the set q̅_{0,1} and/or the second TCI-State or TCI-UL-State (and therefore, associated to the RSs in the set q̅₀ that are specific to the second TCI-State TCI-UL-State as specified herein in the present disclosure) according to one of:
Fixed rule(s) in system specification(s): e.g., the first K periodic CSI-RS resource configuration indexes and/or SS/PBCH block indexes in the set q̅₁ could be specific to the set q̅_{0,0} and/or the first TCI-State TCI-UL-State, and the rest of the periodic CSI-RS resource configuration indexes and/or SS/PBCH block indexes in the set q̅₁ could be specific to the set q̅_{0,1} and/or the second TCI-State TCI-UL-State.
Network's configuration(s)/indication(s) via/by higher layer RRC signalling(s)/parameter(s) and/or MAC CE command(s) and/or dynamic DCI based L1 signalling(s)

The periodic CSI-RS resource configuration indexes and/or SS/PBCH block indexes in the set q̅₁ (e.g., specific to the first TCI-State TCI-UL-State) could be associated with the set q̅₀ and/or the set q̅_{0,0} and/or the periodic CSI-RS resource configuration indexes in the set q̅₀ specific to the first TCI-State TCI-UL-State, and/or the periodic CSI-RS resource configuration indexes and/or SS/PBCH block indexes in the set q̅₁ (e.g., specific to the second TCI-State TCI-UL-State) could be associated with the set q̅₀ and/or the set q̅_{0,1} and/or the periodic CSI-RS resource configuration indexes in the set q̅₀ specific to the second TCI-State TCI-UL-State.

In one embodiment, if a UE is provided dl-OrJointTCI-StateList or TCI-UL-State and is indicated a first TCI-State or TCI-UL-State and a second TCI-State or TCI-UL-State, and/or if the UE does not report its capability of supporting TRP-specific BFR under unified TCI framework with unified TCI state(s), and/or if the UE is not configured/provided by the network (e.g. the network 130) a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the first TCI-State/TCI-UL-State and/or the second TCI-State/TCI-UL-State following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the first TCI-State/TCI-UL-State and/or the second TCI-State/TCI-UL-State following those specified herein in the present disclosure, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if SSB-MTC-AdditionalPCI is not provided, the UE could be provided, for each BWP of a serving cell, two sets q̅_{1,0} and q̅_{1,1} of periodic CSI-RS resource configuration indexes and/or SS/PBCH block indexes for radio link quality measurements on the BWP of the serving cell. Furthermore, the set q̅_{1,0} could be specific to the set q̅_{0,0} and/or could provide/contain/configure one or more periodic CSI-RS resource configuration indexes and/or SS/PBCH block indexes specific to the first TCI-State or TCI-UL-State (and therefore, associated to the RSs in the set q̅₀ that are specific to the first TCI-State/TCI-UL-State as specified herein in the present disclosure), and/or the set q̅_{1,1} could be specific to the set q̅_{0,1} and/or could provide/contain/configure one or more periodic CSI-RS resource configuration indexes and/or SS/PBCH block indexes specific to the second TCI-State or TCI-UL-State (and therefore, associated to the RSs in the set q̅₀ that are specific to the second TCI-State/TCI-UL-State as specified herein in the present disclosure). Optionally, the UE could determine or identify a set q̅₁—specific to q̅₀ (e.g., corresponding to q̅_{0,0} or q̅_{0,1}, or containing/including/providing/comprising RSs specific to the first TCI-State/TCI-UL-State or the second TCI-State/TCI-UL-State) defined/specified herein in the present disclosure—as/corresponding to the set q̅_{1,0} or the set q̅_{1,1} as specified herein in the present disclosure according to one of:
Fixed rule(s) in system specification(s): e.g., the set q̅_{1,0}, or the set q̅_{1,1}
Network's configuration(s)/indication(s) via/by higher layer RRC signalling(s)/parameter(s) and/or MAC CE command(s) and/or dynamic DCI based L1 signalling(s), e.g., the UE could determine or identify the set q̅₁ as/corresponding to the set q̅_{1,0} or the set q̅_{1,1} according to the RRC configuration applyIndicatedTCIState (or equivalently, the first indicator as specified herein in the present disclosure) provided to the corresponding CORESET(s)—for this case,
   if applyIndicatedTCIState=‘first’, the UE could determine or identify the set q̅₁ as/corresponding to the set q̅_{1,0} defined/specified herein in the present disclosure.
   if applyIndicatedTCIState=‘second’, the UE could determine or identify the set q̅₁ as/corresponding to the set q̅_{1,1} defined/specified herein in the present disclosure.

In one embodiment, if a UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or if the UE is provided dl-OrJointTC-StateList or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the TCI-State(s)/TCI-UL-State(s) specific to the first and/or second CORESET(s) following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the TCI-State(s)/TCI-UL-State(s) specific to the first and/or second CORESET(s) following those specified herein in the present disclosure, and/or if SSB-MTC-AdditionalPCI is not provided, the UE (e.g. the UE 116) could be provided, for each BWP of a serving cell, a set q̅₁ of periodic CSI-RS resource configuration indexes and/or SS/PBCH block indexes for radio link quality measurements on the BWP of the serving cell. Furthermore, the set q̅₁ could be specific to q̅₀ (e.g., corresponding to q̅_{0,0} or q̅_{0,1}, or containing/including/providing/comprising RSs specific to the first CORESETs or the TCI-State/TCI-UL-State specific to the first CORESETs or the second CORESETs or the TCI-State/TCI-UL-State specific to the second CORESETs) defined/specified herein in the present disclosure and/or could provide/contain/configure one or more periodic CSI-RS resource configuration indexes and/or SS/PBCH block indexes specific to the first CORESETs or the TCI-State or TCI-UL-State specific to the first CORESETs (and therefore, associated to the RSs in the set q₀, or q̅₀ that are specific to the first CORESETs or the TCI-State TCI-UL-State specific to the first CORESETs as specified herein in the present disclosure) and/or one or more periodic CSI-RS resource configuration indexes and/or SS/PBCH block indexes specific to the second CORESETs or the TCI-State or TCI-UL-State specific to the second CORESETs (and therefore, associated to the RSs in the set q̅_{0,1} or q̅₀ that are specific to the second CORESETs or the TCI-State TCI-UL-State specific to the second CORESETs as specified herein in the present disclosure) according to one of:
Fixed rule(s) in system specification(s): e.g., the first K periodic CSI-RS resource configuration indexes and/or SS/PBCH block indexes in the set q̅₁ could be specific to the first CORESETs or the TCI-State TCI-UL-State specific to the first CORESETs as specified herein in the present disclosure, and the rest of the periodic CSI-RS resource configuration indexes and/or SS/PBCH block indexes in the set q̅₁ could be specific to the second CORESETs or the TCI-State TCI-UL-State specific to the second CORESETs as specified herein in the present disclosure.
Network's configuration(s)/indication(s) via/by higher layer RRC signalling(s)/parameter(s) and/or MAC CE command(s) and/or dynamic DCI based L1 signalling(s)

The periodic CSI-RS resource configuration indexes and/or SS/PBCH block indexes in the set q̅₁ (e.g., specific to the first CORESETs or the TCI-State TCI-UL-State specific to the first CORESETs as specified herein in the present disclosure) could be associated with the set q̅₀ and/or the set q̅_{0,0} and/or the periodic CSI-RS resource configuration indexes in the set q̅₀ specific to the first CORESETs or the TCI-State TCI-UL-State specific to the first CORESETs as specified herein in the present disclosure, and the periodic CSI-RS resource configuration indexes and/or SS/PBCH block indexes in the set q̅₁ (e.g., specific to the second CORESETs or the TCI-State TCI-UL-State specific to the second CORESETs as specified herein in the present disclosure) could be associated with the set q̅₀ and/or the set q̅_{0,1} and/or the periodic CSI-RS resource configuration indexes in the set q̅₀ specific to the second CORESETs or the TCI-State TCI-UL-State specific to the second CORESETs as specified herein in the present disclosure.

In one embodiment, if a UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or if the UE is provided dl-OrJointTCI-StateList or TCI-UL-State, and/or if the UE is provided dl-OrJointTCI-StateList or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the TCI-State(s)/TCI-UL-State(s) specific to the first and/or second CORESET(s) following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the TCI-State(s)/TCI-UL-State(s) specific to the first and/or second CORESET(s) following those specified herein in the present disclosure, and/or if SSB-MTC-AdditionalPCJ is not provided, the UE could be provided, for each BWP of a serving cell, two sets q̅_{1,0} and q̅_{1,1} of periodic CSI-RS resource configuration indexes and/or SS/PBCH block indexes for radio link quality measurements on the BWP of the serving cell. Furthermore, the set q̅_{1,0} could be specific to the set q̅_{0,0} and/or could provide/contain/configure one or more periodic CSI-RS resource configuration indexes and/or SS/PBCH block indexes specific to the first CORESETs or the TCI-State or TCI-UL-State specific to the first CORESETs (and therefore, associated to the RSs in the set q̅₀ that are specific to the first CORESETs or the TCI-State TCI-UL-State specific to the first CORESETs as specified herein in the present disclosure), and/or the set q̅_{1,1} could be specific to the set q̅_{0,1} and/or could provide/contain/configure one or more periodic CSI-RS resource configuration indexes and/or SS/PBCH block indexes specific to the second CORESETs or the TCI-State or TCI-UL-State specific to the second CORESETs (and therefore, associated to the RSs in the set q̅₀ that are specific to the second CORESETs or the TCI-State TCI-UL-State specific to the second CORESETs as specified herein in the present disclosure). Optionally, the UE could determine or identify a set q̅₁—specific to q̅₀ (e.g., corresponding to q̅_{0,0} or q̅_{0,1}, or containing/including/providing/comprising RSs specific to the first CORESETs or the TCI-State/TCI-UL-State specific to the first CORESETs or the second CORESETs or the TCI-State/TCI-UL-State specific to the second CORESETs) defined/specified herein in the present disclosure—as/corresponding to the set q̅_{1,0} or the set q̅_{1,1} as specified herein in the present disclosure according to one of:
Fixed rule(s) in system specification(s): e.g., the set q̅_{1,0}, or the set q̅_{1,1}
Network's configuration(s)/indication(s) via/by higher layer RRC signalling(s)/parameter(s) and/or MAC CE command(s) and/or dynamic DCI based L1 signalling(s)

In one embodiment, if a UE is provided dl-OrJointTCI-StateList or TCI-UL-State and is indicated a first TCI-State or TCI-UL-State and a second TCI-State or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the first TCI-State/TCI-UL-State and/or the second TCI-State/TCI-UL-State following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the first TCI-State/TCI-UL-State and/or the second TCI-State/TCI-UL-State following those specified herein in the present disclosure, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if SSB-MTC-AdditionalPCJ is not provided,
In one example, the physical layer in the UE could provide an indication to higher layers when the radio link quality for corresponding resource configurations in the set q̅₀ as specified/defined herein in the present disclosure that the UE uses to assess the radio link quality is worse than the threshold Q_{out,LR}. For this case/design example, the physical layer informs the higher layers when the radio link quality is worse than the threshold Q_{out,LR} with a periodicity determined by the maximum between the shortest periodicity among the SS/PBCH blocks on the PCell or the PSCell and/or the periodic CSI-RS configurations in the set q̅₀ that the UE uses to assess the radio link quality and 2 msec.
In another example, the physical layer in the UE could provide an indication to higher layers when the first radio link quality as specified herein in the present disclosure for corresponding resource configurations specific to the first TCI-State TCI-UL-State in the set q̅₀ or for corresponding resource configurations in the set q̅_{0,0} that the UE uses to assess the first radio link quality is worse than the threshold Q_{out,LR}, or when the second radio link quality as specified herein in the present disclosure for corresponding resource configurations specific to the second TCI-State TCI-UL-State in the set q̅₀ or for corresponding resource configurations in the set q̅_{0,1} that the UE uses to assess the second radio link quality is worse than the threshold Q_{out,LR}. For this case/design example, the physical layer informs the higher layers when the first radio link quality is worse than the threshold Q_{out,LR} with a periodicity determined by the maximum between the shortest periodicity among the SS/PBCH blocks on the PCell or the PSCell and/or the periodic CSI-RS configurations in the set q̅₀/q̅_{0,0} that the UE uses to assess the radio link quality or the maximum between the shortest periodicity among the SS/PBCH blocks on the PCell or the PSCell and/or the periodic CSI-RS configurations specific to the first TCI-State TCI-UL-State in the set q̅₀ that the UE uses to assess the first radio link quality and 2 msec, and/or the physical layer informs the higher layers when the second radio link quality is worse than the threshold Q_{out,LR} with a periodicity determined by the maximum between the shortest periodicity among the SS/PBCH blocks on the PCell or the PSCell and/or the periodic CSI-RS configurations in the set q̅₀/q̅_{0,1} that the UE uses to assess the radio link quality or the maximum between the shortest periodicity among the SS/PBCH blocks on the PCell or the PSCell and/or the periodic CSI-RS configurations specific to the second TCI-State TCI-UL-State in the set q̅₀ that the UE uses to assess the second radio link quality and 2 msec.

In one embodiment, if a UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or if the UE is provided dl-OrJointTC-StateList or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the TCI-State(s)/TCI-UL-State(s) specific to the first and/or second CORESET(s) following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the TCI-State(s)/TCI-UL-State(s) specific to the first and/or second CORESET(s) following those specified herein in the present disclosure, and/or if SSB-MTC-AdditionalPCI is not provided,
In one example, the physical layer in the UE could provide an indication to higher layers when the radio link quality for corresponding resource configurations in the set q̅₀ as specified/defined herein in the present disclosure that the UE uses to assess the radio link quality is worse than the threshold Q_{out,LR}. For this case/design example, the physical layer informs the higher layers when the radio link quality is worse than the threshold Q_{out,LR} with a periodicity determined by the maximum between the shortest periodicity among the SS/PBCH blocks on the PCell or the PSCell and/or the periodic CSI-RS configurations in the set q̅₀ that the UE uses to assess the radio link quality and 2 msec.
In another example, the physical layer in the UE could provide an indication to higher layers when the first radio link quality as specified herein in the present disclosure for corresponding resource configurations specific to the first CORESETs or the TCI-State TCI-UL-State specific to the first CORESETs in the set q̅₀ or for corresponding resource configurations in the set q̅_{0,0} that the UE uses to assess the first radio link quality is worse than the threshold Q_{out,LR}, and/or when the second radio link quality as specified herein in the present disclosure for corresponding resource configurations specific to the second CORESETs or the TCI-State TCI-UL-State specific to the second CORESETs in the set q̅₀ or for corresponding resource configurations in the set q̅_{0,1} that the UE uses to assess the second radio link quality is worse than the threshold Q_{out,LR}. For this case/design example, the physical layer informs the higher layers when the first radio link quality is worse than the threshold Q_{out,LR} with a periodicity determined by the maximum between the shortest periodicity among the SS/PBCH blocks on the PCell or the PSCell and/or the periodic CSI-RS configurations in the set q̅₀/q̅_{0,0} that the UE uses to assess the radio link quality or the maximum between the shortest periodicity among the SS/PBCH blocks on the PCell or the PSCell and/or the periodic CSI-RS configurations specific to the first CORESETs or the TCI-State TCI-UL-State specific to the first CORESETs in the set q̅₀ that the UE uses to assess the first radio link quality and 2 msec, and/or the physical layer informs the higher layers when the second radio link quality is worse than the threshold Q_{out,LR} with a periodicity determined by the maximum between the shortest periodicity among the SS/PBCH blocks on the PCell or the PSCell and/or the periodic CSI-RS configurations in the set q̅₀/q̅_{0,1} that the UE uses to assess the radio link quality or the maximum between the shortest periodicity among the SS/PBCH blocks on the PCell or the PSCell and/or the periodic CSI-RS configurations specific to the second CORESETs or the TCI-State TCI-UL-State specific to the second CORESETs in the set q̅₀ that the UE uses to assess the second radio link quality and 2 msec.

In one embodiment, if a UE is provided dl-OrJointTCI-StateList or TCI-UL-State and is indicated a first TCI-State or TCI-UL-State and a second TCI-State or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the first TCI-State/TCI-UL-State and/or the second TCI-State/TCI-UL-State following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the first TCI-State/TCI-UL-State and/or the second TCI-State/TCI-UL-State following those specified herein in the present disclosure, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if SSB-MTC-AdditionalPCJ is not provided,
In one example, for the PCell or the PSCell, upon request from higher layers, the UE could provide to higher layers the periodic CSI-RS configuration indexes and/or SS/PBCH block indexes from the set q̅₁ as specified/defined herein in the present disclosure and the corresponding L1-RSRP measurements that are larger than or equal to the Q_{in,LR} threshold. For the SCell, upon request from higher layers, the UE could indicate to higher layers whether there is at least one periodic CSI-RS configuration index or SS/PBCH block index from the set q̅₁ with corresponding L1-RSRP measurements that are larger than or equal to the Q_{in,LR} threshold, and provide the periodic CSI-RS configuration indexes and/or SS/PBCH block indexes from the set q̅₁ and the corresponding L1-RSRP measurements that are larger than or equal to the Q_{in,LR} threshold, if any.
In another example, for the PCell or the PSCell, upon request from higher layers, the UE could provide to higher layers the periodic CSI-RS configuration indexes and/or SS/PBCH block indexes specific to the first TCI-State TCI-UL-State from the set q̅₁ or the periodic CSI-RS configuration indexes and/or SS/PBCH block indexes from the set q̅_{1,0} and the corresponding L1-RSRP measurements that are larger than or equal to the Q_{in,LR} threshold, and/or the periodic CSI-RS configuration indexes and/or SS/PBCH block indexes specific to the second TCI-State TCI-UL-State from the set q̅₁ or the periodic CSI-RS configuration indexes and/or SS/PBCH block indexes from the set q̅_{1,1} and the corresponding L1-RSRP measurements that are larger than or equal to the Q_{in,LR} threshold. For the SCell, upon request from higher layers, the UE could indicate to higher layers whether there is at least one periodic CSI-RS configuration index or SS/PBCH block index specific to the first TCI-State TCI-UL-State from the set q̅₁ or whether there is at least one periodic CSI-RS configuration index or SS/PBCH block index from the set q̅_{1,0} with corresponding L1-RSRP measurements that are larger than or equal to the Q_{in,LR} threshold, and provide the periodic CSI-RS configuration indexes and/or SS/PBCH block indexes specific to the first TCI-State TCI-UL-State from the set q̅₁ or the periodic CSI-RS configuration indexes and/or SS/PBCH block indexes from the set q̅_{1,0} and the corresponding L1-RSRP measurements that are larger than or equal to the Q_{in,LR} threshold, if any, and/or whether there is at least one periodic CSI-RS configuration index or SS/PBCH block index specific to the second TCI-State TCI-UL-State from the set q̅₁ or whether there is at least one periodic CSI-RS configuration index or SS/PBCH block index from the set q̅_{1,1} with corresponding L1-RSRP measurements that are larger than or equal to the Q_{in,LR} threshold, and provide the periodic CSI-RS configuration indexes and/or SS/PBCH block indexes specific to the second TCI-State TCI-UL-State from the set q̅₁ or the periodic CSI-RS configuration indexes and/or SS/PBCH block indexes from the set q̅q_{1,1} and the corresponding L1-RSRP measurements that are larger than or equal to the Q_{in,LR} threshold, if any.

In one embodiment, if a UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or if the UE is provided dl-OrJointTC-StateList or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network (e.g. the network 130) a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the TCI-State(s)/TCI-UL-State(s) specific to the first and/or second CORESET(s) following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the TCI-State(s)/TCI-UL-State(s) specific to the first and/or second CORESET(s) following those specified herein in the present disclosure, and/or if SSB-MTC-AdditionalPCI is not provided,
In one example, for the PCell or the PSCell, upon request from higher layers, the UE could provide to higher layers the periodic CSI-RS configuration indexes and/or SS/PBCH block indexes from the set q̅₁ as specified/defined herein in the present disclosure and the corresponding L1-RSRP measurements that are larger than or equal to the Q_{in,LR} threshold. For the SCell, upon request from higher layers, the UE could indicate to higher layers whether there is at least one periodic CSI-RS configuration index or SS/PBCH block index from the set q̅₁ with corresponding L1-RSRP measurements that are larger than or equal to the Q_{in,LR} threshold, and provide the periodic CSI-RS configuration indexes and/or SS/PBCH block indexes from the set q̅₁ and the corresponding L1-RSRP measurements that are larger than or equal to the Q_{in,LR} threshold, if any.
In another example, for the PCell or the PSCell, upon request from higher layers, the UE could provide to higher layers the periodic CSI-RS configuration indexes and/or SS/PBCH block indexes specific to the first CORESETs or the TCI-State TCI-UL-State specific to the first CORESETs from the set q̅₁ or the periodic CSI-RS configuration indexes and/or SS/PBCH block indexes from the set q̅_{1,0} and the corresponding L1-RSRP measurements that are larger than or equal to the Q_{in,LR} threshold, and/or the periodic CSI-RS configuration indexes and/or SS/PBCH block indexes specific to the second CORESETs or the TCI-State TCI-UL-State specific to the second CORESETs from the set q̅₁ or the periodic CSI-RS configuration indexes and/or SS/PBCH block indexes from the set q̅_{1,1} and the corresponding L1-RSRP measurements that are larger than or equal to the Q_{in,LR} threshold. For the SCell, upon request from higher layers, the UE could indicate to higher layers whether there is at least one periodic CSI-RS configuration index or SS/PBCH block index specific to the first CORESETs or the TCI-State TCI-UL-State specific to the first CORESTs from the set q̅₁ or whether there is at least one periodic CSI-RS configuration index or SS/PBCH block index from the set q̅_{1,0} with corresponding L1-RSRP measurements that are larger than or equal to the Q_{in,LR} threshold, and provide the periodic CSI-RS configuration indexes and/or SS/PBCH block indexes specific to the first CORESETs or the TCI-State TCI-UL-State specific to the first CORESETs from the set q̅₁ or the periodic CSI-RS configuration indexes and/or SS/PBCH block indexes from the set q̅_{1,0} and the corresponding L1-RSRP measurements that are larger than or equal to the Q_{in,LR} threshold, if any, and/or whether there is at least one periodic CSI-RS configuration index or SS/PBCH block index specific to the second CORESETs or the TCI-State TCI-UL-State specific to the second CORESETs from the set q̅₁ or whether there is at least one periodic CSI-RS configuration index or SS/PBCH block index from the set q̅_{1,1} with corresponding L1-RSRP measurements that are larger than or equal to the Q_{in,LR} threshold, and provide the periodic CSI-RS configuration indexes and/or SS/PBCH block indexes specific to the second CORESETs or the TCI-State TCI-UL-State specific to the second CORESETs from the set q̅₁ or the periodic CSI-RS configuration indexes and/or SS/PBCH block indexes from the set q̅_{1,1} and the corresponding L1-RSRP measurements that are larger than or equal to the Q_{in,LR} threshold, if any.

In one embodiment, if a UE is provided dl-OrJointTCI-StateList or TCI-UL-State and is indicated a first TCI-State or TCI-UL-State and a second TCI-State or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is not provided/configured/associated with BFD RS set(s) q̅_{0,0} and/or q̅_{0,1} and/or NBI RS set(s) q̅_{1,0} and/or q_{1,1} for a BWP of the serving cell, and/or if the UE is not expected/configured to determine BFD RS set(s) q̅_{0,0} and/or q̅_{0,1} according to the first TCI-State/TCI-UL-State and/or the second TCI-State/TCI-UL-State following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the first TCI-State/TCI-UL-State and/or the second TCI-State/TCI-UL-State following those specified herein in the present disclosure, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if SSB-MTC-AdditionalPCJ is not provided, the higher layers in the UE could increment the beam failure instance (BFI) count (e.g., by one) in a BFI counter BFI_COUNTER if the higher layers receive from the physical layer in the UE that the radio link quality assessed according to the set q̅₀ of resource configurations—as specified/defined herein in the present disclosure—is worse than the threshold Q_{out,LR}. The UE (e.g. the UE 116) could declare a beam failure for the set q̅₀ as specified/defined herein in the present disclosure if the BFI count in the BFI counter reaches the maximum number of BFI counts (e.g., provided by the higher layer parameter maxBFIcount) before a BFD timer expires. After the higher layers in the UE declare beam failure for the set q̅₀ as specified/defined herein in the present disclosure, the higher layers in the UE would reset the BFI count in the BFI counter BFI_COUNTER and/or the BFD timer to zero.

In one embodiment, if a UE is provided dl-OrJointTCI-StateList or TCI-UL-State and is indicated a first TCI-State or TCI-UL-State and a second TCI-State or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is not provided/configured/associated with BFD RS set(s) q̅_{0,0} and/or q̅_{0,1} and/or NBI RS set(s) q̅_{1,0} and/or q_{1,1} for a BWP of the serving cell, and/or if the UE is not expected/configured to determine BFD RS set(s) q̅_{0,0} and/or q̅_{0,1} according to the first TCI-State/TCI-UL-State and/or the second TCI-State/TCI-UL-State following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the first TCI-State/TCI-UL-State and/or the second TCI-State/TCI-UL-State following those specified herein in the present disclosure, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if SSB-MTC-AdditionalPCJ is not provided, the higher layers in the UE could increment the beam failure instance (BFI) count (e.g., by one) in a BFI counter BFI_COUNTER_0 if the higher layers receive from the physical layer in the UE that the first radio link quality assessed according to the RSs in the set q̅₀ of resource configurations that are specific to the first TCI-State TCI-UL-State or according to the RSs in the set q̅_{0,0} of resource configurations is worse than the threshold Q_{out,LR}. The UE could declare a beam failure for the RSs specific to the first TCI-State TCI-UL-State in the set q̅₀ or for the RSs in the set q̅_{0,0} if the BFI count in the BFI counter BFI_COUNTER_0 reaches the maximum number of BFI counts (e.g., provided by the higher layer parameter maxBFIcount) before a BFD timer specific to the BFI counter BFI_COUNTER_0 expires. After the higher layers in the UE declare beam failure for the RSs specific to the first TCI-State TCI-UL-State in the set q̅₀ or for the RSs in the set q̅_{0,0}, the higher layers in the UE would reset the BFI count in the BFI counter BFI_COUNTER_0 and/or the BFD timer specific to the BFI counter BFI_COUNTER_0 to zero. And/or, the higher layers in the UE could increment the beam failure instance (BFI) count (e.g., by one) in a BFI counter BFI_COUNTER_1 if the higher layers receive from the physical layer in the UE that the second radio link quality assessed according to the RSs in the set q̅₀ of resource configurations that are specific to the second TCI-State TCI-UL-State or according to the RSs in the set q̅_{0,1} of resource configurations is worse than the threshold Q_{out,LR}. The UE could declare a beam failure for the RSs specific to the second TCI-State TCI-UL-State in the set q̅₀ or for the RSs in the set q̅_{0,1} if the BFI count in the BFI counter BFI_COUNTER_1 reaches the maximum number of BFI counts (e.g., provided by the higher layer parameter maxBFIcount) before a BFD timer specific to the BFI counter BFI_COUNTER_1 expires. After the higher layers in the UE declare beam failure for the RSs specific to the second TCI-State TCI-UL-State in the set q̅₀ or for the RSs in the set q̅_{0,1}, the higher layers in the UE would reset the BFI count in the BFI counter BFI_COUNTER_1 and/or the BFD timer specific to the BFI counter BFI_COUNTER_1 to zero. For this case, according to those specified herein in the present disclosure, when/if the serving cell is associated/configured with a single set q̅₀ of resource configurations, and the set q̅₀ (of resource configurations) contains/includes/provides/comprises (1) RSs that are specific to the first TCI-State TCI-UL-State or RSs in the set q̅_{0,0} of resource configurations, and (2) RSs that are specific to the second TCI-State TCI-UL-State or RSs in the set q̅_{0,1} of resource configurations—e.g., when the higher layer RRC configuration applyIndicatedTC/State (or the first indicator as specified herein in the present disclosure) provided to the corresponding CORESET(s) is set to ‘both’, when/if beam failure(s)/BFR(s) is declared or triggered for both (1) RSs that are specific to the first TCI-State TCI-UL-State or RSs in the set q̅_{0,0} of resource configurations, and (2) RSs that are specific to the second TCI-State TCI-UL-State or RSs in the set q̅_{0,1} of resource configurations, in the set q̅₀ of resource configurations of at least the SpCell, according to/based on those specified herein in the present disclosure, and the beam failure recovery procedure as specified herein in the present disclosure is not successfully completed for any of the (1) RSs that are specific to the first TCI-State TCI-UL-State or RSs in the set q̅_{0,0} of resource configurations, and/or (2) RSs that are specific to the second TCI-State TCI-UL-State or RSs in the set q̅_{0,1} of resource configurations, in the set q̅₀ of resource configurations, the MAC entity could for each serving cell configured for beam failure detection initiate a random access procedure (following those specified in clause 5.1 TS 38.321) on at least the SpCell.

In one embodiment, if a UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or if the UE is provided dl-OrJointTCI-StateList or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE/serving cell is not provided/configured/associated with BFD RS set(s) q̅_{0,0} and/or q̅_{0,1} and/or NBI RS set(s) q̅_{1,0} and/or q̅q_{1,1} for a BWP of the serving cell, and/or if the UE is not expected/configured to determine BFD RS set(s) q̅_{0,0} and/or q̅_{0,1} according to the TCI-State(s)/TCI-UL-State(s) specific to the first and/or second CORESET(s) following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the TCI-State(s)/TCI-UL-State(s) specific to the first and/or second CORESET(s) following those specified herein in the present disclosure, and/or if SSB-MTC-AdditionalPCI is not provided, the higher layers in the UE could increment the beam failure instance (BFI) count (e.g., by one) in a BFI counter BFI_COUNTER if the higher layers receive from the physical layer in the UE that the radio link quality assessed according to the set q̅₀ of resource configurations—as specified/defined herein in the present disclosure—is worse than the threshold Q_{out,LR}. The UE could declare a beam failure for the set q̅₀ as specified herein in the present disclosure if the BFI count in the BFI counter reaches the maximum number of BFI counts (e.g., provided by the higher layer parameter maxBFIcount) before a BFD timer expires. After the higher layers in the UE declare beam failure for the set q̅₀ as specified herein in the present disclosure, the higher layers in the UE would reset the BFI count in the BFI counter BFI_COUNTER and/or the BFD timer to zero.

In one embodiment, if a UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or if the UE is provided dl-OrJointTCI-StateList or TCI-UL-State and is indicated a first TCI-State or TCI-UL-State and a second TCI-State or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the TCI-State(s)/TCI-UL-State(s) specific to the first and/or second CORESET(s) following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the TCI-State(s)/TCI-UL-State(s) specific to the first and/or second CORESET(s) following those specified herein in the present disclosure, and/or if SSB-MTC-AdditionalPCI is not provided, the higher layers in the UE could increment the beam failure instance (BFI) count (e.g., by one) in a BFI counter BFI_COUNTER_0 if the higher layers receive from the physical layer in the UE that the first radio link quality assessed according to the RSs in the set q̅₀ of resource configurations that are specific to the first CORESETs or the TCI-State TCI-UL-State specific to the first CORESETs or according to the RSs in the set q̅_{0,0} of resource configurations is worse than the threshold Q_{out,LR}. The UE could declare a beam failure for the RSs specific to the first CORESETs or the TCI-State TCI-UL-State specific to the first CORESETs in the set q̅₀ or for the RSs in the set q̅_{0,0} if the BFI count in the BFI counter BFI_COUNTER_0 reaches the maximum number of BFI counts (e.g., provided by the higher layer parameter maxBFIcount) before a BFD timer specific to the BFI counter BFI_COUNTER_0 expires. After the higher layers in the UE declare beam failure for the RSs specific to the first CORESETs or the TCI-State TCI-UL-State specific to the first CORESETs in the set q̅₀ or for the RSs in the set q̅_{0,0}, the higher layers in the UE would reset the BFI count in the BFI counter BFI_COUNTER_0 and/or the BFD timer specific to the BFI counter BFI_COUNTER_0 to zero. And/or, the higher layers in the UE could increment the beam failure instance (BFI) count (e.g., by one) in a BFI counter BFI_COUNTER_1 if the higher layers receive from the physical layer in the UE that the second radio link quality assessed according to the RSs in the set q̅₀ of resource configurations that are specific to the second CORESETs or the TCI-State TCI-UL-State specific to the second CORESETs or according to the RSs in the set q̅_{0,1} of resource configurations is worse than the threshold Q_{out,LR}. The UE could declare a beam failure for the RSs specific to the second CORESETs or the TCI-State TCI-UL-State specific to the second CORESETs in the set q̅₀ or for the RSs in the set q̅_{0,1} if the BFI count in the BFI counter BFI_COUNTER_1 reaches the maximum number of BFI counts (e.g., provided by the higher layer parameter maxBFIcount) before a BFD timer specific to the BFI counter BFI_COUNTER_1 expires. After the higher layers in the UE declare beam failure for the RSs specific to the second CORESETs or the TCI-State TCI-UL-State specific to the second CORESETs in the set q̅₀ or for the RSs in the set q̅_{0,1}, the higher layers in the UE would reset the BFI count in the BFI counter BFI_COUNTER_1 and/or the BFD timer specific to the BFI counter BFI_COUNTER_1 to zero. For this case, according to those specified herein in the present disclosure, when/if the serving cell is associated/configured with a single set q̅₀ of resource configurations, and the set q̅₀ (of resource configurations) contains/includes/provides/comprises (1) RSs that are specific to the first CORESETs or the TCI-State TCI-UL-State specific to the first CORESETs or RSs in the set q̅_{0,0} of resource configurations, and (2) RSs that are specific to the second CORESETs or the TCI-State TCI-UL-State specific to the second CORESETs or RSs in the set q̅_{0,1} of resource configurations, when/if beam failure(s)/BFR(s) is declared or triggered for both (1) RSs that are specific to the first CORESETs or the TCI-State TCI-UL-State specific to the first CORESETs or RSs in the set q̅_{0,0} of resource configurations, and (2) RSs that are specific to the second CORESETs or the TCI-State TCI-UL-State specific to the second CORESETs or RSs in the set q̅_{0,1} of resource configurations, in the set q̅₀ of resource configurations of at least the SpCell, according to/based on those specified herein in the present disclosure, and the beam failure recovery procedure as specified herein in the present disclosure is not successfully completed for any of the (1) RSs that are specific to the first CORESETs or the TCI-State TCI-UL-State specific to the first CORESETs or RSs in the set q̅_{0,0} of resource configurations, and/or (2) RSs that are specific to the second CORESETs or the TCI-State TCI-UL-State specific to the second CORESETs or RSs in the set q̅_{0,1} of resource configurations, in the set q̅₀ of resource configurations, the MAC entity could for each serving cell configured for beam failure detection initiate a random access procedure (following those specified in clause 5.1 TS 38.321) on at least the SpCell.

In one embodiment, if a UE is provided dl-OrJointTCI-StateList or TCI-UL-State and is indicated a first TCI-State or TCI-UL-State and a second TCI-State or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the first TCI-State/TCI-UL-State and/or the second TCI-State/TCI-UL-State following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the first TCI-State/TCI-UL-State and/or the second TCI-State/TCI-UL-State following those specified herein in the present disclosure, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if SSB-MTC-AdditionalPCJ is not provided, the UE could be provided a configuration for PUCCH transmission with a link recovery request for the UE to transmit PUCCH, e.g., for the set q̅₀ as specified/defined herein in the present disclosure (e.g., corresponding to q̅_{0,0} or q̅_{0,1}, or containing/including/providing/comprising RSs specific to the first TCI-State/TCI-UL-State or the second TCI-State/TCI-UL-State). Optionally, if a UE is provided dl-OrJointTCI-StateList or TCI-UL-State and is indicated a first TCI-State or TCI-UL-State and a second TCI-State or TCI-UL-State, and/or if the UE does not report its capability of supporting TRP-specific BFR under unified TCI framework with unified TCI state(s), the UE could be provided by a first configuration for PUCCH transmission with a link recovery request (LRR) and, if the UE provides two LRRcapability, the UE could be provided by a second configuration for PUCCH transmission with a LRR. For this case, if the UE is provided only the first configuration, the UE transmits a PUCCH with LRR for either the first TCI-State/TCI-UL-State (and therefore, the RSs in the set q̅₀ and/or set q̅₁ that are specific to the first TCI-State/TCI-UL-State as specified herein in the present disclosure) or the set q̅_{0,0}, or the second TCI-State/TCI-UL-State (and therefore, the RSs in the set q̅₀ and/or set q̅₁ that are specific to the second TCI-State/TCI-UL-State as specified herein in the present disclosure) or the set q̅_{0,1}. If the UE is provided both the first and second configurations, the UE uses the first configuration to transmit a PUCCH with LRR associated with/specific to the first TCI-State/TCI-UL-State (and therefore, associated to the RSs in the set q̅₀ and/or set q̅₁ that are specific to the first TCI-State/TCI-UL-State as specified herein in the present disclosure) or the set q̅_{0,0}, and the second configuration to transmit a PUCCH with LRR associated with/specific to the second TCI-State/TCI-UL-State (and therefore, associated to the RSs in the set q̅₀ and/or set q̅₁ that are specific to the second TCI-State/TCI-UL-State as specified herein in the present disclosure) or the set q̅_{0,1}.

In one embodiment, if a UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or if the UE is provided dl-OrJointTC-StateList or TCI-UL-State, and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the TCI-State(s)/TCI-UL-State(s) specific to the first and/or second CORESET(s) following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the TCI-State(s)/TCI-UL-State(s) specific to the first and/or second CORESET(s) following those specified herein in the present disclosure, and/or if SSB-MTC-AdditionalPCI is not provided, the UE could be provided a configuration for PUCCH transmission with a link recovery request for the UE to transmit PUCCH, e.g., for the set q̅₀ as specified/defined herein in the present disclosure (e.g., corresponding to q̅_{0,0} or q̅_{0,1}, or containing/including/providing/comprising RSs specific to the first CORESETs or the TCI-State/TCI-UL-State specific to the first CORESETs or the second CORESETs or the TCI-State/TCI-UL-State specific to the second CORESETs). Optionally, if a UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or if the UE is provided dl-OrJointTC-StateList or TCI-UL-State, and/or if the UE does not report its capability of supporting TRP-specific BFR under unified TCI framework with unified TCI state(s), the UE could be provided by a first configuration for PUCCH transmission with a LRR and, if the UE provides two LRRcapability, the UE could be provided by a second configuration for PUCCH transmission with a LRR. For this case, if the UE is provided only the first configuration, the UE transmits a PUCCH with LRR for either the first CORESETs or the TCI-State/TCI-UL-State specific to the CORESETs (and therefore, the RSs in the set q̅₀ and/or set q̅₁ that are specific to the first CORESETs or the TCI-State/TCI-UL-State specific to the first CORESETs as specified herein in the present disclosure) or the set q̅_{0,0}, or the second CORESETs or the TCI-State/TCI-UL-State specific to the second CORESETs (and therefore, the RSs in the set q̅₀ and/or set q̅₁ that are specific to the second CORESETs or the TCI-State/TCI-UL-State specific to the second CORESETs as specified herein in the present disclosure) or the set q̅_{0,1}. If the UE is provided both the first and second configurations, the UE uses the first configuration to transmit a PUCCH with LRR associated with/specific to the first CORESETs or the TCI-State/TCI-UL-State specific to the first CORESETs (and therefore, associated to the RSs in the set q̅₀ and/or set q̅₁ that are specific to the first CORESETs or the TCI-State/TCI-UL-State specific to the first CORESETs as specified herein in the present disclosure) or the set q̅_{0,0}, and the second configuration to transmit a PUCCH with LRR associated with/specific to the second CORESETs or the TCI-State/TCI-UL-State specific to the second CORESETs (and therefore, associated to the RSs in the set q̅₀ and/or set q̅₁ that are specific to the second CORESETs or the TCI-State/TCI-UL-State specific to the second CORESETs as specified herein in the present disclosure) or the set q̅_{0,1}.

In one embodiment, for the PCell or the PSCell, when/if a UE is provided dl-OrJointTCI-StateList or TCI-UL-State and is indicated a first TCI-State or TCI-UL-State and a second TCI-State or TCI-UL-State, and/or when/if the UE does not report its capability of supporting TRP-specific BFR under unified TCI framework with unified TCI state(s), and/or if the UE is not configured/provided by the network (e.g. the network 130) a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is not provided/configured/associated with BFD RS set(s) q̅_{0,0} and/or q̅_{0,1} and/or NBI RS set(s) q̅_{1,0} and/or q̅q_{1,1} for a BWP of the serving cell, and/or if the UE is not expected/configured to determine BFD RS set(s) q̅_{0,0} and/or q̅_{0,1} according to the first TCI-State/TCI-UL-State and/or the second TCI-State/TCI-UL-State following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the first TCI-State/TCI-UL-State and/or the second TCI-State/TCI-UL-State following those specified herein in the present disclosure, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if SSB-MTC-AdditionalPCI is not provided, the UE could be provided a CORESET through a link to a search space set provided by recoverySearchSpaceId, for monitoring PDCCH in the CORESET. Furthermore, for this case, if the UE is provided recoverySearchSpaceId, the UE does not expect to be provided another search space set for monitoring PDCCH in the CORESET associated with the search space set provided by recoverySearchSpaceId.

In one embodiment, for the PCell or the PSCell, when/if a UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or when/if the UE is provided dl-OrJointTCU-StateList or TCI-UL-State, and/or when/if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the TCI-State(s)/TCI-UL-State(s) specific to the first and/or second CORESET(s) following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the TCI-State(s)/TCI-UL-State(s) specific to the first and/or second CORESET(s) following those specified herein in the present disclosure, and/or if SSB-MTC-AdditionalPCI is not provided, the UE could be provided a CORESET (e.g., a first CORESET or a second CORESET as specified herein in the present disclosure) through a link to a search space set provided by recoverySearchSpaceId, for monitoring PDCCH in the CORESET. Furthermore, for this case, if the UE is provided recoverySearchSpaceId, the UE does not expect to be provided another search space set for monitoring PDCCH in the CORESET (e.g., the first or the second CORESET) associated with the search space set provided by recoverySearchSpaceId.

In one embodiment, for the PCell or the PSCell, when/if a UE is provided dl-OrJointTCI-StateList or TCI-UL-State and is indicated a first TCI-State or TCI-UL-State and a second TCI-State or TCI-UL-State, and/or when/if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the first TCI-State/TCI-UL-State and/or the second TCI-State/TCI-UL-State following those specified herein in the present disclosure, and/or if the UE/serving cell is not provided/configured/associated with a single BFD RS set q̅₀ and/or a single NBI RS set q̅₁ for a BWP of the serving cell, and/or if the UE (e.g. the UE 116) is not expected/configured to determine a single BFD RS set q̅₀ according to the first TCI-State/TCI-UL-State and/or the second TCI-State/TCI-UL-State following those specified herein in the present disclosure, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if SSB-MTC-AdditionalPCJ is not provided, the UE can be provided, by PRACH-ResourceDedicatedBFR, a configuration for PRACH transmission. For PRACH transmission in slot n and according to antenna port quasi co-location parameters associated with periodic CSI-RS resource configuration or with SS/PBCH block associated with index q_{new} provided by higher layers, the UE could monitor PDCCH in a search space set provided by recoverySearchSpaceId for detection of a DCI format with CRC scrambled by C-RNTI or MCS-C-RNTI starting from slot n+4+2^{μ}·k_{mac}, where μ is the SCS configuration for the PRACH transmission and k_{mac} is a number of slots provided by K-Mac or k_{mac}=0 if K-Mac is not provided, within a window configured by BeamFailureRecoveryConfig. In this case, the UE could
monitor PDCCH(s) in a search space set provided by recoverySearchSpaceId, and receive PDSCH(s) corresponding to the PDCCH(s) and aperiodic CSI-RS resource(s) corresponding to the PDCCH(s), using the same antenna port quasi co-location parameters as the ones associated with a corresponding index q_{new} from the NBI RS set q̅₁—as specified/defined herein in the present disclosure or from q̅_{1,0}/q̅_{1,1}, if any, on the serving cell, and/or
monitor PDCCH(s) in a search space set provided by recoverySearchSpaceId that applies the first TCI-State and/or the second TCI-State, and receive PDSCH(s) corresponding to the PDCCH(s) and aperiodic CSI-RS resource(s) corresponding to the PDCCH(s) that apply the first TCI-State and/or the second TCI-State, using the same antenna port quasi co-location parameters as the ones associated with a corresponding index q_{new} from the NBI RS set q̅₁—as specified/defined herein in the present disclosure or from q̅_{1,0} and/or q̅_{1,1}, if any, one the serving cell, and/or
monitor PDCCH(s) in a search space set provided by recoverySearchSpaceId, and transmit PUSCH(s) corresponding to the PDCCH(s), PUCCH(s) corresponding to the PDCCH(s), and SRS(s) corresponding to the PDCCH(s) using the same antenna port quasi co-location parameters/same spatial domain filters as the ones corresponding to q_{new} from q̅₁—as specified/defined herein in the present disclosure or from q̅_{1,0}/q̅_{1,1}, if any, on the serving cell and using the following parameters for determination of a corresponding power
the RS index q_{d}=q_{new} from q̅₁ or from q̅_{1,0}/q_{1,1}, if any, for obtaining a corresponding downlink pathloss estimate for the serving cell
the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
the value of P_{O_UE_PUCCH}(qᵤ) and the PUCCH power control adjustment state l provided by p0AlphaSetforPUCCH associated with the smallest value of ul-powercontrolId for the serving cell
the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell and/or
monitor PDCCH(s) in a search space set provided by recoverySearchSpaceId that applies the first TCI-State and/or the second TCI-State, and transmit PUSCH(s) corresponding to the PDCCH(s), PUCCH(s) corresponding to the PDCCH(s), and SRS(s) corresponding to the PDCCH(s) that apply the first TCI-State or TCI-UL-State and/or the second TCI-State or TCI-UL-State using the same antenna port quasi co-location parameters/same spatial domain filters as the ones corresponding to q_{new} from q̅₁—as specified/defined herein in the present disclosure or from q̅_{1,0} and/or q̅_{1,1}, if any, on the serving cell and using the following parameters for determination of a corresponding power
the RS index q_{d}=q_{new} from q̅₁ or from q̅_{1,0} and/or q̅_{1,1}, if any, for obtaining a corresponding downlink pathloss estimate for the serving cell
the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
the value of P_{O_UE_PUCCH}(qᵤ) and the PUCCH power control adjustment state l provided by p0AlphaSetforPUCCH associated with the smallest value of ul-powercontrolId for the serving cell
the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell until the UE receives by higher layers a configuration of at least a TCI state (e.g., via RRC signalling(s)/parameter(s) dl-OrJointTCI-StateList or TCI-UL-State) and/or an activation for a TCI state (e.g., via a MAC CE activation command) and/or an indication of a TCI state (e.g., via beam indication DCI—DCI format 1_1/1_2 with or without DL assignment) or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, the UE could continue to monitor PDCCH candidates in the search space set provided by recoverySearchSpaceId until the UE receives by higher layers a configuration of at least a TCI state (e.g., via RRC signalling(s)/parameter(s) dl-OrJointTCI-StateList or TCI-UL-State) and/or an activation for a TCI state (e.g., via a MAC CE activation command) and/or an indication of a TCI state (e.g., via beam indication DCI—DCI format 1_1/1_2 with or without DL assignment) or tci-StatesPDCCH-ToAddList and/or tci-StatesPDCCH-ToReleaseList.

In one embodiment, for the PCell or the PSCell, when/if a UE is provided two coresetPoolIndex values 0 and 1 for first and second CORESETs, or is not provided coresetPoolIndex value for the first CORESETs and is provided coresetPoolIndex value of 1 for the second CORESETs, respectively, and/or when/if a UE is provided dl-OrJointTCI-StateList or TCI-UL-State, and/or when/if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,0} according to the TCI-State(s)/TCI-UL-State(s) specific to the first and/or second CORESET(s) following those specified herein in the present disclosure, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the TCI-State(s)/TCI-UL-State(s) specific to the first and/or second CORESET(s) following those specified herein in the present disclosure, and/or if SSB-MTC-AdditionalPCI is not provided, the UE can be provided, by PRACH-ResourceDedicatedBFR, a configuration for PRACH transmission. For PRACH transmission in slot n and according to antenna port quasi co-location parameters associated with periodic CSI-RS resource configuration or with SS/PBCH block associated with index q_{new} provided by higher layers, the UE could monitor PDCCH in a search space set provided by recoverySearchSpaceId for detection of a DCI format with CRC scrambled by C-RNTI or MCS-C-RNTI starting from slot n+4+2μ·k_{mac}, where μ is the SCS configuration for the PRACH transmission and k_{mac} is a number of slots provided by K-Mac or k_{mac}=0 if K-Mac is not provided, within a window configured by BeamFailureRecoveryConfig. In this case, the UE could
monitor PDCCH(s) in a search space set provided by recoverySearchSpaceId, and receive PDSCH(s) corresponding to the PDCCH(s) and aperiodic CSI-RS resource(s) corresponding to the PDCCH(s), using the same antenna port quasi co-location parameters as the ones associated with a corresponding index q_{new} from the NBI RS set q̅₁—as specified/defined herein in the present disclosure or from q̅_{1,0}/q̅_{1,1}, if any, on the serving cell, and/or
monitor PDCCH(s) specific to the first and/or second CORESETs in a search space set provided by recoverySearchSpaceId, and receive PDSCH(s) corresponding to the PDCCH(s) and aperiodic CSI-RS resource(s) corresponding to the PDCCH(s) that are specific to the first and/or second CORESETs, using the same antenna port quasi co-location parameters as the ones associated with a corresponding index q_{new} from the NBI RS set q̅₁—as specified/defined herein in the present disclosure or from q̅_{1,0} and/or q̅_{1,1}, if any, one the serving cell, and/or
monitor PDCCH(s) in a search space set provided by recoverySearchSpaceId, and transmit PUSCH(s) corresponding to the PDCCH(s), PUCCH(s) corresponding to the PDCCH(s), and SRS(s) corresponding to the PDCCH(s) using the same antenna port quasi co-location parameters/same spatial domain filters as the ones corresponding to q_{new} from q̅₁—as specified/defined herein in the present disclosure or from q̅_{1,0}/q̅_{1,1}, if any, on the serving cell and using the following parameters for determination of a corresponding power
the RS index q_{d}=q_{new} from q̅₁ or from q̅_{1,0}/q̅_{1,1}, if any, for obtaining a corresponding downlink pathloss estimate for the serving cell
the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell
the value of P_{O_UE_PUCCH}(qᵤ) and the PUCCH power control adjustment state l provided by p0AlphaSetforPUCCH associated with the smallest value of ul-powercontrolId for the serving cell
the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell
   and/or
monitor PDCCH(s) specific to the first and/or second CORESETs in a search space set provided by recoverySearchSpaceId, and transmit PUSCH(s) corresponding to the PDCCH(s), PUCCH(s) corresponding to the PDCCH(s), and SRS(s) corresponding to the PDCCH(s) that are specific to the first and/or second CORESETs using the same antenna port quasi co-location parameters/same spatial domain filters as the ones corresponding to q_{new} from q̅₁—as specified/defined herein in the present disclosure or from q̅_{1,0} and/or q̅_{1,1}, if any, on the serving cell and using the following parameters for determination of a corresponding power
the RS index q_{d}=q_{new} from q̅₁ or from q̅_{1,0} and/or q̅_{1,1}, if any, for obtaining a corresponding downlink pathloss estimate for the serving cell
the values of P_{O_UE_PUSCH,b,f,c}(j), α_{b,f,c}(W, and the PUSCH power control adjustment state l provided by p0AlphaSetforPUSCH associated with the smallest value of ul-powercontrolId for the serving cell
the value of P_{O_UE_PUCCH}(qᵤ) and the PUCCH power control adjustment state l provided by p0AlphaSetforPUCCH associated with the smallest value of ul-powercontrolId for the serving cell
the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell
   until the UE receives by higher layers a configuration of at least a TCI state (e.g., via RRC signalling(s)/parameter(s) dl-OrJointTCI-StateList or TCI-UL-State) and/or an activation for a TCI state (e.g., via a MAC CE activation command) and/or an indication of a TCI state (e.g., via beam indication DCI—DCI format 1_1/1_2 with or without DL assignment) or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, the UE could continue to monitor PDCCH candidates in the search space set provided by recoverySearchSpaceId until the UE receives by higher layers a configuration of at least a TCI state (e.g., via RRC signalling(s)/parameter(s) dl-OrJointTCI-StateList or TCI-UL-State) and/or an activation for a TCI state (e.g., via a MAC CE activation command) and/or an indication of a TCI state (e.g., via beam indication DCI—DCI format 1_1/1_2 with or without DL assignment) or tci-StatesPDCCH-ToAddList and/or tci-StatesPDCCH-ToReleaseList.

In one embodiment, if a UE is provided dl-OrJointTCI-StateList or TCI-UL-State or ul-TCI-StateList and is indicated a first TCI-State or TCI-UL-State and a second TCI-State or TCI-UL-State (e.g., for a PCell and/or a PSCell and/or a SCell), and/or if the UE reports its capability of supporting TRP-specific BFR under unified TCI framework with unified TCI state(s), and/or if the UE is configured/provided by the network (e.g. the network 130) a higher layer parameter perTRP-BFR, e.g., set to ‘enabled’, the UE/serving cell could be provided/configured/associated a first BFD RS set and a first NBI RS set q̅_{0,0} and q̅_{1,0}, and with a second BFD RS set and a second NBI RS set q̅_{0,1} and q̅_{1,1}, and/or the UE could determine the first BFD RS set q̅_{0,0} and/or the second BFD RS set q̅_{0,1} according to the first TCI-State/TCI-UL-State and/or the second TCI-State/TCI-UL-State following those specified herein in the present disclosure. In this case, when/if the first BFD RS set and/or the second BFD RS set (and therefore, the BFD RS resources provided/configured/indicated/determined/identified therein) is/are having radio link quality worse than Q_{out,LR}, (a) after 28 symbols from a last symbol of a PDCCH reception with a DCI format scheduling a PUSCH transmission with a same HARQ process number as for the transmission of the PUSCH and having a toggled NDI field value, and/or (b) after 28 symbols from a last symbol of a PDCCH reception in a search space set provided by recoverySearchSpaceId where the UE detects a DCI format with CRC scrambled by C-RNTI or MCS-C-RNTI, and/or (c) after 28 symbols from the last symbol of the PDCCH reception that determines the completion of the contention based random access procedure (e.g., when/if the UE provides BFR MAC CE in Msg3 or MsgA of contention based random access procedure), the UE
monitors PDCCH that applies the first TCI-State, and receives PDSCH and aperiodic CSI-RS resource that apply the first TCI-State, on the serving cell/PCell/PSCell/SCell using same antenna port quasi co-location parameters as the ones associated with a corresponding index q_{new} from q̅_{1,0}, if any, on the serving cell and/or PCell and/or PSCell and/or SCell
monitors PDCCH that applies the second TCI-State, and receives PDSCH and aperiodic CSI-RS resource that apply the second TCI-State, on the serving cell/PCell/PSCell/SCell using same antenna port quasi co-location parameters as the ones associated with a corresponding index q_{new} from q̅_{1,1}, if any, on the serving cell and/or PCell and/or PSCell and/or SCell
transmits PUSCH, PUCCH, and SRS that apply the first TCI-State or TCI-UL-State using a same spatial domain filter as the one corresponding to q_{new} from q̅_{1,0}, if any, or using a same spatial domain filter as for the last PRACH transmission (e.g., specific to the first TCI-State or TCI-UL-State), on the serving cell/PCell/PSCell/SCell and using the following parameters for determination of a corresponding power
the RS index q_{d}=q_{new} from q̅_{1,0}, if any, for obtaining a corresponding downlink pathloss estimate for the serving cell/PCell/PSCell/SCell
the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell/PCell/PSCell/SCell
the value of P_{O_UE_PUCCH}(qᵤ) and the PUCCH power control adjustment state l provided by p0AlphaSetforPUCCH associated with the smallest value of ul-powercontrolId for the serving cell/PCell/PSCell/SCell
the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell/PCell/PSCell/SCell
transmits PUSCH, PUCCH, and SRS that apply the second TCI-State or TCI-UL-State using a same spatial domain filter as the one corresponding to q_{new} from q̅_{1,1}, if any, or using a same spatial domain filter as for the last PRACH transmission (e.g., specific to the second TCI-State or TCI-UL-State), on the serving cell/PCell/PSCell/SCell and using the following parameters for determination of a corresponding power
the RS index q_{d}=q_{new} from q̅_{1,1}, if any, for obtaining a corresponding downlink pathloss estimate for the serving cell/PCell/PSCell/SCell
the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell/PCell/PSCell/SCell
the value of P_{O_UE_PUCCH}(qᵤ) and the PUCCH power control adjustment state l provided by p0AlphaSetforPUCCH associated with the smallest value of ul-powercontrolId for the serving cell/PCell/PSCell/SCell
the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell/PCell/PSCell/SCell where the SCS configuration for the 28 symbols is the smallest of the SCS configurations of the active DL BWP for the PDCCH reception and of the active DL BWP(s) of the serving cells.

In one embodiment, if a UE is provided dl-OrJointTCI-StateList or TCI-UL-State or ul-TCI-StateList and is indicated a first TCI-State or TCI-UL-State and a second TCI-State or TCI-UL-State (e.g., for a PCell and/or a PSCell and/or a SCell), and/or if the UE does not report its capability of supporting TRP-specific BFR under unified TCI framework with unified TCI state(s), and/or if the UE is not configured/provided by the network a higher layer parameter perTRP-BFR, e.g., set to ‘enabled’, and/or if the UE is configured/provided by the network a higher layer parameter perTRP-BFR set to ‘disabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the first TCI-State/TCI-UL-State and/or the second TCI-State/TCI-UL-State following those specified herein in the present disclosure, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if SSB-MTC-AdditionalPCI is not provided, the UE/serving cell could be provided/configured/associated with a single BFD RS set q̅₀ and/or with a single NBI RS set q̅₁ and/or the UE could determine a single BFD RS set q̅₀ according to the first TCI-State/TCI-UL-State and/or the second TCI-State/TCI-UL-State following those specified herein in the present disclosure (other than two BFD RS sets q̅_{0,0} and q̅_{0,1} and two NBI RS sets q̅₀ and q̅q_{1,1} when/if the UE reports its capability of supporting TRP-specific BFR under unified TCI framework with unified TCI state(s)). In this case, when the BFD RS set q₀ (and therefore, the BFD RS resource(s) provided/configured/indicated/determined/identified therein) is having radio link quality worse than Q_{out,LR}, (a) after 28 symbols from a last symbol of a PDCCH reception with a DCI format scheduling a PUSCH transmission with a same HARQ process number as for the transmission of the PUSCH and having a toggled NDI field value, and/or (b) after 28 symbols from a last symbol of a PDCCH reception in a search space set provided by recoverySearchSpaceId where the UE detects a DCI format with CRC scrambled by C-RNTI or MCS-C-RNTI, and/or (c) after 28 symbols from the last symbol of the PDCCH reception that determines the completion of the contention based random access procedure (e.g., when/if the UE provides BFR MAC CE in Msg3 or MsgA of contention based random access procedure), the UE (e.g. the UE 116) could
for (a), (b) and/or (c) as defined/specified herein, monitor PDCCHs and/or PDCCH(s) in CORESETs and/or PDCCH(s) in the CORESET(s) with the higher layer RRC configuration(s) applyIndicatedTCIState (or the first indicator as specified herein in the present disclosure) provided to the CORESET(s) set to ‘first’, ‘second’ or ‘both’—i.e., not set to ‘none’, e.g., on the SCell(s) indicated by the corresponding MAC CE (for at least (a) as defined/specified herein), and receive PDSCHs and/or PDSCH(s) scheduled/activated by the PDCCH(s) defined/specified herein in the present disclosure and aperiodic CSI-RS resources and/or aperiodic CSI-RS resource in a CSI resource set with the higher layer RRC configuration(s) applyIndicatedTCIState provided to the aperiodic CSI-RS resource/CSI resource set to ‘first’ or ‘second’ and/or aperiodic CSI-RS resource in a CSI resource set with the same indicated TCI state as for the PDCCH(s) and/or PDSCH(s) defined/specified herein in the present disclosure (e.g., the higher layer RRC configuration(s) applyIndicatedTCIState provided to the aperiodic CSI-RS resource/CSI resource set could be set to the same value—e.g., ‘first’ or ‘second’—as that of the higher layer RRC configuration(s) applyIndicatedTCIState (or the first indicator as specified herein in the present disclosure) provided to the CORESET(s)), using the same antenna port quasi co-location parameters as the ones associated with a/the corresponding index q_{new} from the NBI RS set q̅₁, if any, (e.g., on the serving cell or the PCell or the PSCell or the SCell), and/or
for (a), (b) and/or (c) as defined/specified herein, monitor PDCCH(s) that applies the first TCI-State and/or the second TCI-State, e.g., on the SCell(s) indicated by the corresponding MAC CE (for at least (a) as defined/specified herein), and receive PDSCH(s) and aperiodic CSI-RS resource(s) that apply the first TCI-State and/or the second TCI-State (i.e., the aperiodic CSI-RS resource(s) could apply the same first/second TCI-State as that for the PDCCH(s) and/or PDSCH(s) defined/specified herein in the present disclosure), using the same antenna port quasi co-location parameters as the ones associated with a corresponding index q_{new} from the NBI RS set q̅₁, if any, (e.g., one the serving cell or the PCell or the PSCell or the SCell), and/or
for at least (b) and (c) as defined/specified herein, transmit PUSCHs and/or PUSCH(s) scheduled/activated by the PDCCH(s) defined/specified herein in the present disclosure, PUCCHs and/or PUCCH(s) with the higher layer RRC configuration(s) applyIndicatedTCIState provided to the corresponding PUCCH resource(s)/PUCCH resource group set to ‘first’ or ‘second’ or ‘both’ and/or SRSs and/or SRS(s) in the first and/or second SRS resource set(s) and/or SRS(s) that uses a same spatial domain filter with same indicated TCI state as for the PUCCH(s) and/or PUSCH(s) defined/specified herein in the present disclosure, using a same spatial domain filter as for the last PRACH transmission using the following parameters for determination of a corresponding power
   the RS index q_{d}=q_{new} from q̅₁, if any, for obtaining a corresponding downlink pathloss estimate for at least the PCell or the PSCell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for at least the PCell or the PSCell
   the value of P_{O_UE_PUCCH}(qᵤ) and the PUCCH power control adjustment state l provided by p0AlphaSetforPUCCH associated with the smallest value of ul-powercontrolId for at least the PCell or the PSCell
   the values of P_{O_UE_SRS,b,f,c}(qₛ) α_{SRS,b,f,c}(qₛ), and the SRS power control adjustment state l provided by p0AlphaSetforSRS associated with the smallest value of ul-powercontrolId for at least the PCell or the PSCell and/or
for at least (a) as defined/specified herein, transmit PUSCHs and/or PUSCH(s) scheduled/activated by the PDCCH(s) defined/specified herein in the present disclosure, PUCCHs and/or PUCCH(s) with the higher layer RRC configuration(s) applyIndicatedTCIState provided to the corresponding PUCCH resource(s)/PUCCH resource group set to ‘first’ or ‘second’ or ‘both’ and/or SRSs and/or SRS(s) in the first and/or second SRS resource set(s) and/or SRS(s) that uses a same spatial domain filter with same indicated TCI state as for the PUCCH(s) and/or PUSCH(s) defined/specified herein in the present disclosure, using a same spatial domain filter as the one corresponding to q_{new} from q̅₁, if any, (e.g., on at least the serving cell or the SCell) and using the following parameters for determination of a corresponding power
the RS index q_{d}=q_{new} from q̅₁, if any, for obtaining a corresponding downlink pathloss estimate for at least the SCell
the values of P_{O_UE_PUSCH,b,f,c}(j), α_{b,f,c}(j), and the PUSCH power control adjustment state l provided by p0AlphaSetforPUSCH associated with the smallest value of ul-powercontrolId for at least the SCell
the value of P_{O_UE_PUCCH}(qᵤ) and the PUCCH power control adjustment state l provided by p0AlphaSetforPUCCH associated with the smallest value of ul-powercontrolId for at least the SCell
the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for at least the SCell and/or
for at least (b) and (c) as defined/specified herein, transmit PUSCH, PUCCH, and SRS that apply the first TCI-State or TCI-UL-State and/or the second TCI-State or TCI-UL-State (i.e., the SRS could use a same spatial domain filter with same indicated first/second TCI-State/TCI-UL-State as for the PUCCH(s) and/or PUSCH(s) defined/specified herein in the present disclosure) using a same spatial domain filter as for the last PRACH transmission using the following parameters for determination of a corresponding power
   the RS index q=q_{new} from q̅₁, if any, for obtaining a corresponding downlink pathloss estimate for at least the PCell or the PSCell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for at least the PCell or the PSCell
   the value of P_{O_UE_PUCCH}(qᵤ) and the PUCCH power control adjustment state l provided by p0AlphaSetforPUCCH associated with the smallest value of ul-powercontrolId for at least the PCell or the PSCell
   the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for at least the PCell or the PSCell and/or
for at least (a) as defined/specified herein, transmit PUSCH, PUCCH, and SRS that apply the first TCI-State or TCI-UL-State and/or the second TCI-State or TCI-UL-State (i.e., the SRS could use a same spatial domain filter with same indicated first/second TCI-State TCI-UL-State as for the PUCCH(s) and/or PUSCH(s) defined/specified herein in the present disclosure) using a same spatial domain filter as the one corresponding to q_{new} from q̅₁, if any, (e.g., on at least the serving cell or the SCell) and using the following parameters for determination of a corresponding power
   the RS index q_{d}=q_{new} from q̅₁, if any, for obtaining a corresponding downlink pathloss estimate for at least the SCell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for at least the SCell
   the value of P_{O_UE_PUCCH}(qᵤ) and the PUCCH power control adjustment state l provided by p0AlphaSetforPUCCH associated with the smallest value of ul-powercontrolId for at least the SCell
   the values of P_{O_UE_SRS,b,f,c}(qₛ), α_{SRS,b,f,c}(s), and the SRS power control adjustment state l provided by p0AlphaSetforSRS associated with the smallest value of ul-powercontrolId for at least the SCell
      where the SCS configuration for the 28 symbols is the smallest of the SCS configurations of the active DL BWP for the PDCCH reception and of the active DL BWP(s) of the serving cells. For this case—i.e., after the specified beam resetting procedure herein has been completed,
In one example, the UE could expect to receive a first or third (unified) TCI state(s) activation/deactivation MAC CE command as specified herein in the present disclosure, and/or the UE could be expected to apply the TCI codepoints—when they become applicable—activated by/in a first or third (unified) TCI state(s) activation/deactivation MAC CE command as specified herein in the present disclosure, and/or the UE could be expected to apply TCI codepoint(s) from a first/third unified TCI state(s) activation/deactivation MAC CE command as specified herein in the present disclosure to the TCI field of DCI format 1_1/1_2. Or, the UE may not expect to receive a second or fourth (unified) TCI state(s) activation/deactivation MAC CE command as specified herein in the present disclosure, and/or the UE may not be expected to apply the TCI codepoints—when they become applicable—activated by/in a second or fourth (unified) TCI state(s) activation/deactivation MAC CE command as specified herein in the present disclosure, and/or the UE may not be expected to apply TCI codepoint(s) from a second/fourth unified TCI state(s) activation/deactivation MAC CE command as specified herein in the present disclosure to the TCI field of DCI format 1_1/1_2. For this case/design example, when/if the joint/DL/UL TCI state indicated by a TCI codepoint—from the first/third (unified) TCI state(s) activation/deactivation MAC CE command as specified herein in the present disclosure—has become applicable (e.g., after the corresponding beam application time),
   For example, the UE could apply the indicated joint/DL/UL TCI state to monitor PDCCHs, and receive PDSCHs and aperiodic CSI-RS resources, and/or to transmit PUSCHs, PUCCHs, and SRSs.
   For another example, the UE could apply the indicated joint/DL/UL TCI state to monitor PDCCH(s) that applies the first TCI-State and/or the second TCI-State, and receive PDSCH(s) and aperiodic CSI-RS resource(s) that apply the first TCI-State and/or the second TCI-State, and/or to transmit PUSCH, PUCCH, and SRS that apply the first TCI-State or TCI-UL-State and/or the second TCI-State or TCI-UL-State.
In another example, the UE could expect to receive a second or fourth (unified) TCI state(s) activation/deactivation MAC CE command as specified herein in the present disclosure, and/or the UE could be expected to apply the TCI codepoints—when they become applicable—activated by/in a second or fourth (unified) TCI state(s) activation/deactivation MAC CE command as specified herein in the present disclosure, and/or the UE could be expected to apply TCI codepoint(s) from a second or fourth unified TCI state(s) activation/deactivation MAC CE command as specified herein in the present disclosure to the TCI field of DCI format 1_1/1_2. Or, the UE may not expect to receive a first or third (unified) TCI state(s) activation/deactivation MAC CE command as specified herein in the present disclosure, and/or the UE may not be expected to apply the TCI codepoints—when they become applicable—activated by/in a first or third (unified) TCI state(s) activation/deactivation MAC CE command as specified herein in the present disclosure, and/or the UE may not be expected to apply TCI codepoint(s) from a first/third unified TCI state(s) activation/deactivation MAC CE command as specified herein in the present disclosure to the TCI field of DCI format 1_1/1_2. For this case/design example, when/if the joint/DL/UL TCI state(s) indicated by a TCI codepoint—from the second/fourth (unified) TCI state(s) activation/deactivation MAC CE command as specified herein in the present disclosure—has become applicable (e.g., after the corresponding beam application time),
For example, when/if the indicated joint/DL/UL TCI state(s) corresponds to a first TCI state,
   the UE could apply the indicated first joint/DL/UL TCI state to monitor PDCCHs, and receive PDSCHs and aperiodic CSI-RS resources, and/or to transmit PUSCHs, PUCCHs, and SRSs, and/or
   the UE could apply the indicated first joint/DL/UL TCI state to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or apply the TCI state corresponding to q_{new} from q̅₁ to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State.
For another example, when/if the indicated joint/DL/UL TCI state(s) corresponds to a second TCI state,
   the UE could apply the indicated second joint/DL/UL TCI state to monitor PDCCHs, and receive PDSCHs and aperiodic CSI-RS resources, and/or to transmit PUSCHs, PUCCHs, and SRSs, and/or
   the UE could apply the indicated second joint/DL/UL TCI state to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State, and/or apply the TCI state corresponding to q_{new} from q̅₁ to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State.
For another example, when/if the indicated joint/DL/UL TCI state(s) corresponds to a first TCI state and a second TCI state,
   the UE could apply the indicated first joint/DL/UL TCI state to monitor PDCCHs, and receive PDSCHs and aperiodic CSI-RS resources, and/or to transmit PUSCHs, PUCCHs, and SRSs, and/or
   the UE could apply the indicated first joint/DL/UL TCI state to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or apply the TCI state corresponding to q_{new} from q̅₁ to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State, and/or
   the UE could apply the indicated second joint/DL/UL TCI state to monitor PDCCHs, and receive PDSCHs and aperiodic CSI-RS resources, and/or to transmit PUSCHs, PUCCHs, and SRSs, and/or
   the UE could apply the indicated second joint/DL/UL TCI state to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State, and/or apply the TCI state corresponding to q_{new} from q̅₁ to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or
   the UE could apply the indicated first joint/DL/UL TCI state to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or apply the indicated second joint/DL/UL TCI state to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State.

In one embodiment, if a UE is provided dl-OrJointTCI-StateList or TCI-UL-State or ul-TCI-StateList and is indicated a first TCI-State or TCI-UL-State and a second TCI-State or TCI-UL-State (e.g., for a PCell and/or a PSCell and/or a SCell), and/or if the UE does not report its capability of supporting TRP-specific BFR under unified TCI framework with unified TCI state(s), and/or if the UE is not configured/provided by the network (e.g. the network 130) a higher layer parameter perTRP-BFR, e.g., set to ‘enabled’, and/or if the UE is configured/provided by the network a higher layer parameter perTRP-BFR set to ‘disabled’, and/or if the UE is not provided in PDCCH-Config two different values of coresetPoolIndex (e.g., 0 and 1) in CORESETs, and/or if the UE is not provided coresetPoolIndex value for the first CORESETs and is not provided coresetPoolIndex value for the second CORESETs, respectively, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the first TCI-State/TCI-UL-State and/or the second TCI-State/TCI-UL-State following those specified herein in the present disclosure, and/or when/if the TCI selection field (or the second indicator as specified herein in the present disclosure) is (configured to be) present or not (configured to be) present in DCI format 1_1/1_2—e.g., when/if the higher layer parameter tciSelection-PresentInDCI is configured/provided or not configured/provided, and/or if SSB-MTC-AdditionalPCJ is not provided, the UE/serving cell could be configured/associated a first BFD RS set and a first NBI RS set q̅_{0,0} and q̅_{1,0}, and with a second BFD RS set and a second NBI RS set q̅_{0,1} and q̅_{1,1}, and/or the UE (e.g. the UE 116) could determine the first BFD RS set q̅_{0,0} and/or the second BFD RS set q̅_{0,1} according to the first TCI-State/TCI-UL-State and/or the second TCI-State/TCI-UL-State following those specified herein in the present disclosure. In this case, when/if the first BFD RS set and/or the second BFD RS set (and therefore, the BFD RS resources provided/configured/indicated/determined/identified therein) is/are having radio link quality worse than Q_{out,LR}, (a) after 28 symbols from a last symbol of a PDCCH reception with a DCI format scheduling a PUSCH transmission with a same HARQ process number as for the transmission of the PUSCH and having a toggled NDI field value, and/or (b) after 28 symbols from a last symbol of a PDCCH reception in a search space set provided by recoverySearchSpaceId where the UE detects a DCI format with CRC scrambled by C-RNTI or MCS-C-RNTI, and/or (c) after 28 symbols from the last symbol of the PDCCH reception that determines the completion of the contention based random access procedure (e.g., when/if the UE provides BFR MAC CE in Msg3 or MsgA of contention based random access procedure), the UE could
for (a), (b) and/or (c) as defined/specified herein, monitor PDCCHs and/or PDCCH(s) in CORESETs and/or PDCCH(s) in the CORESET(s) with the higher layer RRC configuration(s) applyIndicatedTCIState (or the first indicator as specified herein in the present disclosure) provided to the CORESET(s) set to ‘first’, ‘second’ or ‘both’—i.e., not set to ‘none’, e.g., on the SCell(s) indicated by the corresponding MAC CE (for at least (a) as defined/specified herein), and receive PDSCHs and/or PDSCH(s) scheduled/activated by the PDCCH(s) defined/specified herein in the present disclosure and aperiodic CSI-RS resources and/or aperiodic CSI-RS resource in a CSI resource set with the higher layer RRC configuration(s) applyIndicatedTCIState provided to the aperiodic CSI-RS resource/CSI resource set to ‘first’ or ‘second’ and/or aperiodic CSI-RS resource in a CSI resource set with the same indicated TCI state as for the PDCCH(s) and/or PDSCH(s) defined/specified herein in the present disclosure (e.g., the higher layer RRC configuration(s) applyIndicatedTCIState provided to the aperiodic CSI-RS resource/CSI resource set could be set to the same value—e.g., ‘first’ or ‘second’—as that of the higher layer RRC configuration(s) applyIndicatedTCIState (or the first indicator as specified herein in the present disclosure) provided to the CORESET(s)), using the same antenna port quasi co-location parameters as the ones associated with a/the corresponding index q_{new} from a reference NBI RS set corresponding to the NBI RS set q̅_{1,0} or q̅_{1,1}, if any, (e.g., on the serving cell or the PCell or the PSCell or the SCell), and/or
for (a), (b) and/or (c) as defined/specified herein, monitor PDCCH(s) that applies the first TCI-State and/or the second TCI-State, e.g., on the SCell(s) indicated by the corresponding MAC CE (for at least (a) as defined/specified herein), and receive PDSCH(s) and aperiodic CSI-RS resource(s) that apply the first TCI-State and/or the second TCI-State (i.e., the aperiodic CSI-RS resource(s) could apply the same first/second TCI-State as that for the PDCCH(s) and/or PDSCH(s) defined/specified herein in the present disclosure), using the same antenna port quasi co-location parameters as the ones associated with a corresponding index q_{new} from a reference NBI RS set corresponding to the NBI RS set q̅_{1,0} or q̅_{1,1}, if any, (e.g., one the serving cell or the PCell or the PSCell or the SCell), and/or
for at least (b) and (c) as defined/specified herein, transmit PUSCHs and/or PUSCH(s) scheduled/activated by the PDCCH(s) defined/specified herein in the present disclosure, PUCCHs and/or PUCCH(s) with the higher layer RRC configuration(s) applyIndicatedTCIState provided to the corresponding PUCCH resource(s)/PUCCH resource group set to ‘first’ or ‘second’ or ‘both’ and/or SRSs and/or SRS(s) in the first and/or second SRS resource set(s) and/or SRS(s) that uses a same spatial domain filter with same indicated TCI state as for the PUCCH(s) and/or PUSCH(s) defined/specified herein in the present disclosure, using a same spatial domain filter as for the last PRACH transmission using the following parameters for determination of a corresponding power
   the RS index q_{d}=q_{new} from a reference NBI RS set corresponding to the NBI RS set q̅_{1,0} or q̅_{1,1}, if any, for obtaining a corresponding downlink pathloss estimate for at least the PCell or the PSCell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for at least the PCell or the PSCell
   the value of P_{O_UE_PUCCH}(qᵤ) and the PUCCH power control adjustment state l provided by p0AlphaSetforPUCCH associated with the smallest value of ul-powercontrolId for at least the PCell or the PSCell
   the values of P_{O_UE_SRS,b,f,c}(qₛ) α_{SRS,b,f,c}(qₛ), and the SRS power control adjustment state l provided by p0AlphaSetforSRS associated with the smallest value of ul-powercontrolId for at least the PCell or the PSCell
      and/or
for at least (a) as defined/specified herein, transmit PUSCHs and/or PUSCH(s) scheduled/activated by the PDCCH(s) defined/specified herein in the present disclosure, PUCCHs and/or PUCCH(s) with the higher layer RRC configuration(s) applyIndicatedTCIState provided to the corresponding PUCCH resource(s)/PUCCH resource group set to ‘first’ or ‘second’ or ‘both’ and/or SRSs and/or SRS(s) in the first and/or second SRS resource set(s) and/or SRS(s) that uses a same spatial domain filter with same indicated TCI state as for the PUCCH(s) and/or PUSCH(s) defined/specified herein in the present disclosure, using a same spatial domain filter as the one corresponding to q_{new} from a reference NBI RS set corresponding to the NBI RS set q̅_{1,0} or q̅_{1,1}, if any, (e.g., on at least the serving cell or the SCell) and using the following parameters for determination of a corresponding power
the RS index q=q_{new} from a reference NBI RS set corresponding to the NBI RS set q̅_{1,0} or q̅_{1,1}, if any, for obtaining a corresponding downlink pathloss estimate for at least the SCell
the values of P_{O_UE_PUSCH,b,f,c}(j), α_{b,f,c}(j), and the PUSCH power control adjustment state l provided by p0AlphaSetforPUSCH associated with the smallest value of ul-powercontrolId for at least the SCell
the value of P_{O_UE_PUCCH}(qᵤ) and the PUCCH power control adjustment state l provided by p0AlphaSetforPUCCH associated with the smallest value of ul-powercontrolId for at least the SCell
the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for at least the SCell and/or
for at least (b) and (c) as defined/specified herein, transmit PUSCH, PUCCH, and SRS that apply the first TCI-State or TCI-UL-State and/or the second TCI-State or TCI-UL-State (i.e., the SRS could use a same spatial domain filter with same indicated first/second TCI-State TCI-UL-State as for the PUCCH(s) and/or PUSCH(s) defined/specified herein in the present disclosure) using a same spatial domain filter as for the last PRACH transmission using the following parameters for determination of a corresponding power
   the RS index q=q_{new} from a reference NBI RS set corresponding to the NBI RS set q̅_{1,0} or q̅_{1,1}, if any, for obtaining a corresponding downlink pathloss estimate for at least the PCell or the PSCell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for at least the PCell or the PSCell
   the value of P_{O_UE_PUCCH}(qᵤ) and the PUCCH power control adjustment state l provided by p0AlphaSetforPUCCH associated with the smallest value of ul-powercontrolId for at least the PCell or the PSCell
   the values of P_{O_UE_SRS,b,f,c}(s) α_{SRS,b,f,c}(s), and the SRS power control adjustment state l provided by p0AlphaSetforSRS associated with the smallest value of ul-powercontrolId for at least the PCell or the PSCell
      and/or
for at least (a) as defined/specified herein, transmit PUSCH, PUCCH, and SRS that apply the first TCI-State or TCI-UL-State and/or the second TCI-State or TCI-UL-State (i.e., the SRS could use a same spatial domain filter with same indicated first/second TCI-State TCI-UL-State as for the PUCCH(s) and/or PUSCH(s) defined/specified herein in the present disclosure) using a same spatial domain filter as the one corresponding to q_{new} from a reference NBI RS set corresponding to the NBI RS set q̅_{1,0} or q̅q_{1,1}, if any, (e.g., on at least the serving cell or the SCell) and using the following parameters for determination of a corresponding power
   the RS index q_{d}=q_{new} from a reference NBI RS set corresponding to the NBI RS set q̅_{1,0} or q̅q_{1,1}, if any, for obtaining a corresponding downlink pathloss estimate for at least the SCell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for at least the SCell
   the value of P_{O_UE_PUCCH}(qᵤ) and the PUCCH power control adjustment state l provided by p0AlphaSetforPUCCH associated with the smallest value of ul-powercontrolId for at least the SCell
   the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for at least the SCell where the SCS configuration for the 28 symbols is the smallest of the SCS configurations of the active DL BWP for the PDCCH reception and of the active DL BWP(s) of the serving cells. The UE could determine/identify the reference NBI RS set (corresponding to the first NBI RS set q̅_{1,0} or the second NBI RS set q̅_{1,1}) according to those specified herein in the present disclosure including: (1) fixed rule(s) in system specifications—e.g., the reference NBI RS set could correspond to the first NBI RS set q̅_{1,0}, (2) network's configuration(s)/indication(s), e.g., via higher layer RRC signalling(s)/parameter(s) and/or MAC CE command(s) and/or dynamic DCI based L1 signalling(s), and/or (3) UE's autonomous determination/selection, which could be further sent to the network via/in part of a beam/CSI report and/or UE's capability signalling(s). For this case—i.e., after the specified beam resetting procedure herein has been completed,
In one example, the UE could expect to receive a first or third (unified) TCI state(s) activation/deactivation MAC CE command as specified herein in the present disclosure, and/or the UE could be expected to apply the TCI codepoints—when they become applicable—activated by/in a first or third (unified) TCI state(s) activation/deactivation MAC CE command as specified herein in the present disclosure, and/or the UE could be expected to apply TCI codepoint(s) from a first/third unified TCI state(s) activation/deactivation MAC CE command as specified herein in the present disclosure to the TCI field of DCI format 1_1/1_2. Or, the UE may not expect to receive a second or fourth (unified) TCI state(s) activation/deactivation MAC CE command as specified herein in the present disclosure, and/or the UE may not be expected to apply the TCI codepoints—when they become applicable—activated by/in a second or fourth (unified) TCI state(s) activation/deactivation MAC CE command as specified herein in the present disclosure, and/or the UE may not be expected to apply TCI codepoint(s) from a second/fourth unified TCI state(s) activation/deactivation MAC CE command as specified herein in the present disclosure to the TCI field of DCI format 1_1/1_2. For this case/design example, when/if the joint/DL/UL TCI state indicated by a TCI codepoint—from the first/third (unified) TCI state(s) activation/deactivation MAC CE command as specified herein in the present disclosure—has become applicable (e.g., after the corresponding beam application time),
   For example, the UE could apply the indicated joint/DL/UL TCI state to monitor PDCCHs, and receive PDSCHs and aperiodic CSI-RS resources, and/or to transmit PUSCHs, PUCCHs, and SRSs.
   For another example, the UE could apply the indicated joint/DL/UL TCI state to monitor PDCCH(s) that applies the first TCI-State and/or the second TCI-State, and receive PDSCH(s) and aperiodic CSI-RS resource(s) that apply the first TCI-State and/or the second TCI-State, and/or to transmit PUSCH, PUCCH, and SRS that apply the first TCI-State or TCI-UL-State and/or the second TCI-State or TCI-UL-State.
In another example, the UE could expect to receive a second or fourth (unified) TCI state(s) activation/deactivation MAC CE command as specified herein in the present disclosure, and/or the UE could be expected to apply the TCI codepoints—when they become applicable—activated by/in a second or fourth (unified) TCI state(s) activation/deactivation MAC CE command as specified herein in the present disclosure, and/or the UE could be expected to apply TCI codepoint(s) from a second or fourth unified TCI state(s) activation/deactivation MAC CE command as specified herein in the present disclosure to the TCI field of DCI format 1_1/1_2. Or, the UE may not expect to receive a first or third (unified) TCI state(s) activation/deactivation MAC CE command as specified herein in the present disclosure, and/or the UE may not be expected to apply the TCI codepoints—when they become applicable—activated by/in a first or third (unified) TCI state(s) activation/deactivation MAC CE command as specified herein in the present disclosure, and/or the UE may not be expected to apply TCI codepoint(s) from a first/third unified TCI state(s) activation/deactivation MAC CE command as specified herein in the present disclosure to the TCI field of DCI format 1_1/1_2. For this case/design example, when/if the joint/DL/UL TCI state(s) indicated by a TCI codepoint—from the second/fourth (unified) TCI state(s) activation/deactivation MAC CE command as specified herein in the present disclosure—has become applicable (e.g., after the corresponding beam application time),
For example, when/if the indicated joint/DL/UL TCI state(s) corresponds to a first TCI state,
   the UE could apply the indicated first joint/DL/UL TCI state to monitor PDCCHs, and receive PDSCHs and aperiodic CSI-RS resources, and/or to transmit PUSCHs, PUCCHs, and SRSs, and/or
   the UE could apply the indicated first joint/DL/UL TCI state to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or apply the TCI state corresponding to q_{new} from the reference NBI RS set as specified herein in the present disclosure to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State.
For another example, when/if the indicated joint/DL/UL TCI state(s) corresponds to a second TCI state,
   the UE could apply the indicated second joint/DL/UL TCI state to monitor PDCCHs, and receive PDSCHs and aperiodic CSI-RS resources, and/or to transmit PUSCHs, PUCCHs, and SRSs, and/or
   the UE could apply the indicated second joint/DL/UL TCI state to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State, and/or apply the TCI state corresponding to q_{new} from the reference NBI RS set as specified herein in the present disclosure to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State.
For another example, when/if the indicated joint/DL/UL TCI state(s) corresponds to a first TCI state and a second TCI state,
   the UE could apply the indicated first joint/DL/UL TCI state to monitor PDCCHs, and receive PDSCHs and aperiodic CSI-RS resources, and/or to transmit PUSCHs, PUCCHs, and SRSs, and/or
   the UE could apply the indicated first joint/DL/UL TCI state to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or apply the TCI state corresponding to q_{new} from the reference NBI RS set as specified herein in the present disclosure to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State, and/or
   the UE could apply the indicated second joint/DL/UL TCI state to monitor PDCCHs, and receive PDSCHs and aperiodic CSI-RS resources, and/or to transmit PUSCHs, PUCCHs, and SRSs, and/or
   the UE could apply the indicated second joint/DL/UL TCI state to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State, and/or apply the TCI state corresponding to q_{new} from the reference NBI RS set as specified herein in the present disclosure to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or
   the UE could apply the indicated first joint/DL/UL TCI state to monitor PDCCH(s) that applies the first TCI-State, and receive PDSCH(s) and aperiodic CSI-RS resource(s) that apply the first TCI-State, and/or to transmit PUSCH, PUCCH, and SRS that apply the first TCI-State or TCI-UL-State, and/or apply the indicated second joint/DL/UL TCI state to monitor PDCCH(s) that applies the second TCI-State, and receive PDSCH(s) and aperiodic CSI-RS resource(s) that apply the second TCI-State, and/or to transmit PUSCH, PUCCH, and SRS that apply the second TCI-State or TCI-UL-State.

In one embodiment, if a UE is provided two coresetPoolIndex values 0 and 1 for the first and second CORESETs, or is not provided coresetPoolIndex value for the first CORESETs and is provided coresetPoolIndex value of 1 for the second CORESETs, respectively, and the UE is provided dl-OrJointTCI-StateList or TCI-UL-State or ul-TCI-StateList (e.g., for a PCell and/or a PSCell and/or a SCell), and/or if the UE reports its capability of supporting TRP-specific BFR under unified TCI framework with unified TCI state(s), and/or if the UE is configured/provided by the network a higher layer parameter perTRP-BFR, e.g., set to ‘enabled’, the UE/serving cell could be configured/associated a first BFD RS set and a first NBI RS set q̅_{0,0} and q̅_{1,0}, and with a second BFD RS set and a second NBI RS set q̅_{0,1} and q_{1,1}, and/or the UE could determine the first BFD RS set q̅_{0,0} and/or the second BFD RS set q̅_{0,1} according to the TCI-State(s)/TCI-UL-State(s) specific to the first and/or second CORESET(s) following those specified herein in the present disclosure. In this case, when/if the first BFD RS set and/or the second BFD RS set (and therefore, the BFD RS resources provided/configured/indicated/determined/identified therein) is/are having radio link quality worse than Q_{out,LR}, (a) after 28 symbols from a last symbol of a PDCCH reception with a DCI format scheduling a PUSCH transmission with a same HARQ process number as for the transmission of the PUSCH and having a toggled NDI field value, and/or (b) after 28 symbols from a last symbol of a PDCCH reception in a search space set provided by recoverySearchSpaceId where the UE detects a DCI format with CRC scrambled by C-RNTI or MCS-C-RNTI, and/or (c) after 28 symbols from the last symbol of the PDCCH reception that determines the completion of the contention based random access procedure (e.g., when/if the UE provides BFR MAC CE in Msg3 or MsgA of contention based random access procedure), the UE
monitors PDCCH in the first CORESETs, and receives PDSCH scheduled/activated by PDCCH in the first CORESETs, and aperiodic CSI-RS resource that apply a TCI-State specific to the first CORESETs, using same antenna port quasi co-location parameters as the ones associated with a corresponding index q_{new} from q̅_{1,0}, if any, for the serving cell/PCell/PSCell/SCell
monitors PDCCH in the second CORESETs, and receives PDSCH scheduled/activated by PDCCH in the second CORESETs, and aperiodic CSI-RS resource that apply a TCI-State specific to the second CORESETs, using the same antenna port quasi co-location parameters as the ones associated with the corresponding index q_{new} from q̅_{1,1}, if any, for the serving cell/PCell/PSCell/SCell
transmits PUSCH, PUCCH, and SRS that apply TCI-State or TCI-UL-State specific to the first CORESETs using a same spatial domain filter as the one corresponding to q_{new} from q̅_{1,0}, if any, or using a same spatial domain filter as for the last PRACH transmission (e.g., specific to the first CORESETs), for the serving cell/PCell/PSCell/SCell and using the following parameters for determination of a corresponding power
the RS index q_{d}=q_{new} from q̅_{1,0}, if any, for obtaining a corresponding downlink pathloss estimate for the serving cell/PCell/PSCell/SCell
the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell/PCell/PSCell/SCell
the value of P_{O_UE_PUCCH}(qᵤ) and the PUCCH power control adjustment state l provided by p0AlphaSetforPUCCH associated with the smallest value of ul-powercontrolId for the serving cell/PCell/PSCell/SCell
the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell/PCell/PSCell/SCell
transmits PUSCH, PUCCH, and SRS that apply TCI-State or TCI-UL-State specific to the second CORESETs using a same spatial domain filter as the one corresponding to q_{new} from q̅_{1,1}, if any, or using a same spatial domain filter as for the last PRACH transmission (e.g., specific to the second CORESETs), for the serving cell/PCell/PSCell/SCell and using the following parameters for determination of a corresponding power
the RS index q_{d}=q_{new} from q̅_{1,1}, if any, for obtaining a corresponding downlink pathloss estimate for the serving cell/PCell/PSCell/SCell
the values of P_{O_UE_PUSCH,b,f,c}(j), α_{b,f,c}(W, and the PUSCH power control adjustment state l provided by p0AlphaSetforPUSCH associated with the smallest value of ul-powercontrolId for the serving cell/PCell/PSCell/SCell
the value of P_{O_UE_PUCCH}(qᵤ) and the PUCCH power control adjustment state l provided by p0AlphaSetforPUCCH associated with the smallest value of ul-powercontrolId for the serving cell/PCell/PSCell/SCell
the values of P_{O_UE_SRS,b,f,c}, α_{SRS,b,f,c}(qₛ), and the SRS power control adjustment state l provided by p0AlphaSetforSRS associated with the smallest value of ul-powercontrolId for the serving cell/PCell/PSCell/SCell
   where the SCS configuration for the 28 symbols is the smallest of the SCS configurations of the active DL BWP for the PDCCH reception and of the active DL BWP(s) of the serving cells.

In one embodiment, if a UE is provided two coresetPoolIndex values 0 and 1 for the first and second CORESETs, or is not provided coresetPoolIndex value for the first CORESETs and is provided coresetPoolIndex value of 1 for the second CORESETs, respectively, and if a UE is provided dl-OrJointTCI-StateList or TCI-UL-State or ul-TCI-StateList (e.g., for a PCell and/or a PSCell and/or a SCell), and/or if the UE does not report its capability of supporting TRP-specific BFR under unified TCI framework with unified TCI state(s), and/or if the UE is not configured/provided by the network (e.g. the network 130) a higher layer parameter perTRP-BFR, e.g., set to ‘enabled’, and/or if the UE is configured/provided by the network a higher layer parameter perTRP-BFR set to ‘disabled’, and/or if the UE/serving cell is not provided/configured/associated with BFD RS set(s) q̅_{0,0} and/or q̅_{0,1} and/or NBI RS set(s) q̅_{1,0} and/or q̅_{1,1} for a BWP of the serving cell, and/or if the UE is not expected/configured to determine BFD RS set(s) q̅_{0,0} and/or q̅_{0,1} according to the TCI-State(s)/TCI-UL-State(s) specific to the first CORESETs and/or the second CORESETs following those specified herein in the present disclosure, and/or if SSB-MTC-AdditionalPCI is not provided, the UE/serving cell could be provided/configured/associated with a single BFD RS set q̅₀ and with a single NBI RS set q̅₁ and/or the UE could determine a single BFD RS set q̅₀ according to the TCI-State/TCI-UL-State specific to the first CORESETs and/or the second CORESETs following those specified herein in the present disclosure (other than two BFD RS sets q̅_{0,0} and q̅_{0,1} and two NBI RS sets q̅_{1,0} and q̅_{1,1} when/if the UE reports its capability of supporting TRP-specific BFR under unified TCI framework with unified TCI state(s)). In this case, when the BFD RS set q̅_{0,1} (and therefore, the BFD RS resource(s) provided/configured/indicated/determined/identified therein) is having radio link quality worse than Q_{out,LR}, (a) after 28 symbols from a last symbol of a PDCCH reception with a DCI format scheduling a PUSCH transmission with a same HARQ process number as for the transmission of the PUSCH and having a toggled NDI field value, and/or (b) after 28 symbols from a last symbol of a PDCCH reception in a search space set provided by recoverySearchSpaceId where the UE detects a DCI format with CRC scrambled by C-RNTI or MCS-C-RNTI, and/or (c) after 28 symbols from the last symbol of the PDCCH reception that determines the completion of the contention based random access procedure (e.g., when/if the UE provides BFR MAC CE in Msg3 or MsgA of contention based random access procedure), the UE (e.g. the UE 116) could
for (a), (b) and/or (c) as defined/specified herein, monitor PDCCHs and/or PDCCH(s) in CORESETs, e.g., on the SCell(s) indicated by the corresponding MAC CE (for at least (a) as defined/specified herein), and receive PDSCHs and/or PDSCH(s) scheduled/activated by the PDCCH(s) defined/specified herein in the present disclosure and aperiodic CSI-RS resources and/or aperiodic CSI-RS resource in a CSI resource set with the higher layer RRC configuration(s) applyIndicatedTCIState provided to the aperiodic CSI-RS resource/CSI resource set to ‘first’ or ‘second’ and/or aperiodic CSI-RS resource in a CSI resource set with the same indicated TCI state as for the PDCCH(s) and/or PDSCH(s) defined/specified herein in the present disclosure (e.g., the higher layer RRC configuration(s) applyIndicatedTCIState provided to the aperiodic CSI-RS resource/CSI resource set could be set to ‘first’ with respect to the first CORESET(s) or ‘second’ with respect to the second CORESET(s)), using the same antenna port quasi co-location parameters as the ones associated with a corresponding index q_{new} from the NBI RS set q̅₁, if any, (e.g., on the serving cell or the PCell or the PSCell or the SCell), and/or
for (a), (b) and/or (c) as defined/specified herein, monitor PDCCH(s) in the first CORESETs and/or the second CORESETs, e.g., on the SCell(s) indicated by the corresponding MAC CE (for at least (a) as defined/specified herein), and receive PDSCH(s) scheduled/activated by PDCCH(s) in the first CORESETs and/or the second CORESETs, and aperiodic CSI-RS resource(s) applying TCI-State(s) specific to the first CORESETs and/or second CORESET(s)—i.e., the aperiodic CSI-RS resource(s) could apply the same TCI-State(s), e.g., specific to the first/second CORESET(s), as that for the PDCCH(s) and/or PDSCH(s) defined/specified herein in the present disclosure, using same antenna port quasi co-location parameters as the ones associated with a corresponding index q_{new} from the NBI RS set q̅₁, if any, (e.g., for the serving cell or the PCell or the PSCell or the SCell), and/or
for at least (b) and (c) as defined/specified herein, transmit PUSCHs and/or PUSCH(s) scheduled/activated by the PDCCH(s) defined/specified herein in the present disclosure, PUCCHs and/or PUCCH(s) with the higher layer RRC configuration(s) applyIndicatedTCIState provided to the corresponding PUCCH resource(s)/PUCCH resource group set to ‘first’ or ‘second’ or ‘both’ and/or SRSs and/or SRS(s) in the first and/or second SRS resource set(s) and/or SRS(s) that uses a same spatial domain filter with same indicated TCI-State(s)/UL-TCI-State(s), e.g., specific to the first/second CORESET(s), as for the PUCCH(s) and/or PUSCH(s) defined/specified herein in the present disclosure, using a same spatial domain filter as for the last PRACH transmission using the following parameters for determination of a corresponding power
   the RS index q_{d}=q_{new} from q̅₁, if any, for obtaining a corresponding downlink pathloss estimate for the serving cell or the PCell or the PSCell or the SCell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell or the PCell or the PSCell or the SCell
   the value of P_{O_UE_PUCCH}(qᵤ) and the PUCCH power control adjustment state l provided by p0AlphaSetforPUCCH associated with the smallest value of ul-powercontrolId for the serving cell or the PCell or the PSCell or the SCell
   the values of P_{O_UE_SRS,b,f,c}(qₛ), α_{SRS,b,f,c}(s), and the SRS power control adjustment state l provided by p0AlphaSetforSRS associated with the smallest value of ul-powercontrolId for the serving cell or the PCell or the PSCell or the SCell
      and/or
for at least (a) as defined/specified herein, transmit PUSCHs and/or PUSCH(s) scheduled/activated by the PDCCH(s) defined/specified herein in the present disclosure, PUCCHs and/or PUCCH(s) with the higher layer RRC configuration(s) applyIndicatedTCIState provided to the corresponding PUCCH resource(s)/PUCCH resource group set to ‘first’ or ‘second’ or ‘both’, and SRSs and/or SRS(s) in the first and/or second SRS resource set(s) and/or SRS(s) that uses a same spatial domain filter with same indicated TCI-State(s)/UL-TCI-State(s), e.g., specific to the first/second CORESET(s), as for the PUCCH(s) and/or PUSCH(s) defined/specified herein in the present disclosure using a same spatial domain filter as the one corresponding to q_{new} from q̅₁, if any, (e.g., on the serving cell and/or PCell and/or PSCell and/or SCell), and using the following parameters for determination of a corresponding power
the RS index q=q_{new} from q̅₁, if any, for obtaining a corresponding downlink pathloss estimate for the serving cell and/or PCell and/or PSCell and/or SCell
the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell and/or PCell and/or PSCell and/or SCell
the value of P_{O_UE_PUCCH}(qᵤ) and the PUCCH power control adjustment state l provided by p0AlphaSetforPUCCH associated with the smallest value of ul-powercontrolId for the serving cell and/or PCell and/or PSCell and/or SCell
the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell and/or PCell and/or PSCell and/or SCell
   and/or
for at least (b) and (c) as defined/specified herein, transmit PUSCH, PUCCH, and SRS that apply the TCI-State(s) or TCI-UL-State(s) specific to the first CORESETs and/or the second CORESET(s) (i.e., the SRS could use a same spatial domain filter with same indicated TCI-State/TCI-UL-State, e.g., specific to the first/second CORESETs, as for the PUCCH(s) and/or PUSCH(s) defined/specified herein in the present disclosure) using a same spatial domain filter as for the last PRACH transmission using the following parameters for determination of a corresponding power
   the RS index q=q_{new} from q̅₁, if any, for obtaining a corresponding downlink pathloss estimate for at least the PCell or the PSCell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for at least the PCell or the PSCell
   the value of P_{O_UE_PUCCH}(qᵤ) and the PUCCH power control adjustment state l provided by p0AlphaSetforPUCCH associated with the smallest value of ul-powercontrolId for at least the PCell or the PSCell
   the values of P_{O_UE_SRS,b,f,c}(s) α_{SRS,b,f,c}(s), and the SRS power control adjustment state l provided by p0AlphaSetforSRS associated with the smallest value of ul-powercontrolId for at least the PCell or the PSCell
      and/or
for at least (a) as defined/specified herein, transmit PUSCH, PUCCH, and SRS that apply the TCI-State(s) or TCI-UL-State(s) specific to the first CORESETs and/or the second CORESETs (i.e., the SRS could use a same spatial domain filter with same indicated TCI-State/TCI-UL-State, e.g., specific to the first/second CORESETs, as for the PUCCH(s) and/or PUSCH(s) defined/specified herein in the present disclosure) using a same spatial domain filter as the one corresponding to q_{new} from q̅₁, if any, (e.g., on the serving cell and/or PCell and/or PSCell and/or SCell) and using the following parameters for determination of a corresponding power
   the RS index q_{d}=q_{new} from q̅₁, if any, for obtaining a corresponding downlink pathloss estimate for at least the SCell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for at least the SCell
   the value of P_{O_UE_PUCCH}(qᵤ) and the PUCCH power control adjustment state l provided by p0AlphaSetforPUCCH associated with the smallest value of ul-powercontrolId for at least the SCell
   the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for at least the SCell
      where the SCS configuration for the 28 symbols is the smallest of the SCS configurations of the active DL BWP for the PDCCH reception and of the active DL BWP(s) of the serving cells. For this case—i.e., after the specified beam resetting procedure herein has been completed,
In one example, the UE could expect to receive a (unified) TCI state(s) activation/deactivation MAC CE command (e.g., a first (unified) TCI state(s) activation/deactivation command as specified herein in the present disclosure) not specific to any value(s) of coresetPoolIndex, and/or the UE could be expected to apply the TCI codepoints—when they become applicable—activated by/in a (unified) TCI state(s) activation/deactivation MAC CE command not specific to any value(s) of coresetPoolIndex, and/or the UE could be expected to apply TCI codepoint(s) from a (unified) TCI state(s) activation/deactivation MAC CE command not specific to any value(s) of coresetPoolIndex to the TCI field of DCI format 1_1/1_2. Or, the UE may not expect to receive a (unified) TCI state(s) activation/deactivation MAC CE command (e.g., a first (unified) TCI state(s) activation/deactivation MAC CE command as specified herein in the present disclosure) specific to a value of coresetPoolIndex (e.g., 0 or 1), and/or the UE may not be expected to apply the TCI codepoints—when they become applicable—activated by/in a (unified) TCI state(s) activation/deactivation MAC CE command specific to a value of coresetPoolIndex, and/or the UE may not be expected to apply TCI codepoint(s) from a (unified) TCI state(s) activation/deactivation MAC CE command specific to a value of coresetPoolIndex to the TCI field of DCI format 1_1/1_2. For this case/design example, when/if the joint/DL/UL TCI state indicated by a TCI codepoint—from the (unified) TCI state(s) activation/deactivation MAC CE command not specific to any value(s) of coresetPoolIndex—has become applicable (e.g., after the corresponding beam application time),
   For example, the UE could apply the indicated joint/DL/UL TCI state to monitor PDCCHs, and receive PDSCHs and aperiodic CSI-RS resources, and/or to transmit PUSCHs, PUCCHs, and SRSs.
   For another example, the UE could apply the indicated joint/DL/UL TCI state to monitor PDCCH(s) in the first and/or second CORESETs, and receive PDSCH(s) scheduled/activated by PDCCH(s) in the first and/or second CORESETs, and aperiodic CSI-RS resource(s) applying the TCI-State(s) specific to the first and/or second CORESETs, and/or to transmit PUSCH, PUCCH, and SRS that apply the TCI-State(s) or TCI-UL-State(s) specific to the first and/or second CORESETs.
In another example, the UE could expect to receive a (unified) TCI state(s) activation/deactivation MAC CE command (e.g., a first (unified) TCI state(s) activation/deactivation command as specified herein in the present disclosure) specific to a value of coresetPoolIndex (e.g., 0 or 1), and/or the UE could be expected to apply the TCI codepoints—when they become applicable—activated by/in a (unified) TCI state(s) activation/deactivation MAC CE command specific to a value of coresetPoolIndex (e.g., 0 or 1), and/or the UE could be expected to apply TCI codepoint(s) from a (unified) TCI state(s) activation/deactivation MAC CE command specific to a value of coresetPoolIndex to the TCI field of DCI format 1_1/1_2 specific to the same value of coresetPoolIndex. Or, the UE may not expect to receive a (unified) TCI state(s) activation/deactivation MAC CE command (e.g., a first (unified) TCI state(s) activation/deactivation MAC CE command as specified herein in the present disclosure) not specific to any value(s) of coresetPoolIndex, and/or the UE may not be expected to apply the TCI codepoints—when they become applicable—activated by/in a (unified) TCI state(s) activation/deactivation MAC CE command not specific to any value(s) of coresetPoolIndex, and/or the UE may not be expected to apply TCI codepoint(s) from a (unified) TCI state(s) activation/deactivation MAC CE command not specific to any value(s) of coresetPoolIndex to the TCI field of DCI format 1_1/1_2. For this case/design example, when/if the joint/DL/UL TCI state indicated by a TCI codepoint—from the (unified) TCI state(s) activation/deactivation MAC CE command specific to a value of coresetPoolIndex (e.g., 0 or 1)—has become applicable (e.g., after the corresponding beam application time),
   For example, when/if the indicated joint/DL/UL TCI state(s) is of a TCI codepoint from the (unified) TCI state(s) activation/deactivation MAC CE command specific to value 0 of coresetPoolIndex,
      the UE could apply the indicated joint/DL/UL TCI state to monitor PDCCHs, and receive PDSCHs and aperiodic CSI-RS resources, and/or to transmit PUSCHs, PUCCHs, and SRSs, and/or
      the UE could apply the indicated joint/DL/UL TCI state to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or apply the TCI state corresponding to q_{new} from in to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs.
   For another example, when/if the indicated joint/DL/UL TCI state(s) is of a TCI codepoint from the (unified) TCI state(s) activation/deactivation MAC CE command specific to value 1 of coresetPoolIndex,
      the UE could apply the indicated joint/DL/UL TCI state to monitor PDCCHs, and receive PDSCHs and aperiodic CSI-RS resources, and/or to transmit PUSCHs, PUCCHs, and SRSs, and/or
      the UE could apply the indicated joint/DL/UL TCI state to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs, and/or apply the TCI state corresponding to q_{new} from q̅₁ to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs.
In another example, the UE could expect to receive a 1^{st} (unified) TCI state(s) activation/deactivation MAC CE command (e.g., a first (unified) TCI state(s) activation/deactivation command as specified herein in the present disclosure) specific to value 0 of coresetPoolIndex and a 2^{nd} (unified) TCI state(s) activation/deactivation MAC CE command (e.g., a first (unified) TCI state(s) activation/deactivation command as specified herein in the present disclosure) specific to value 1 of coresetPoolIndex, and/or the UE could be expected to apply the TCI codepoints—when they become applicable—activated by/in a 1^{st} (unified) TCI state(s) activation/deactivation MAC CE command specific to value 0 of coresetPoolIndex and a 2^{nd} (unified) TCI state(s) activation/deactivation MAC CE command specific to value 1 of coresetPoolIndex, and/or the UE could be expected to apply TCI codepoint(s) from a 1^{st} (unified) TCI state(s) activation/deactivation MAC CE command specific to value 0 of coresetPoolIndex to the TCI field of DCI format 1_1/1_2 specific to the same value 0 of coresetPoolIndex, and apply TCI codepoint(s) from a 2^{nd} (unified) TCI state(s) activation/deactivation MAC CE command specific to value 1 of coresetPoolIndex to the TCI field of DCI format 1_1/1_2 specific to the same value 1 of coresetPoolIndex. Or, the UE may not expect to receive a (unified) TCI state(s) activation/deactivation MAC CE command (e.g., a first (unified) TCI state(s) activation/deactivation MAC CE command as specified herein in the present disclosure) not specific to any value(s) of coresetPoolIndex, and/or the UE may not be expected to apply the TCI codepoints—when they become applicable—activated by/in a (unified) TCI state(s) activation/deactivation MAC CE command not specific to any value(s) of coresetPoolIndex, and/or the UE may not be expected to apply TCI codepoint(s) from a (unified) TCI state(s) activation/deactivation MAC CE command not specific to any value(s) of coresetPoolIndex to the TCI field of DCI format 1_1/1_2. For this case/design example, when/if a first joint/DL/UL TCI states indicated by a TCI codepoint—from the 1^{st} (unified) TCI state(s) activation/deactivation MAC CE command specific to value 0 of coresetPoolIndex—and a second joint/DL/UL TCI states indicated by a TCI codepoint—from the 2^{nd} (unified) TCI state(s) activation/deactivation MAC CE command specific to value 1 of coresetPoolIndex—have become applicable (e.g., after the corresponding beam application time),
   the UE could apply the indicated first joint/DL/UL TCI state specific to value 0 of coresetPoolIndex to monitor PDCCHs, and receive PDSCHs and aperiodic CSI-RS resources, and/or to transmit PUSCHs, PUCCHs, and SRSs, and/or
   the UE could apply the indicated first joint/DL/UL TCI state specific to value 0 of coresetPoolIndex to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or apply the TCI state corresponding to q_{new} from q̅₁ to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs, and/or
   the UE could apply the indicated second joint/DL/UL TCI state specific to value 1 of coresetPoolIndex to monitor PDCCHs, and receive PDSCHs and aperiodic CSI-RS resources, and/or to transmit PUSCHs, PUCCHs, and SRSs, and/or
   the UE could apply the indicated second joint/DL/UL TCI state specific to value 1 of coresetPoolIndex to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs, and/or apply the TCI state corresponding to q_{new} from q̅₁ to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or
   the UE could apply the indicated first joint/DL/UL TCI state specific to value 0 of coresetPoolIndex to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or apply the indicated second joint/DL/UL TCI state specific to value 1 of coresetPoolIndex to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs.

In one embodiment, if a UE (e.g. the UE 116) is provided two coresetPoolIndex values 0 and 1 for the first and second CORESETs, or is not provided coresetPoolIndex value for the first CORESETs and is provided coresetPoolIndex value of 1 for the second CORESETs, respectively, and if a UE is provided dl-OrJointTCI-StateList or TCI-UL-State or ul-TCI-StateList (e.g., for a PCell and/or a PSCell and/or a SCell), and/or if the UE does not report its capability of supporting TRP-specific BFR under unified TCI framework with unified TCI state(s), and/or if the UE is not configured/provided by the network (e.g. the network 130) a higher layer parameter perTRP-BFR, e.g., set to ‘enabled’, and/or if the UE is configured/provided by the network a higher layer parameter perTRP-BFR set to ‘disabled’, and/or if the UE/serving cell is not provided/configured/associated with a single BFD RS set q̅₀ and/or a single NBI RS set q̅₁ for a BWP of the serving cell, and/or if the UE is not expected/configured to determine a single BFD RS set q̅₀ according to the TCI-State(s)/TCI-UL-State(s) specific to the first and/or second CORESET(s) following those specified herein in the present disclosure, and/or if SSB-MTC-AdditionalPCI is not provided, the UE/serving cell could be provided/configured/associated a first BFD RS set and a first NBI RS set q̅_{0,0} and q̅_{1,0}, and with a second BFD RS set and a second NBI RS set q̅_{0,1} and q̅_{1,1}, and/or the UE could determine the first BFD RS set q̅_{0,0} and/or the second BFD RS set q̅_{0,1} according to the TCI-State(s)/TCI-UL-State(s) specific to the first and/or second CORESET(s) following those specified herein in the present disclosure. In this case, when/if the first BFD RS set and/or the second BFD RS set (and therefore, the BFD RS resources provided/configured/indicated/determined/identified therein) is/are having radio link quality worse than Q_{out,LR}, (a) after 28 symbols from a last symbol of a PDCCH reception with a DCI format scheduling a PUSCH transmission with a same HARQ process number as for the transmission of the PUSCH and having a toggled NDI field value, and/or (b) after 28 symbols from a last symbol of a PDCCH reception in a search space set provided by recoverySearchSpaceId where the UE detects a DCI format with CRC scrambled by C-RNTI or MCS-C-RNTI, and/or (c) after 28 symbols from the last symbol of the PDCCH reception that determines the completion of the contention based random access procedure (e.g., when/if the UE provides BFR MAC CE in Msg3 or MsgA of contention based random access procedure), the UE could
for (a), (b) and/or (c) as defined/specified herein, monitor PDCCHs and/or PDCCH(s) in CORESETs, e.g., on the SCell(s) indicated by the corresponding MAC CE (for at least (a) as defined/specified herein), and receive PDSCHs and/or PDSCH(s) scheduled/activated by the PDCCH(s) defined/specified herein in the present disclosure and aperiodic CSI-RS resources and/or aperiodic CSI-RS resource in a CSI resource set with the higher layer RRC configuration(s) applyIndicatedTCIState provided to the aperiodic CSI-RS resource/CSI resource set to ‘first’ or ‘second’ and/or aperiodic CSI-RS resource in a CSI resource set with the same indicated TCI state as for the PDCCH(s) and/or PDSCH(s) defined/specified herein in the present disclosure (e.g., the higher layer RRC configuration(s) applyIndicatedTCIState provided to the aperiodic CSI-RS resource/CSI resource set could be set to ‘first’ with respect to the first CORESET(s) or ‘second’ with respect to the second CORESET(s)), using the same antenna port quasi co-location parameters as the ones associated with a corresponding index q_{new} from a reference NBI RS set corresponding to the NBI RS set q̅_{1,0} or q̅q_{1,1}, if any, (e.g., on the serving cell or the PCell or the PSCell or the SCell), and/or
for (a), (b) and/or (c) as defined/specified herein, monitor PDCCH(s) in the first CORESETs and/or the second CORESETs, e.g., on the SCell(s) indicated by the corresponding MAC CE (for at least (a) as defined/specified herein), and receive PDSCH(s) scheduled/activated by PDCCH(s) in the first CORESETs and/or the second CORESETs, and aperiodic CSI-RS resource(s) applying TCI-State(s) specific to the first CORESETs and/or second CORESET(s)—i.e., the aperiodic CSI-RS resource(s) could apply the same TCI-State(s), e.g., specific to the first/second CORESET(s), as that for the PDCCH(s) and/or PDSCH(s) defined/specified herein in the present disclosure, using same antenna port quasi co-location parameters as the ones associated with a corresponding index q_{new} from a reference NBI RS set corresponding to the NBI RS set q̅_{1,0} or q̅_{1,1}, if any, (e.g., for the serving cell or the PCell or the PSCell or the SCell), and/or
for at least (b) and (c) as defined/specified herein, transmit PUSCHs and/or PUSCH(s) scheduled/activated by the PDCCH(s) defined/specified herein in the present disclosure, PUCCHs and/or PUCCH(s) with the higher layer RRC configuration(s) applyIndicatedTCIState provided to the corresponding PUCCH resource(s)/PUCCH resource group set to ‘first’ or ‘second’ or ‘both’ and/or SRSs and/or SRS(s) in the first and/or second SRS resource set(s) and/or SRS(s) that uses a same spatial domain filter with same indicated TCI-State(s)/UL-TCI-State(s), e.g., specific to the first/second CORESET(s), as for the PUCCH(s) and/or PUSCH(s) defined/specified herein in the present disclosure, using a same spatial domain filter as for the last PRACH transmission using the following parameters for determination of a corresponding power
   the RS index q_{d}=q_{new} from a reference NBI RS set corresponding to the NBI RS set q̅_{1,0} or q̅_{1,1}, if any, for obtaining a corresponding downlink pathloss estimate for the serving cell or the PCell or the PSCell or the SCell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell or the PCell or the PSCell or the SCell
   the value of P_{O_UE_PUCCH}(qᵤ) and the PUCCH power control adjustment state l provided by p0AlphaSetforPUCCH associated with the smallest value of ul-powercontrolId for the serving cell or the PCell or the PSCell or the SCell
   the values of P_{O_UE_SRS,b,f,c}(qₛ) α_{SRS,b,f,c}(qₛ), and the SRS power control adjustment state l provided by p0AlphaSetforSRS associated with the smallest value of ul-powercontrolId for the serving cell or the PCell or the PSCell or the SCell
      and/or
for at least (a) as defined/specified herein, transmit PUSCHs and/or PUSCH(s) scheduled/activated by the PDCCH(s) defined/specified herein in the present disclosure, PUCCHs and/or PUCCH(s) with the higher layer RRC configuration(s) applyIndicatedTCIState provided to the corresponding PUCCH resource(s)/PUCCH resource group set to ‘first’ or ‘second’ or ‘both’, and SRSs and/or SRS(s) in the first and/or second SRS resource set(s) and/or SRS(s) that uses a same spatial domain filter with same indicated TCI-State(s)/UL-TCI-State(s), e.g., specific to the first/second CORESET(s), as for the PUCCH(s) and/or PUSCH(s) defined/specified herein in the present disclosure using a same spatial domain filter as the one corresponding to q_{new} from a reference NBI RS set corresponding to the NBI RS set q̅_{1,0} or q̅q_{1,1}, if any, (e.g., on the serving cell and/or PCell and/or PSCell and/or SCell), and using the following parameters for determination of a corresponding power
the RS index q_{d}=q_{new} from a reference NBI RS set corresponding to the NBI RS set q̅_{1,0} or q̅_{1,1}, if any, for obtaining a corresponding downlink pathloss estimate for the serving cell and/or PCell and/or PSCell and/or SCell
the values of P_{O_UE_PUSCH,b,f,c}(j), α_{b,f,c}(j), and the PUSCH power control adjustment state l provided by p0AlphaSetforPUSCH associated with the smallest value of ul-powercontrolId for the serving cell and/or PCell and/or PSCell and/or SCell
the value of P_{O_UE_PUCCH}(qᵤ) and the PUCCH power control adjustment state l provided by p0AlphaSetforPUCCH associated with the smallest value of ul-powercontrolId for the serving cell and/or PCell and/or PSCell and/or SCell
the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for the serving cell and/or PCell and/or PSCell and/or SCell and/or
for at least (b) and (c) as defined/specified herein, transmit PUSCH, PUCCH, and SRS that apply the TCI-State(s) or TCI-UL-State(s) specific to the first CORESETs and/or the second CORESET(s) (i.e., the SRS could use a same spatial domain filter with same indicated TCI-State TCI-UL-State, e.g., specific to the first/second CORESETs, as for the PUCCH(s) and/or PUSCH(s) defined/specified herein in the present disclosure) using a same spatial domain filter as for the last PRACH transmission using the following parameters for determination of a corresponding power
   the RS index q_{d}=q_{new} from a reference NBI RS set corresponding to the NBI RS set q̅_{1,0} or q̅_{1,1}, if any, for obtaining a corresponding downlink pathloss estimate for at least the PCell or the PSCell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for at least the PCell or the PSCell
   the value of P_{O_UE_PUCCH}(qᵤ) and the PUCCH power control adjustment state l provided by p0AlphaSetforPUCCH associated with the smallest value of ul-powercontrolId for at least the PCell or the PSCell
   the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for at least the PCell or the PSCell
      and/or
for at least (a) as defined/specified herein, transmit PUSCH, PUCCH, and SRS that apply the TCI-State(s) or TCI-UL-State(s) specific to the first CORESETs and/or the second CORESETs (i.e., the SRS could use a same spatial domain filter with same indicated TCI-State TCI-UL-State, e.g., specific to the first/second CORESETs, as for the PUCCH(s) and/or PUSCH(s) defined/specified herein in the present disclosure) using a same spatial domain filter as the one corresponding to q_{new} from a reference NBI RS set corresponding to the NBI RS set q̅_{1,0} or q̅q_{1,1}, if any, (e.g., on the serving cell and/or PCell and/or PSCell and/or SCell) and using the following parameters for determination of a corresponding power
   the RS index q_{d}=q_{new} from a reference NBI RS set corresponding to the NBI RS set q̅_{1,0} or q̅q_{1,1}, if any, for obtaining a corresponding downlink pathloss estimate for at least the SCell
   the values of P_{O_UE_PUSCH,b,f,c}(j), α_{b,f,c}(j), and the PUSCH power control adjustment state l provided by p0AlphaSetforPUSCH associated with the smallest value of ul-powercontrolId for at least the SCell
   the value of P_{O_UE_PUCCH}(qᵤ) and the PUCCH power control adjustment state l provided by p0AlphaSetforPUCCH associated with the smallest value of ul-powercontrolId for at least the SCell
   the values of P_{O_UE_SRS,b,f,c}(qₛ), α_{SRS,b,f,c}(qₛ), and the SRS power control adjustment state l provided by p0AlphaSetforSRS associated with the smallest value of ul-powercontrolId for at least the SCell
      where the SCS configuration for the 28 symbols is the smallest of the SCS configurations of the active DL BWP for the PDCCH reception and of the active DL BWP(s) of the serving cells. The UE could determine/identify the reference NBI RS set (corresponding to the first NBI RS set q̅_{1,0} or the second NBI RS set q̅_{1,1}) according to those specified herein in the present disclosure including: (1) fixed rule(s) in system specifications—e.g., the reference NBI RS set could correspond to the first NBI RS set q̅_{1,0}, (2) network's configuration(s)/indication(s), e.g., via higher layer RRC signalling(s)/parameter(s) and/or MAC CE command(s) and/or dynamic DCI based L1 signaling(s), and/or (3) UE's autonomous determination/selection, which could be further sent to the network via/in part of a beam/CSI report and/or UE's capability signalling(s). For this case—i.e., after the specified beam resetting procedure herein has been completed,
In one example, the UE could expect to receive a (unified) TCI state(s) activation/deactivation MAC CE command (e.g., a first (unified) TCI state(s) activation/deactivation command as specified herein in the present disclosure) not specific to any value(s) of coresetPoolIndex, and/or the UE could be expected to apply the TCI codepoints—when they become applicable—activated by/in a (unified) TCI state(s) activation/deactivation MAC CE command not specific to any value(s) of coresetPoolIndex, and/or the UE could be expected to apply TCI codepoint(s) from a (unified) TCI state(s) activation/deactivation MAC CE command not specific to any value(s) of coresetPoolIndex to the TCI field of DCI format 1_1/1_2. Or, the UE may not expect to receive a (unified) TCI state(s) activation/deactivation MAC CE command (e.g., a first (unified) TCI state(s) activation/deactivation MAC CE command as specified herein in the present disclosure) specific to a value of coresetPoolIndex (e.g., 0 or 1), and/or the UE may not be expected to apply the TCI codepoints—when they become applicable—activated by/in a (unified) TCI state(s) activation/deactivation MAC CE command specific to a value of coresetPoolIndex, and/or the UE may not be expected to apply TCI codepoint(s) from a (unified) TCI state(s) activation/deactivation MAC CE command specific to a value of coresetPoolIndex to the TCI field of DCI format 1_1/1_2. For this case/design example, when/if the joint/DL/UL TCI state indicated by a TCI codepoint—from the (unified) TCI state(s) activation/deactivation MAC CE command not specific to any value(s) of coresetPoolIndex—has become applicable (e.g., after the corresponding beam application time),
   For example, the UE could apply the indicated joint/DL/UL TCI state to monitor PDCCHs, and receive PDSCHs and aperiodic CSI-RS resources, and/or to transmit PUSCHs, PUCCHs, and SRSs.
   For another example, the UE could apply the indicated joint/DL/UL TCI state to monitor PDCCH(s) in the first and/or second CORESETs, and receive PDSCH(s) scheduled/activated by PDCCH(s) in the first and/or second CORESETs, and aperiodic CSI-RS resource(s) applying the TCI-State(s) specific to the first and/or second CORESETs, and/or to transmit PUSCH, PUCCH, and SRS that apply the TCI-State(s) or TCI-UL-State(s) specific to the first and/or second CORESETs.
In another example, the UE could expect to receive a (unified) TCI state(s) activation/deactivation MAC CE command (e.g., a first (unified) TCI state(s) activation/deactivation command as specified herein in the present disclosure) specific to a value of coresetPoolIndex (e.g., 0 or 1), and/or the UE could be expected to apply the TCI codepoints—when they become applicable—activated by/in a (unified) TCI state(s) activation/deactivation MAC CE command specific to a value of coresetPoolIndex (e.g., 0 or 1), and/or the UE could be expected to apply TCI codepoint(s) from a (unified) TCI state(s) activation/deactivation MAC CE command specific to a value of coresetPoolIndex to the TCI field of DCI format 1_1/1_2 specific to the same value of coresetPoolIndex. Or, the UE may not expect to receive a (unified) TCI state(s) activation/deactivation MAC CE command (e.g., a first (unified) TCI state(s) activation/deactivation MAC CE command as specified herein in the present disclosure) not specific to any value(s) of coresetPoolIndex, and/or the UE may not be expected to apply the TCI codepoints—when they become applicable—activated by/in a (unified) TCI state(s) activation/deactivation MAC CE command not specific to any value(s) of coresetPoolIndex, and/or the UE may not be expected to apply TCI codepoint(s) from a (unified) TCI state(s) activation/deactivation MAC CE command not specific to any value(s) of coresetPoolIndex to the TCI field of DCI format 1_1/1_2. For this case/design example, when/if the joint/DL/UL TCI state indicated by a TCI codepoint—from the (unified) TCI state(s) activation/deactivation MAC CE command specific to a value of coresetPoolIndex (e.g., 0 or 1)—has become applicable (e.g., after the corresponding beam application time),
   For example, when/if the indicated joint/DL/UL TCI state(s) is of a TCI codepoint from the (unified) TCI state(s) activation/deactivation MAC CE command specific to value 0 of coresetPoolIndex,
      the UE could apply the indicated joint/DL/UL TCI state to monitor PDCCHs, and receive PDSCHs and aperiodic CSI-RS resources, and/or to transmit PUSCHs, PUCCHs, and SRSs, and/or
      the UE could apply the indicated joint/DL/UL TCI state to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or apply the TCI state corresponding to q_{new} from the reference NBI RS set corresponding to the NBI RS set q̅_{1,0} or q̅_{1,1} to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs.
   For another example, when/if the indicated joint/DL/UL TCI state(s) is of a TCI codepoint from the (unified) TCI state(s) activation/deactivation MAC CE command specific to value 1 of coresetPoolIndex,
      the UE could apply the indicated joint/DL/UL TCI state to monitor PDCCHs, and receive PDSCHs and aperiodic CSI-RS resources, and/or to transmit PUSCHs, PUCCHs, and SRSs, and/or
      the UE could apply the indicated joint/DL/UL TCI state to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs, and/or apply the TCI state corresponding to q_{new} from the reference NBI RS set corresponding to the NBI RS set q̅_{1,0} or q̅_{1,1} to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs.
In another example, the UE could expect to receive a 1^{st} (unified) TCI state(s) activation/deactivation MAC CE command (e.g., a first (unified) TCI state(s) activation/deactivation command as specified herein in the present disclosure) specific to value 0 of coresetPoolIndex and a 2^{nd} (unified) TCI state(s) activation/deactivation MAC CE command (e.g., a first (unified) TCI state(s) activation/deactivation command as specified herein in the present disclosure) specific to value 1 of coresetPoolIndex, and/or the UE could be expected to apply the TCI codepoints—when they become applicable—activated by/in a 1^{st} (unified) TCI state(s) activation/deactivation MAC CE command specific to value 0 of coresetPoolIndex and a 2^{nd} (unified) TCI state(s) activation/deactivation MAC CE command specific to value 1 of coresetPoolIndex, and/or the UE could be expected to apply TCI codepoint(s) from a 1^{st} (unified) TCI state(s) activation/deactivation MAC CE command specific to value 0 of coresetPoolIndex to the TCI field of DCI format 1_1/1_2 specific to the same value 0 of coresetPoolIndex, and apply TCI codepoint(s) from a 2^{nd} (unified) TCI state(s) activation/deactivation MAC CE command specific to value 1 of coresetPoolIndex to the TCI field of DCI format 1_1/1_2 specific to the same value 1 of coresetPoolIndex. Or, the UE may not expect to receive a (unified) TCI state(s) activation/deactivation MAC CE command (e.g., a first (unified) TCI state(s) activation/deactivation MAC CE command as specified herein in the present disclosure) not specific to any value(s) of coresetPoolIndex, and/or the UE may not be expected to apply the TCI codepoints—when they become applicable—activated by/in a (unified) TCI state(s) activation/deactivation MAC CE command not specific to any value(s) of coresetPoolIndex, and/or the UE may not be expected to apply TCI codepoint(s) from a (unified) TCI state(s) activation/deactivation MAC CE command not specific to any value(s) of coresetPoolIndex to the TCI field of DCI format 1_1/1_2. For this case/design example, when/if a first joint/DL/UL TCI states indicated by a TCI codepoint—from the 1^{st} (unified) TCI state(s) activation/deactivation MAC CE command specific to value 0 of coresetPoolIndex—and a second joint/DL/UL TCI states indicated by a TCI codepoint—from the 2^{nd} (unified) TCI state(s) activation/deactivation MAC CE command specific to value 1 of coresetPoolIndex—have become applicable (e.g., after the corresponding beam application time),
   the UE could apply the indicated first joint/DL/UL TCI state specific to value 0 of coresetPoolIndex to monitor PDCCHs, and receive PDSCHs and aperiodic CSI-RS resources, and/or to transmit PUSCHs, PUCCHs, and SRSs, and/or
   the UE could apply the indicated first joint/DL/UL TCI state specific to value 0 of coresetPoolIndex to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or apply the TCI state corresponding to q_{new} from the reference NBI RS set corresponding to the NBI RS set q̅_{1,0} or q̅_{1,1} to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs, and/or
   the UE could apply the indicated second joint/DL/UL TCI state specific to value 1 of coresetPoolIndex to monitor PDCCHs, and receive PDSCHs and aperiodic CSI-RS resources, and/or to transmit PUSCHs, PUCCHs, and SRSs, and/or
   the UE could apply the indicated second joint/DL/UL TCI state specific to value 1 of coresetPoolIndex to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs, and/or apply the TCI state corresponding to q_{new} from the reference NBI RS set corresponding to the NBI RS set q̅_{1,0} or q̅_{1,1} to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or
   the UE could apply the indicated first joint/DL/UL TCI state specific to value 0 of coresetPoolIndex to monitor PDCCH(s) in the first CORESETs, and receive PDSCH(s) scheduled/activated by PDCCH(s) in the first CORESETs, and aperiodic CSI-RS resource(s) applying the TCI-State(s) specific to the first CORESETs, and/or to transmit PUSCH, PUCCH, and SRS that apply the TCI-State(s) or TCI-UL-State(s) specific to the first CORESETs, and/or apply the indicated second joint/DL/UL TCI state specific to value 1 of coresetPoolIndex to monitor PDCCH(s) in the second CORESETs, and receive PDSCH(s) scheduled/activated by PDCCH(s) in the second CORESETs, and aperiodic CSI-RS resource(s) applying the TCI-State(s) specific to the second CORESETs, and/or to transmit PUSCH, PUCCH, and SRS that apply the TCI-State(s) or TCI-UL-State(s) specific to the second CORESETs.

Throughout the present disclosure, the TCI-State TCI-UL-State specific to the first CORESETs could also be referred to as first TCI-State TCI-UL-State or the first TCI-State TCI-UL-State specific to the first CORESETs, and the TCI-State TCI-UL-State specific to the second CORESETs could also be referred to as second TCI-State TCI-UL-State, or the second TCI-State TCI-UL-State specific to the second CORESETs.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a first transmission configuration indication (TCI) state and a second TCI state; and
transmit a capability signaling; and
a processor operably coupled to the transceiver, the processor configured to determine, based on the capability signaling, a beam failure detection (BFD) reference signal (RS) resource set q₀ from (i) the first or second TCI state or (ii) the first and second TCI state;
wherein the transceiver is further configured to:
receive a new beam RS resource set q₁ associated with the q₀; and
receive a RS resource index q_{new} from the q₁ and a beam failure recovery (BFR) response (BFRR); and
wherein the processor is further configured to:
determine, based on the q₀, q_{new}, and BFRR, a quasi-co-location (QCL) assumption for receiving downlink (DL) channels or signals; and
determine, based on the q₀, q_{new}, and BFRR, a spatial domain filter for transmitting uplink (UL) channels or signals.

2. The UE of claim 1, wherein the first or second TCI state is a joint, DL, or UL TCI state.

3. The UE of claim 1, wherein the capability signaling indicates whether transmission-reception point (TRP) specific BFR is supported.

4. The UE of claim 3, wherein:
when the capability signaling indicates support for TRP specific BFR, the q₀ includes RS resource indexes in RS resource sets indicated by the first TCI state;
otherwise, the q₀ includes RS resource indexes in RS resource sets indicated by the first and second TCI states.

5. The UE of claim 1, wherein the first and second TCI states correspond to control resource sets (CORESETs) associated with coresetPoolIndex values 0 and 1, respectively.

6. The UE of claim 1, wherein, when the q₀ includes RS resource indexes in RS resource sets indicated by the first and second TCI states, the transceiver is further configured to use a same antenna port QCL parameter associated with the q_{new} to:
monitor a physical downlink control channel (PDCCH) in a control resource set (CORESET);
receive a physical downlink shared channel (PDSCH); and
receive an aperiodic channel state information reference signal (CSI-RS) resource in a CSI-RS resource set.

7. The UE of claim 1, wherein, when the q₀ includes RS resource indexes in RS resource sets indicated by the first and second TCI states, the transceiver is further configured to use a same spatial domain filter associated with the q_{new} to transmit:
a physical uplink control channel (PUCCH);
a physical shared control channel (PUSCH); and
a sounding reference signal (SRS) that uses a same spatial domain filter for transmitting the PUCCH and PUSCH.

8. A base station (BS), comprising:
a transceiver configured to:
transmit a first transmission configuration indication (TCI) state and a second TCI state; and
receive a capability signaling; and
a processor operably coupled to the transceiver, the processor configured to determine, based on the capability signaling, a beam failure detection (BFD) reference signal (RS) resource set q₀ from (i) the first or second TCI state or (ii) the first and second TCI state;
wherein the transceiver is further configured to:
transmit a new beam RS resource set q₁ associated with the q₀; and
transmit a RS resource index q_{new} from the q₁ and a beam failure recovery (BFR) response (BFRR); and
wherein the q₀, q_{new}, and BFRR, indicate (i) a quasi-co-location (QCL) assumption for downlink (DL) channels or signals and (ii) a spatial domain filter for uplink (UL) channels or signals.

9. The BS of claim 8, wherein the first or second TCI state is a joint, DL, or UL TCI state.

10. The BS of claim 8, wherein the capability signaling indicates whether transmission-reception point (TRP) specific BFR is supported.

11. The BS of claim 10, wherein:
when the capability signaling indicates support for TRP specific BFR, the q₀ includes RS resource indexes in RS resource sets indicated by the first TCI state;
otherwise, the q₀ includes RS resource indexes in RS resource sets indicated by the first and second TCI states.

12. The BS of claim 8, wherein the first and second TCI states correspond to control resource sets (CORESETs) associated with coresetPoolIndex values 0 and 1, respectively.

13. The BS of claim 8, wherein, when the q₀ includes RS resource indexes in RS resource sets indicated by the first and second TCI states, the transceiver is further configured to use a same antenna port QCL parameter associated with the q_{new} to transmit:
a physical downlink control channel (PDCCH) in a control resource set (CORESET);
a physical downlink shared channel (PDSCH); and
an aperiodic channel state information reference signal (CSI-RS) resource in a CSI-RS resource set.

14. The BS of claim 8, wherein, when the q₀ includes RS resource indexes in RS resource sets indicated by the first and second TCI states, the transceiver is further configured to use a same spatial domain filter associated with the q_{new} to receive:
a physical uplink control channel (PUCCH);
a physical shared control channel (PUSCH); and
a sounding reference signal (SRS) that uses a same spatial domain filter for transmitting the PUCCH and PUSCH.

15. A method performed by a user equipment (UE), the method comprising:
receiving a first transmission configuration indication (TCI) state and a second TCI state;
transmitting a capability signaling;
determining, based on the capability signaling, a beam failure detection (BFD) reference signal (RS) resource set q₀ from (i) the first or second TCI state or (ii) the first and second TCI state;
receiving a new beam RS resource set q₁ associated with the q₀;
receiving a RS resource index q_{new} from the q₁ and a beam failure recovery (BFR) response (BFRR);
determining, based on the q₀, q_{new}, and BFRR, a quasi-co-location (QCL) assumption for receiving downlink (DL) channels or signals; and
determining, based on the q₀, q_{new}, and BFRR, a spatial domain filter for transmitting uplink (UL) channels or signals.

16. The method of claim 15, wherein the first or second TCI state is a joint, DL, or UL TCI state.

17. The method of claim 15, wherein the capability signaling indicates whether transmission-reception point (TRP) specific BFR is supported.

18. The method of claim 17, wherein:
when the capability signaling indicates support for TRP specific BFR, the q₀ includes RS resource indexes in RS resource sets indicated by the first TCI state;
otherwise, the q₀ includes RS resource indexes in RS resource sets indicated by the first and second TCI states.

19. The method of claim 15, further comprising:
when the q₀ includes RS resource indexes in RS resource sets indicated by the first and second TCI states, using a same antenna port QCL parameter associated with the q_{new} for:
monitoring a physical downlink control channel (PDCCH) in a control resource set (CORESET);
receiving a physical downlink shared channel (PDSCH); and
receiving an aperiodic channel state information reference signal (CSI-RS) resource in a CSI-RS resource set.

20. The method of claim 15, further comprising:
when the q₀ includes RS resource indexes in RS resource sets indicated by the first and second TCI states, using a same spatial domain filter associated with the q_{new} to transmit:
a physical uplink control channel (PUCCH);
a physical shared control channel (PUSCH); and
a sounding reference signal (SRS) that uses a same spatial domain filter for transmitting the PUCCH and PUSCH.
